(19) United States
(12) Patent Application Publication
(10) Pub. No.: US 2008/0270151 A1
(43) Pub. Date: Oct. 30, 2008

(54) METHOD AND SYSTEM FOR DEVELOPING AN AUDIENCE OF BUYERS AND OBTAINING THEIR BEHAVIORAL PREFERENCES TO PROMOTE COMMERCE ON A COMMUNICATION NETWORK

(75) Inventors: Don Mahoney, Cochranville, PA (US); John Barber, Potomac Falls, VA (US); William F. Geritz, Columbia, MD (US); Joseph H. Schonfeld, Baltimore, MD (US)

Correspondence Address: DLA PIPER US LLP, P. O. BOX 9271, RESTON, VA, 20195, US

(73) Assignee: BD METRICS, BALTIMORE, MD (US)

(21) Appl. No.: 11/740,759

(22) Filed: Apr. 26, 2007

(51) Int. Cl. G06Q 10/00

(52) U.S. Cl. 705/1

(57) ABSTRACT

A method and system are disclosed that provide for determining and developing business opportunities network within a communication network. Profile data of a plurality of participants of an event are stored within the network. The profile data are associated with at least one of the plurality of participants, and serve as a basis to generate recommendations of pertinence to each of the plurality of participants.

### CROSS REFERENCE TO RELATED APPLICATION

This application is related to U.S. Provisional Patent Application Ser. No. 60/544,555 entitled “Automated System and Method for Determination and Reporting of Business Development Opportunities,” filed with the U.S. Patent and Trademark Office on Feb. 13, 2004 and U.S. Patent Application Publication 11/057,417, filed with the U.S. Patent and Trademark. Office on Feb. 14, 2005. Both applications are incorporated herein in their entirety.

### BACKGROUND OF THE INVENTION

1. Field of the Invention

The invention disclosed herein relates generally to an automated method and system for the determination and reporting of business development opportunities, and more particularly to an automated method and system for allowing providers of goods and services in an environment of a specific population of prospective business partners to determine the existence of and track connections between and among one another, and for allowing an administrator of the environment in which such connections may take place to likewise track such connections.

2. Background of the Prior Art

Persons involved in the development or marketing of new products or services, whether from the engineering, financial, or general management perspectives, are all faced with the challenge of finding the best available market opportunity for such newly developed products or services. At times, one company may have lofty goals of deploying a new product or service but may lack the technical expertise to bring such product or service to market. Other times, a company may have developed a new technology that it believes is valuable but for which there is an undefined or underdeveloped commercial market. Obviously, many other barriers likewise exist to the introduction of new products or services into the marketplace and the realization of commercial success.

In order to address these challenges, many persons and/or companies involved in the development and/or marketing of new products or services will seek out partners to address certain of the challenges associated with introducing a new product or service to the commercial marketplace. For instance, they may wish to simply establish a network of persons in particular industries apart from their own who would be able to advise them of the potential applications or acceptance of the new product or service in their respective industries. Alternately, the developer of the new technology may wish to establish such a network of persons in varying industries in order to determine how the new product or service might be combined or integrated with products or services in such industries to provide a new product or service offering combining the two.

In order to establish these networks of persons having such expertise, or even to establish networks of potential buyers for one's own products and services, many developers and marketers of new products or services undertake “networking” efforts, i.e., attending trade shows, scientific conferences, professional association meetings, and the like in order to establish relationships with as wide a variety of persons as possible. This common strategy relies on the hope that establishing a wide network will eventually, on a somewhat haphazard basis, allow the networking person to establish a relationship with someone who is in a position to effect the course of action of a potential purchaser, seller, technology partner, or other business partner with regard to that networking person's own products, services, or other business needs. While such random contacts may, assuming a wide enough networking effort, lead to some success in establishing relationships with those persons in other organizations effecting such organizations' courses of action, it remains a highly inefficient means to build relationships that would lead to lasting, mutually beneficial business relationships.

Efforts have been made in the past to create electronic networking environments in which individuals may register with an online service (such as providing their email address and other contact information) in an online but nonetheless haphazard attempt to find some chain of contacts that they might be able to exploit in order to personally contact a specific individual. For example, U.S. Pat. No. 6,175,831 to Weinreich et al. describes a networking database containing multiple user records which indicate defined personal relationships among users, such that one user may potential follow a series of such relationships from himself to another user with whom they would like to establish contact. While such online “social networking” services are gaining in popularity, they still rely on the randomness of beneficial relationships being overcome by the numbers of persons involved in the service. In other words, if the services are successful at registering a large number of diverse users, the probability increases that a business development executive will be able to find a chain of contacts to a specific person at a specific company whom they would like to meet or talk with in order to explore a potential business relationship. However, such tools still require that the user know who it is that they are looking for, and thus does little for the business development executive who is looking for ail potential contacts with whom he or she should seek a relationship in order to advance the commercial exploitation of their new product or service.

It would therefore be helpful to provide an automated system for creating contacts that goes beyond the simple identification of routes to particular persons a user might want to contact, but that in fact finds specific persons that, from a business development perspective, the user should want to contact, regardless of whether the user knows that such person exists. It would further be helpful to provide an automated system that, in addition to identifying persons a user should want to contact from a business development perspective, also provides the user with an indication for why that person would be an appropriate contact, i.e., the extent to which such person or persons are likely to provide the user with a business development opportunity, whether in the context of a product purchase, product sale, new product development, joint venture, merger or acquisition, or the like. It would also be helpful to provide to such administrators of programs (e.g., tradeshows) in which such potential contacts could be sought to have a mechanism by which they could track the success of such programs in establishing such contacts, and to extend prospective participants' involvement in such program to in turn increase their interest in the program (and thus there purchases of registrations in the program).

### SUMMARY OF THE INVENTION

The embodiments described herein are methods and systems for determining and developing business opportunities within a communication network. According to one embodiment, there is provided a method and system in which content associated with a community is stored. The demographics, interests, and/or behaviors of a user in the community are determined. The content associated with the community is filtered based on the determining. The filtered content is delivered to the user.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 shows is a schematic diagram of an exemplary lead generation and tracking system according to a preferred embodiment of the invention.

FIG. 2 is an exemplary data input screen for receiving company information according to a preferred embodiment of the invention.

FIG. 3 is an exemplary Product Categories selection screen according to a preferred embodiment of the invention.

FIG. 4 is an exemplary Product Listing data input screen according to a preferred embodiment of the invention.

FIG. 4a is an exemplary Add/Edit Product data input screen according to a preferred embodiment of the invention.

FIG. 4b is a top level view of an exemplary Market Space Definition Taxonomy according to a preferred embodiment of the invention.

FIG. 5 is an exemplary Contact Information data input screen according to a preferred embodiment of the invention.

FIG. 6 is an exemplary My Expertise selection screen according to a preferred embodiment of the invention.

FIG. 7 is an exemplary My Product Interests selection screen according to a preferred embodiment of the invention.

FIG. 8 is an exemplary Leads Profile summary screen according to a preferred embodiment of the invention.

FIG. 8a is an exemplary Keywords and Phrases display and input screen according to a preferred embodiment of the invention.

FIG. 8b is an exemplary Product Categories selection screen according to a preferred embodiment of the invention.

FIG. 9 is a chart detailing scoring for user behaviors and demographics according to a preferred embodiment of the invention.

FIG. 10 is a chart summarizing behavior and demographic scoring according to a preferred embodiment of the invention.

FIG. 11 is a flowchart reflecting screening of User Profiles to generate leads according to a preferred embodiment of the invention.

FIG. 12 is an exemplary Connection Details summary screen according to a preferred embodiment of the invention.

FIG. 13 is an exemplary Pending Connections listing screen according to a preferred embodiment of the invention.

FIG. 14 is an exemplary Established Connections listing screen according to a preferred embodiment of the invention.

FIG. 15 is an exemplary Schedule a Meeting data input screen according to a preferred embodiment of the invention.

FIG. 16 is an exemplary Meeting Calendar display screen according to a preferred embodiment of the invention.

FIG. 17 is an exemplary Booth Visits display screen according to a preferred embodiment of the invention.

FIG. 18 is an exemplary Search data input screen according to a preferred embodiment of the invention.

FIG. 19 is an exemplary Saved Searches display screen according to a preferred embodiment of the invention.

FIG. 19a is an exemplary Search Results display screen according to a preferred embodiment of the invention.

FIG. 19b is an exemplary Results Detail display screen according to a preferred embodiment of the invention.

FIG. 20 is an exemplary Find Peers and Colleagues data input screen according to a preferred embodiment of the invention.

FIG. 21 is an exemplary Find People data input screen according to a preferred embodiment of the invention.

FIG. 22 is an exemplary People Search Results display screen according to a preferred embodiment of the invention.

FIG. 23 is an exemplary Connection Details/Invite Connection display screen according to a preferred embodiment of the invention.

FIG. 24 is an exemplary Connection Request Details data input screen according to a preferred embodiment of the invention.

FIG. 25 is an exemplary Connection Details/Accept Connection display screen according to a preferred embodiment of the invention.

FIG. 26 is an exemplary Find Products and Companies selection screen according to a preferred embodiment of the invention.

FIG. 27 is an exemplary Find Sessions search screen according to a preferred embodiment of the invention.

FIG. 28 is a flow chart showing communications from the system to users during the lead conversion process according to a preferred embodiment of the invention.

FIG. 29 is an exemplary Exhibitor Opportunity Report according to a preferred embodiment of the invention.

FIG. 30 is an exemplary You-Based Event Report according to a preferred embodiment of the invention.

FIG. 31 is an exemplary Exhibitor Activity Report according to a preferred embodiment of the invention.

FIG. 32 is an exemplary Justification Report according to a preferred embodiment of the invention.

FIG. 33 is an exemplary Owner Analytics Report according to a preferred embodiment of the invention.

FIG. 34 illustrates an interface of an iFrame in Instant Portal Creation.

FIG. 35 illustrates another example of an interface of an Instant Portal Creation.

FIG. 36 illustrates an interface that enables the iFrame to welcome a user by name and display personalized content from their portal account directly on the event web site.

FIG. 37 illustrates a conceptual system diagram of an Instant Portal Creation to detect an existing account, to show the user a message to this effect, and to resend a confirmation email containing login credentials in order to take the user to his or her existing portal account.

FIG. 38 illustrates an interface of a message screen that enables a user to click directly into his or her newly created prospect portal.

FIGS. 39-43 illustrate interfaces and a conceptual system diagram that enable registrants of a trade show or conference to be offered the ability to place onto their personal computer a persisting desktop object (PDO) that allows easy, “always-on” access to their portal and alerts them when the portal has found relevant new content or people.

FIG. 44 is a conceptual block diagram for implementing some or all registrants of an event to receive “Role-Based Portals”.

FIG. 45 illustrates an interface that allows the user to modify his profile and change his role.

FIGS. 46-49 illustrate interfaces and a conceptual system diagram that enables users in an event community to be able to increase the relevance of their search results or recommendations by running a secondary search or match based on the result they like best.

FIG. 50 is an exemplary interface that provides users with the ability to add search results and incoming connections of high personal interest to an “Event Plan”.

FIG. 51 is a conceptual system diagram for implementing the Event Plan Utility.

FIG. 52 is an exemplary interface for implementing the Event Plan.

FIGS. 53-55 illustrate interfaces that enable a user to interactively improve the recommendations displayed in the Event Plan.

FIGS. 56-60 illustrate conceptual system diagrams and interfaces that enable registrants of an event to receive updates that increase their professional knowledge.

FIGS. 61-66 illustrate interfaces and a conceptual system diagram that enables registrants of an event to have the ability to improve the relevance of the recommendations generated for them in their portal.

FIGS. 67-70 illustrate a conceptual system diagram and interfaces that enables registrants of an event to have their portal or PDO periodically update them with any unique new people, companies, products, knowledge, or other content items that match their previous searches or matching profiles.

### DETAILED DESCRIPTION OF SEVERAL EMBODIMENTS OF THE INVENTION

The invention summarized above and defined by the enumerated claims may be better understood by referring to the following description, which should be read in conjunction with the accompanying drawings in which like reference numbers are used for like parts. This description of an embodiment, set out below to enable one to build and use an implementation of the invention, is not intended to limit the enumerated claims, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

A method and system are provided for enabling product or service providers an environment, in which they may identify and be notified of the existence of individuals with whom such provider might wish to enter into a business transaction, and for enabling a program administrator (e.g., an entity desiring to produce a tradeshow) to track the interactions among product or service providers registered for such program. In a particularly preferred embodiment, such product or service provider may be an exhibitor or an attendee at a trade show, exhibition, or other environment in which the provider may have access to a large population of would-be business partners, whether those partners represent potential purchasers of the entity's particular goods or services, technology partners with or from whom the entity might wish to provide or receive other technology, manufacturing partners with whom the entity might wish to enter into an OEM agreement, or other partners who might be suitable for a wide variety of business transactions. In order to give such providers the maximum opportunity to explore relationships with potential business partners, it is necessary to both identify those partners and provide a mechanism by which the interactions with those potential partners may be tracked so that leads may be followed up and pursued to their fullest opportunity. The method and system described herein provide an automated environment to allow the provider to perform these functions; i.e., identify would-be business partners among the specific audience population, communicate with those would-be business partners, and track the interactions with those partners to ensure that such leads produce the maximum benefit.

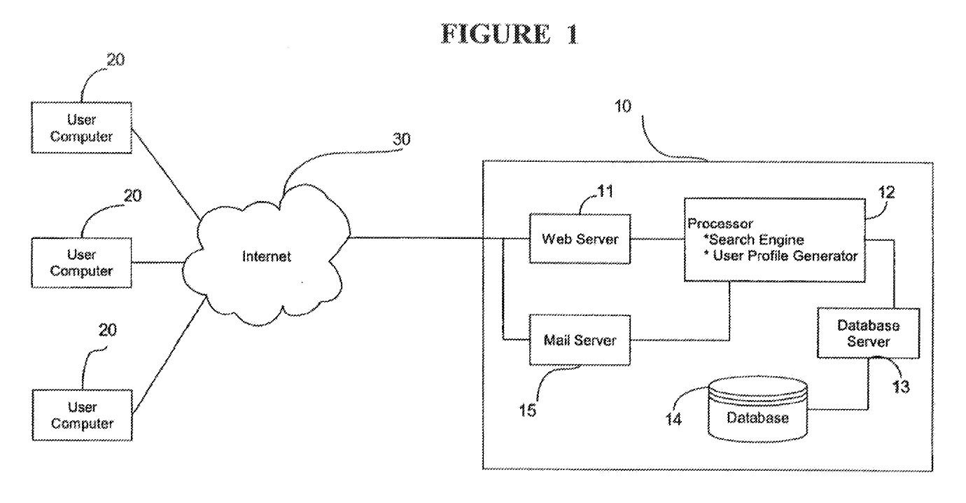

An exemplary system suitable for employing the lead generation and tracking environment is shown in FIG. 1. Such system preferably comprises a server system 10 accessible to a plurality of user computers 20 through a network 30, such as the Internet. User computers 20 are preferably personal computers having memory and communications software enabling communication through network 30 with remote server system 10 to exchange data with server system 10, such as through a web server 11 resident on or in communication with server system 10 capable of processing requests for documents and other services from user computers 20 and providing information over network 30 to such user computers 20. A processor 12 is provided in server system 10, which processor includes a search function capable of receiving search requests from users (as detailed below) and issuing such queries through a database server 13 to retrieve data from database 14. Web server 11 is also preferably capable of receiving data from user computers 20 and transmitting such data to processor 12 to create User Profiles (further detailed below) and, through database server 13, store such User Profiles in database 14. Database 14 preferably houses not only the User Profiles for the various users of the system, but also the knowledge bases used by the system in order to provide the rules and metrics by which leads may be identified.

As described below, each user of the system preferably engages the system to create a User Profile which identifies certain demographic characteristics about such user that in turn are used to determine potential matches with other users. While the specific data elements comprising the User Profile are described below, it is noted that such User Profile is unique to each user, and preferably comprises the complete data record for each such user to identify and track potential partners (i.e., “Leads”) for such user. The User Profile is preferably an electronic data record stored in one or more databases accessible to database server 13 so that such record may be readily retrieved, searched, and modified.

Creation of Entity Profile for Exhibitor and Attendee

In a preferred method of the invention, a product or service provider, or other person seeking to establish a relationship with a potential business partner, such as an exhibitor or an attendee at a trade show, accesses the server system 10 to create an entity profile. Web server 11 provides a user interface enabling the user to engage the server system 10 to create such entity profile. In addition to providing general biographical information, the user is prompted to provide information concerning the general categories to which the products or services they offer belong, specific details concerning one or more particular products or services offered, the user's personal information, the user's particular areas of expertise and connection interests, and the categories of products or services in which the user is interested.

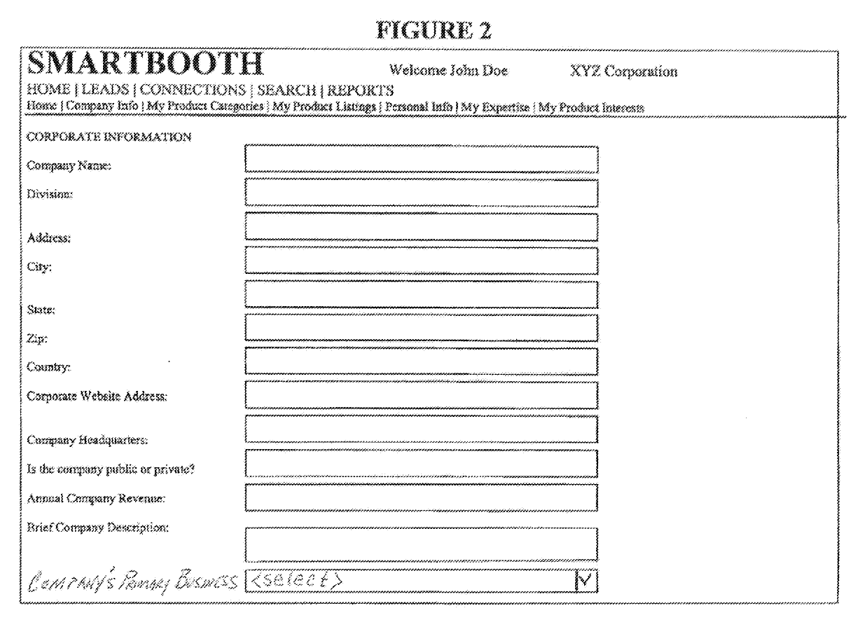

As shown on the exemplary Company Information screen of FIG. 2, the biographical information solicited from the user preferably comprises a series of data windows in which the user may input or select relevant biographical data, such as their company name and contact information, their company website, and the like.

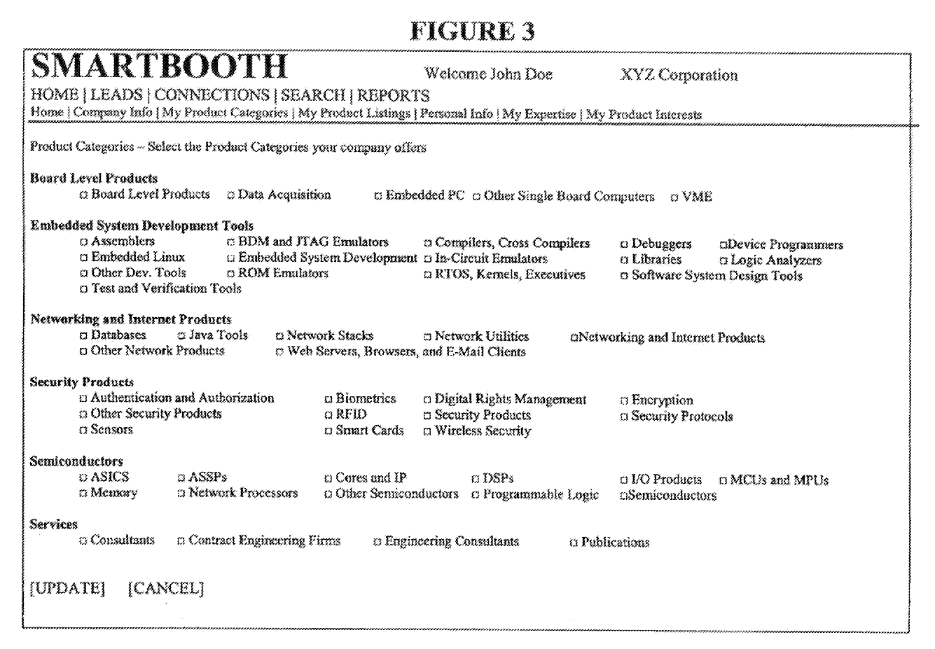

Following input of company information, as shown on FIG. 3, the user is prompted to provide information concerning the general categories to which their products or services belong. Preferably, the user is presented a list of different product or service categories allowing the user to select those categories relating to their own products or services. In a particularly preferred embodiment, the list of categories available for selection is particularly configured for the environment in which the system is to be used. For instance, if the system is intended for use by exhibitors and/or attendees at a trade show relating to systems design, as shown in the exemplary Product Category Selection Screen of FIG. 3, the categories may be separated into primary headings, such as “Board Level Products, Embedded System Development Tools,” etc., and further broken down into subheadings with more particularized product or service category titles. Once the user has selected those categories that relate to their own products or services, they may implement an “update” function to save such product category selections to their User Profile.

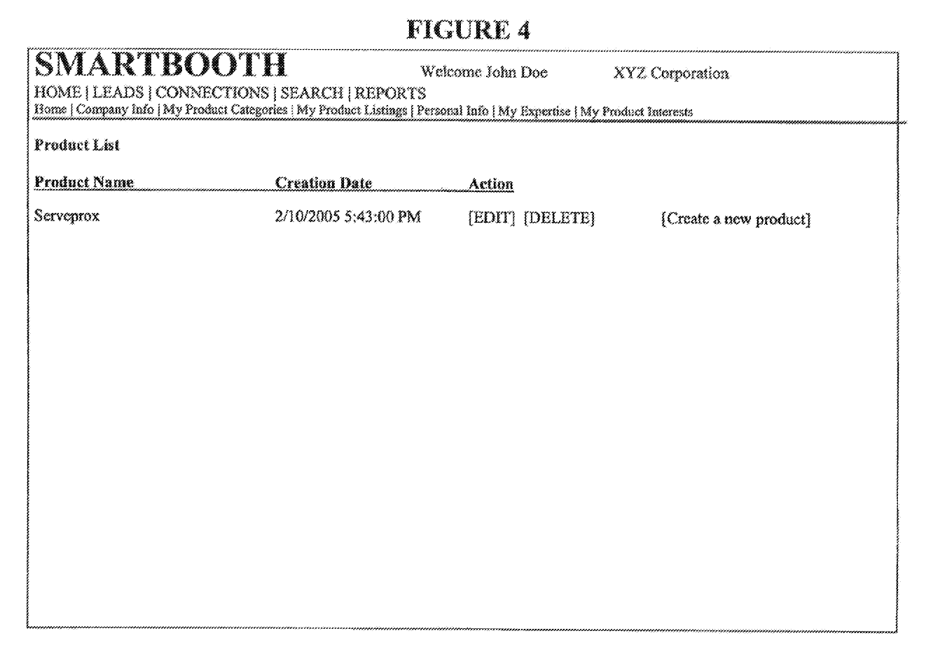

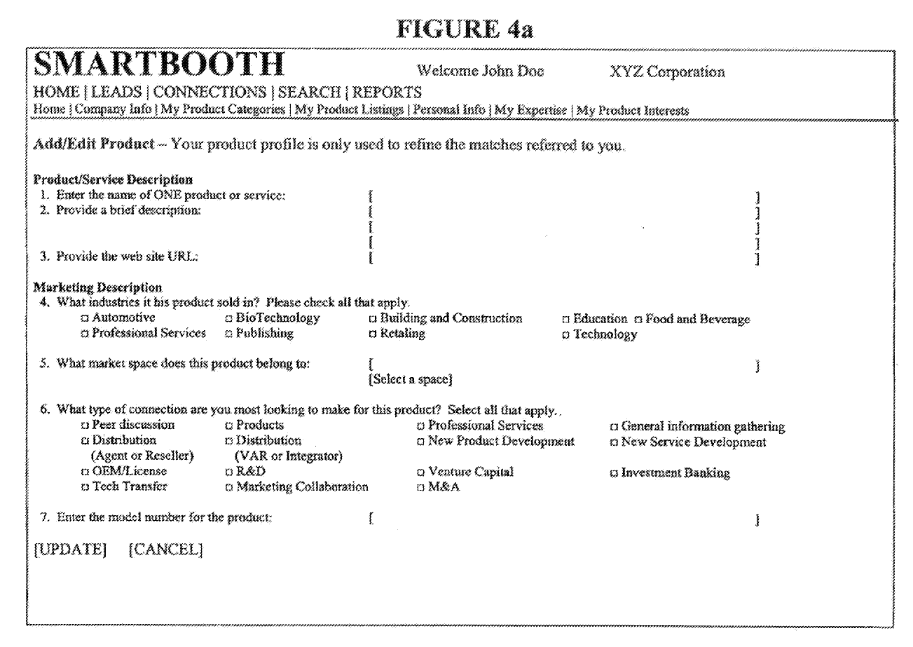

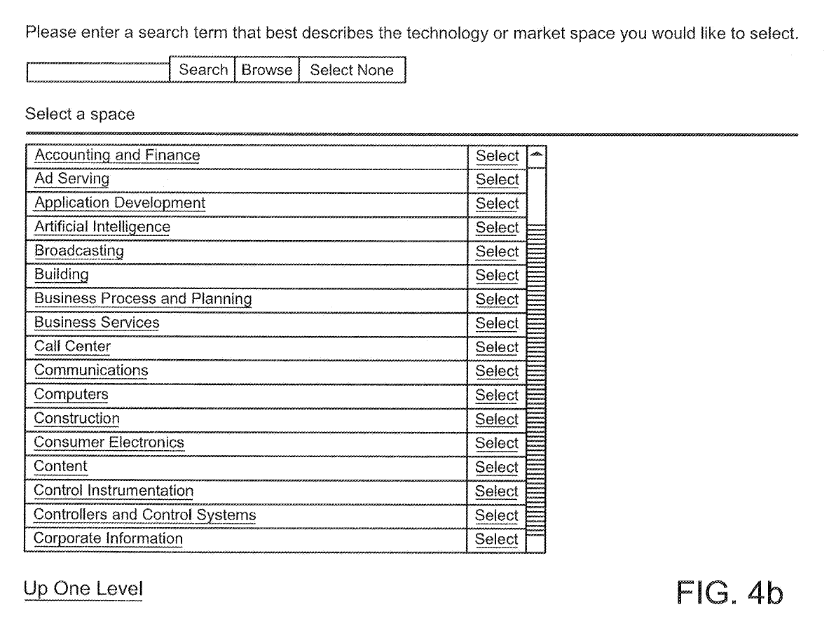

After selecting specific categories, as shown on FIG. 4, the user may create a list of specific products that they wish to particularly present to the population of potential business partners for consideration of a business relationship. Any products that the user has established are preferably displayed on the Product List Screen, an example of which is shown in FIG. 4. In order to create a new product or service to add to the Product List Screen, the user may implement a “create a new product” function that, in turn, presents the user with an “Add/Edit Product” screen as shown in FIG. 4a. The Add/Edit Product screen prompts a user to provide a profile for a particular product or services to enable the profile to be searched by the population of potential business partners. More particularly, the user is preferably prompted to input a product name, a textual description, and a website on which additional information for such product or service may be obtained. In addition to such general identifying information for the product or service, each product or service preferably also carries a Marketing Description, Market Space Definition, and Sales Description, all of which are selected by the user from lists of available market descriptions, market space definitions, and sales descriptions, respectively. More particularly, both Marketing Description and Sales Description classifications comprise check box selections allowing the user to designate those marketing descriptions and sales descriptions relevant to their product or service. Likewise, a pull down list allows a user to access a Market Space Definition Taxonomy, shown in greater detail in FIG. 4b. Preferably, such market space taxonomy is provided in the form of a multi-level outline structure, with each top level market space (particularly shown in FIG. 4b) potentially having subspaces and tertiary spaces there-under enabling line selection of the relevant market space to which the particular product or services belongs. An exemplary automated market taxonomy suitable for use with the system and method set forth herein is described in co-owned U.S. patent application Publication No. US 2004/0243459, the specification of which is incorporated herein by reference. Once completed with the input of such selections, the user may implement an “update” function to save such selections to their User Profile. Also, it is of note that the particular categories defining the market description and sales description may be modified, including adding additional categories or removing categories from those listed, as is appropriate for the particular forum in which the method and system are to be used, without departing from the spirit and scope of the instant invention.

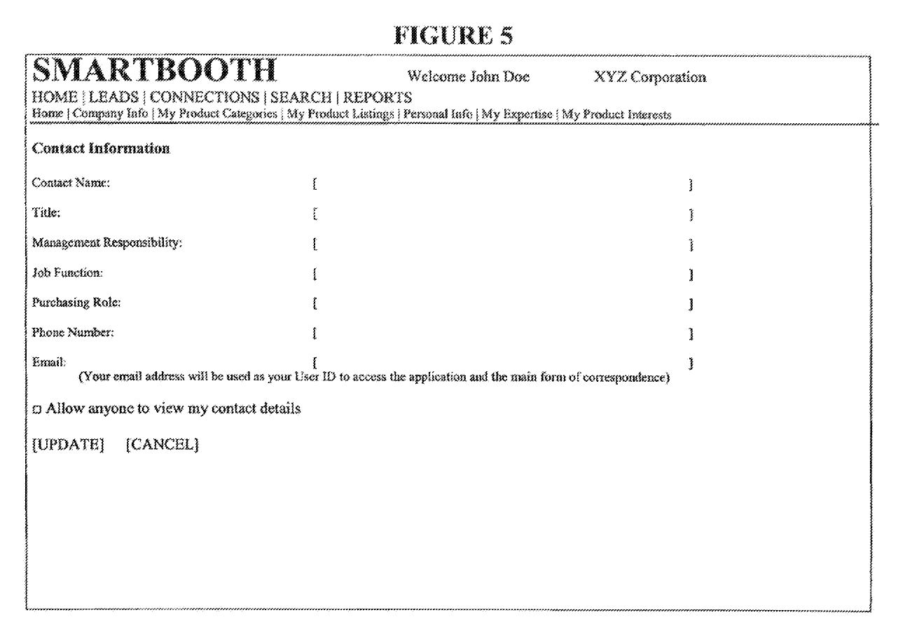

In addition to establishing a profile for the entity with which the particular user is associated, as shown in the exemplary Contact Information Screen of FIG. 5, that particular user is also preferably prompted to provide their own unique contact information, including their name, title, management responsibility, job function, purchasing role, and general contact information (such as telephone numbers and email addresses). When completed, the user preferably engages an update function to save their individual contact information to their User Profile.

It is noted that while multiple individual users may be associated with a single entity, each unique user is preferably provided their own identification key (i.e., User ID) to identify themselves and their individual User Profile to the system. The use of the information comprising each user's profile is set forth in greater detail below.

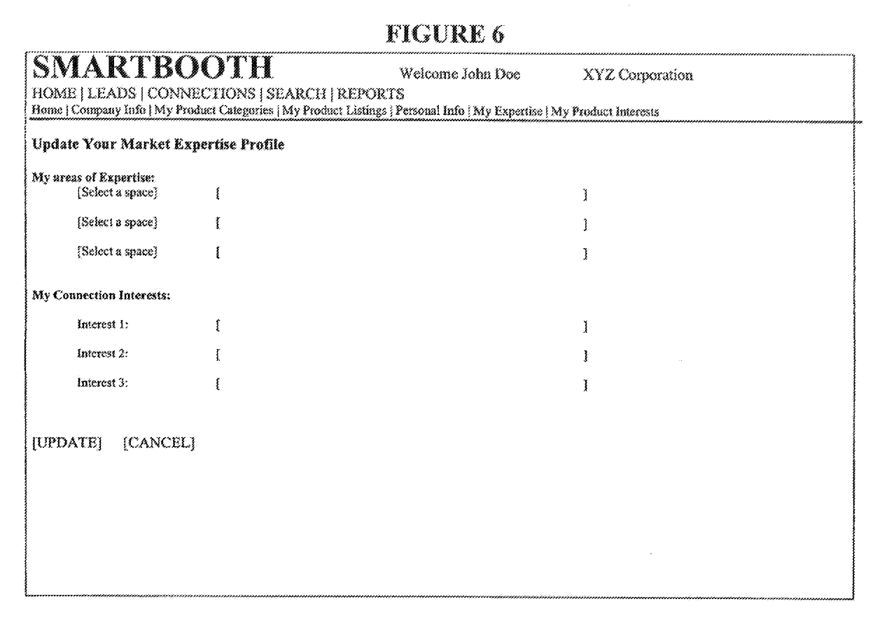

As shown in FIG. 6, another category of information solicited from the user is their individual Market Expertise Profile. When presented with a Market Expertise Profile screen, the user is prompted to select one or more areas in which that individual has expertise. Such selection is preferably made from the same market space taxonomy referenced above with regard to FIG. 4. Additionally, the user is prompted to indicate their “Connection Interests,” which interests may be selected from a pull-down list. The possible connection interests particularly identity potential reasons why the user might want to meet another member of the population, e.g., the particular type of transaction that might be explored if the user locates a suitable business partner. Such connection interests preferably include one or more of the following categories: Peer Discussion; Products; Professional Services; General Information Gathering; Distribution—Agent or Reseller; Distribution—VAR or Integrator; Technology (IP) Transfer; Marketing Collaboration; New Product Development; New Service Development; OEM/License; Research and Development; Venture Capital; Investment Banking; and M&A. Additional and/or alternate categories of potential business relationships, or other reasons why two members of the population might want to talk to one another, may be provided without departing from the spirit and scope of the invention. When completed, a user engages an update function to save their Market Expertise Profile to their User Profile.

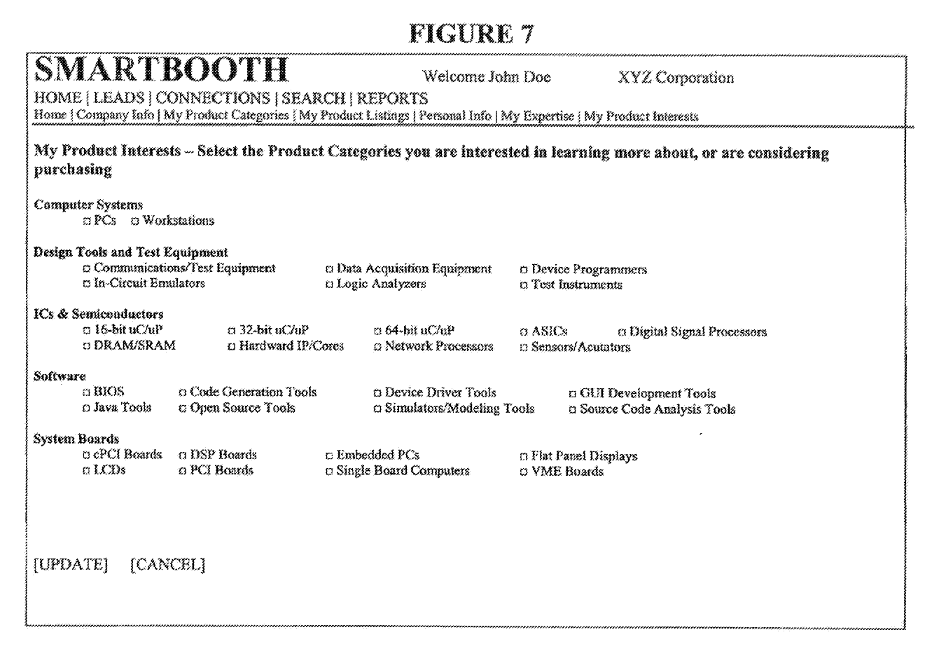

Another element of the User Profile is preferably solicited from the user, and is depicted in FIG. 7 as a Product Interests screen which allows the user to select specific product categories that such user might have interest in learning more about (such as for purposes of exploring a potential business relationship with a business partner, the subject matter of which concerns such product category), or which the user might have interest in purchasing from a prospective business partner. The particular product categories may be modified as necessary in order to have maximum applicability to the environment in which the system is to be used. Once the user has made their selections concerning their product interests, they may engage an update function to save their Product interests to their User Profile.

Optionally, the system may provide different levels of access to different users, enabling some portion of the above-described editing capabilities to different users within a single company or other entity to enable only those individuals having sufficient or desired authority to change company data. For example, You-Based Personalization Technology is a system and method for structuring the content of a business or event community (which content may include companies, products, people, conference sessions, knowledge, news, or information) around the demographics, stated interests, derived interests, and behaviors of each active or prospective participant. You-Based technology is an automated technology that increases the relevance of a business community (e.g., a trade show community) for each participant by automatically filtering that content to the subset which is most relevant to the participant, thus saving the participant time, and increasing the engagement of the participant. The technique builds behaviorally-qualified online audiences of users. You-Based technology includes both the intelligence to filter content and deliver relevant recommendation described above, and also techniques to deliver that filtered content to the participant via a unique technique called “Yon-Based Marketing”, a “push” technology which sends alerts to individuals in a community each time it has found new personalized content relevant to them. These “push” alerts drive buyers to click-through to You-Based portal pages where the participant encounters relevant content and information which engages the participant with the community.

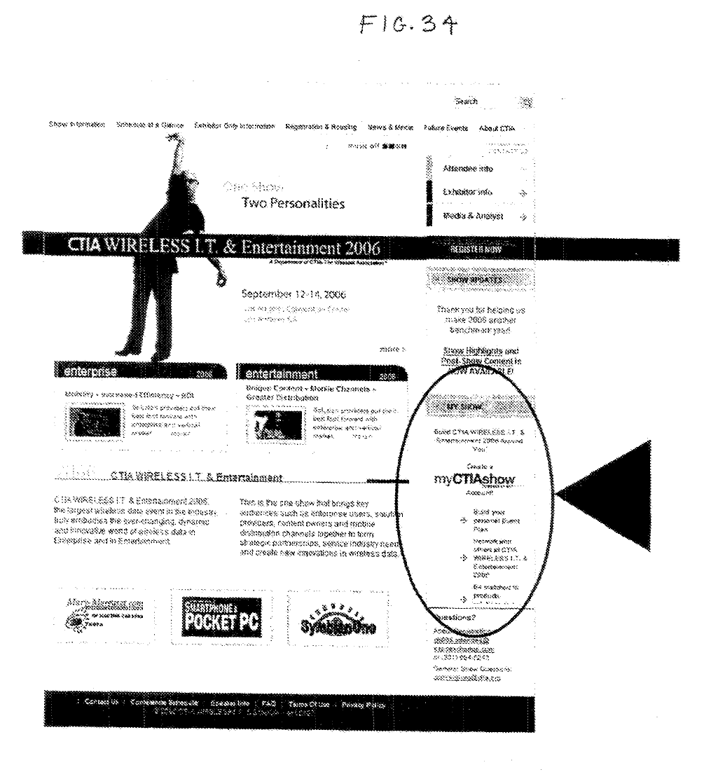

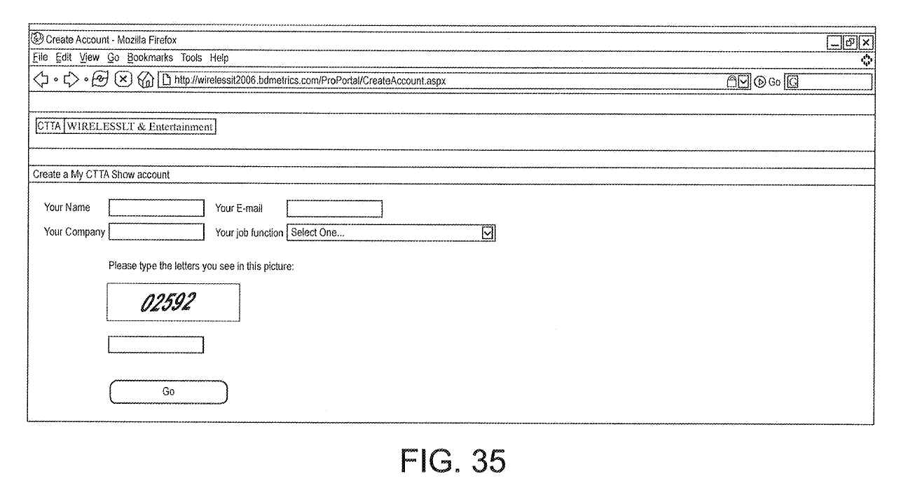

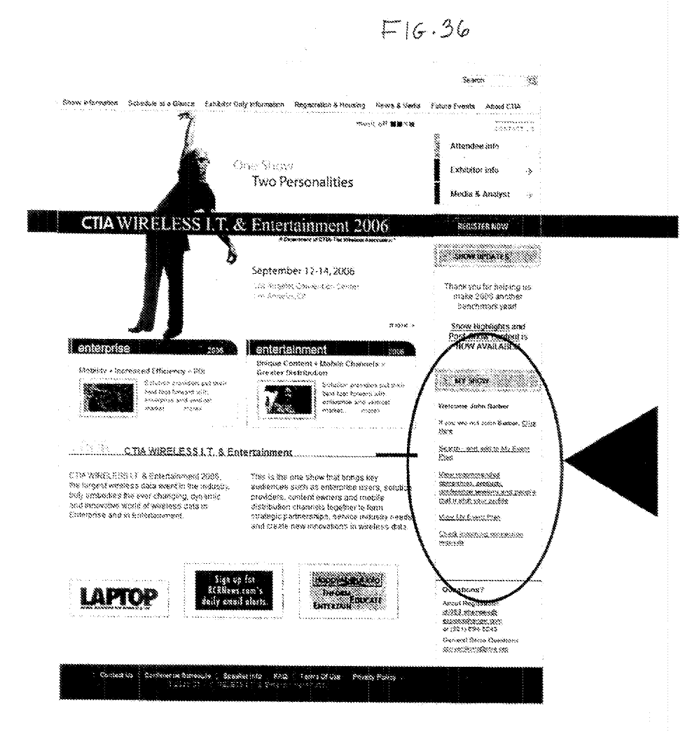

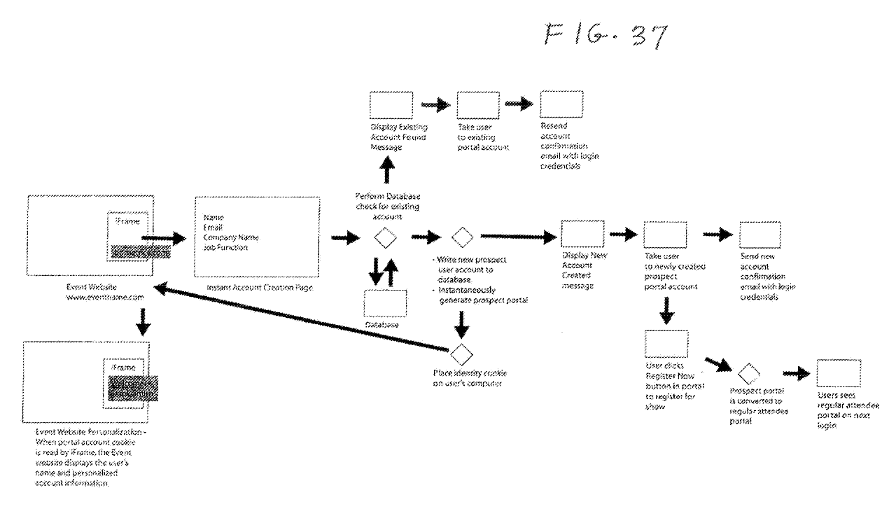

FIGS. 34-38 illustrate interfaces and a conceptual system diagram that enable prospective registrants of a trade show or conference to have the ability to instantaneously create a prospect portal account via the event website. In FIGS. 34-38, once an account has been created, registrants and prospective registrants may be able to see and access their portal account and its personalized content directly on the event website. The system as illustrated in FIGS. 34-38 provide both of these capabilities through an “instant portal creation” technology. Instant portal creation places an iFrame (a framed web page) within the pages of an event website. An interface example of an iFrame in Instant Portal Creation is shown in FIG. 34. This iFrame can be formatted to appear like any other page element of the event website. Yet it can be a small webpage hosted not on the event website, but rather on the same domain and webserver as the attendee portal application. When a user clicks on the iFrame to create an account, he or she can be taken to an instant account creation screen which collects four pieces of data—name, company name, job function, and email address, as shown in FIG. 35. After the user completes this screen and clicks “Go” to create an account, a database check may be performed to detect the presence of an existing account. FIG. 37 illustrates a conceptual system diagram of an Instant Portal Creation wherein if an existing account is detected, the user can be shown a message to this effect, a confirmation email containing login credentials may be resent, and the user can be taken to his or her existing portal account. No new account is created. As illustrated in FIG. 37, if no existing account is detected, the user's profile information can be written to the database and a new prospect portal account is created for the user. Further, in FIGS. 37 and 38, a message screen is displayed indicating successful creation of the account, and the user can click directly into his or her newly created prospect portal to begin exploring the personal value of the show. Also, FIG. 37 illustrates that a confirmation email containing the user's login credentials is simultaneously sent. In FIGS. 36 and 37, during the account creation process, an identity cookie can be placed upon the user's computer that, when read by the iFrame upon the user's next visit to the event website, enables the iFrame to welcome the user by name and display personalized content from their portal account directly on the event web site. Clicks upon these personal content links in the iFrame conveniently open corresponding pages within the user's portal account. Users may click a button in their prospect portal accounts to register for the show, and a database record of these clicks can be made as one measure of the effectiveness of the prospect portal in driving event registration.

The instant portal creation system as shown in FIGS. 37 includes at least one processor 12 (FIG. 1) that offers the user, from the user portal, an opportunity to register for the event. The processor may enable the system to provide personalized content on the user portal based on the user portal account, block use of predetermined functionality from the user portal for users who have not registered for the event, notify users that such predetermined functionality activates after such users register for the event, and track from the portal application when a user having a user portal account accesses an event registration interface or registers for the event, wherein an event plan utility, an online networking system, and/or a personalized walking map provided on the user portal may serve as a basis to register with the event website. The personalized content can serve as a basis to register with the event website and/or attend the event. The instant portal creation system may monitor activity within the user portal wherein such monitoring within the user portal may be configured to be executed autonomously from trackings associated with portals of users whose access to functionality has not been blocked.

Further, the instant portal creation system can be capable of tracking accesses to the event website from the user portal, and determining whether the user registers for the event after accessing the event website. The system can also permit user portal accounts to be issued as leads based on preferences set by an exhibitor.

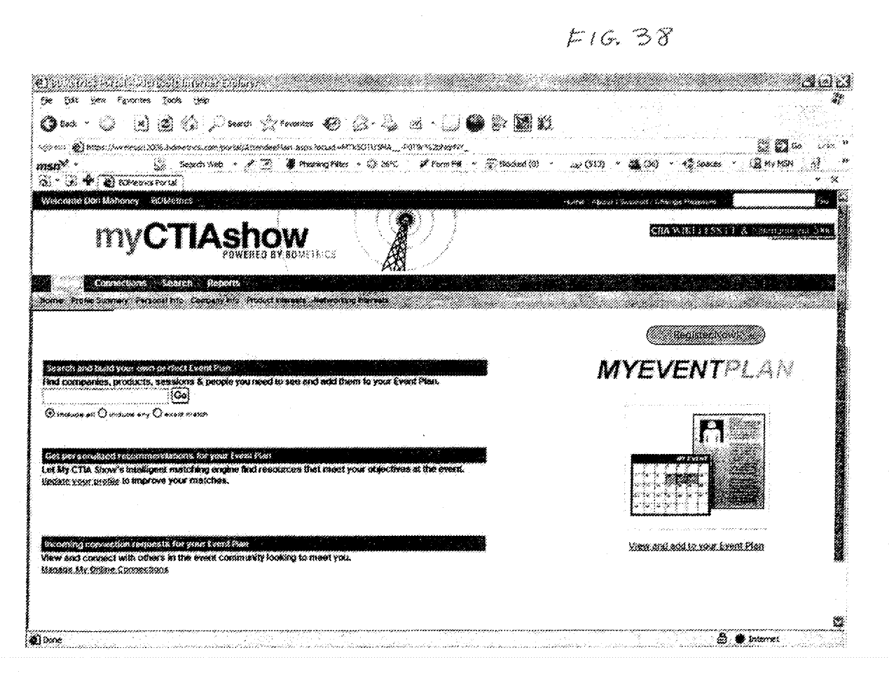

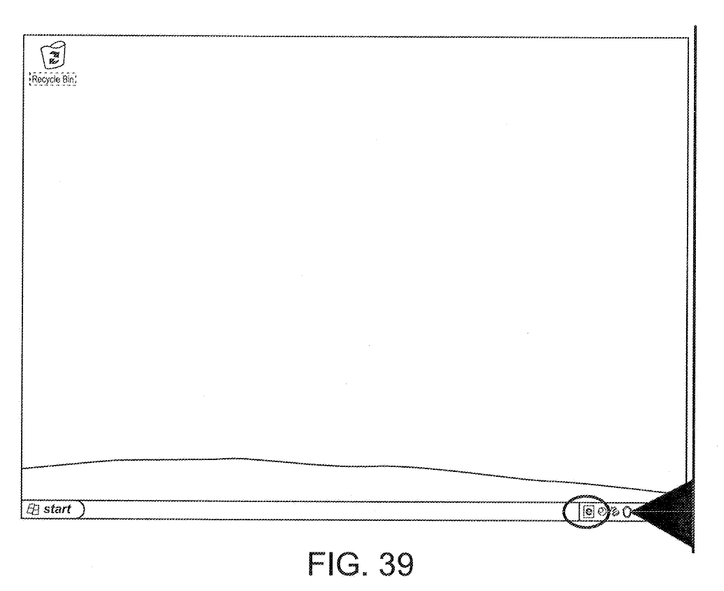

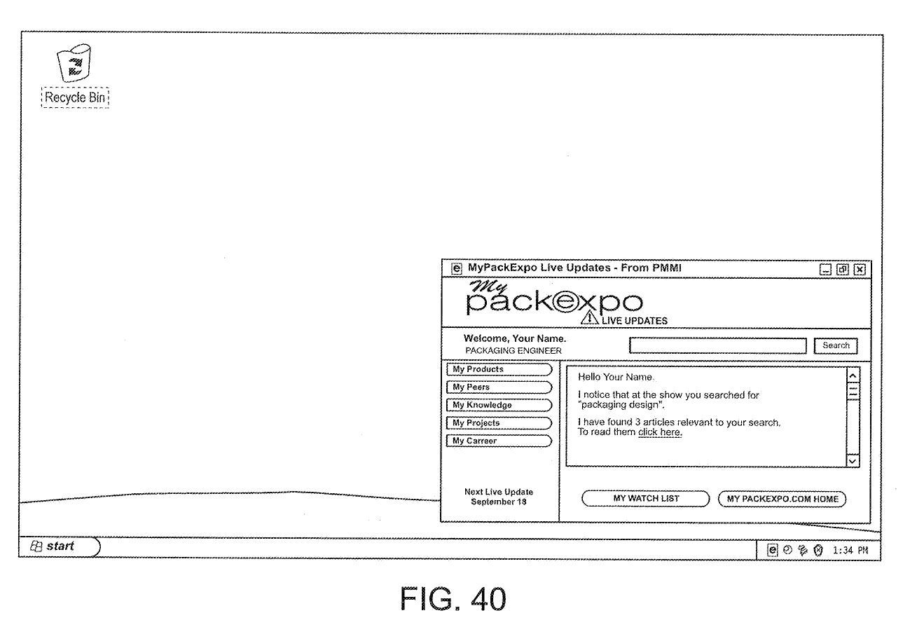

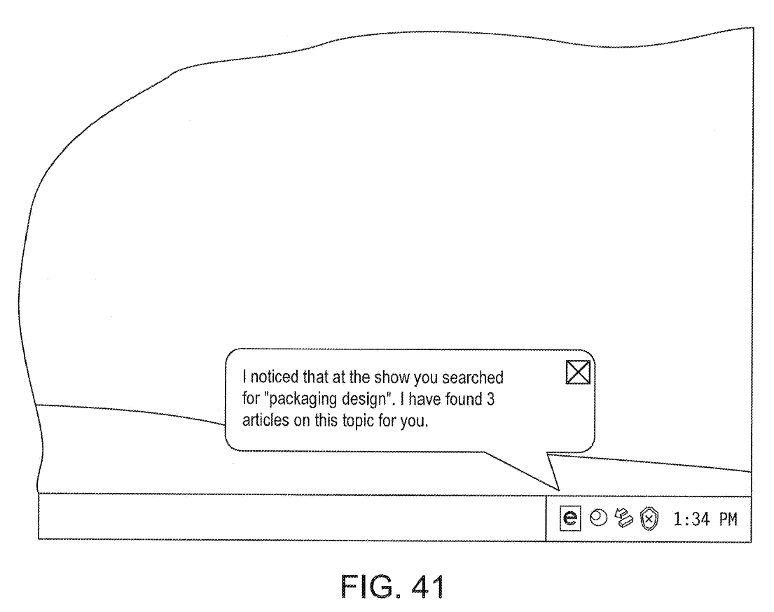

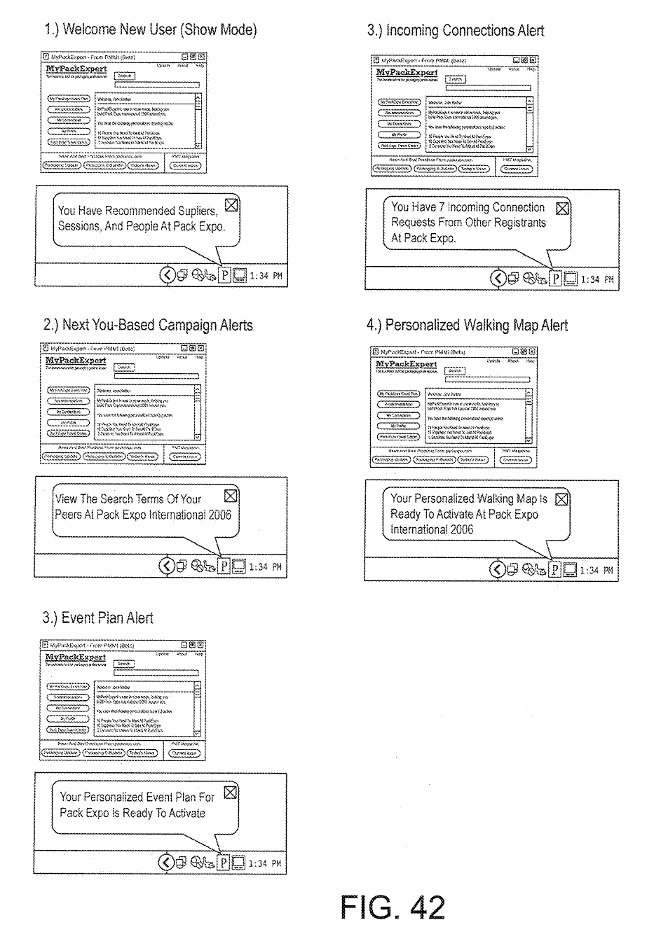

FIGS. 39-43 illustrate interlaces and a conceptual system diagram that enable registrants of a trade show or conference to be offered the ability to place onto their personal computer a persisting desktop object (PDO) that allows easy, “always-on” access to their portal and alerts them when the portal has found relevant new content or people. This PDO is a web-connected business tool that proactively works for users 24 hours a day, finding and gathering companies, products, knowledge, people, and other content relevant to their user profile and search behavior and advancing their projects and career. FIG. 39 illustrates an example of a PDO that is based upon a piece of desktop software that installs on the user's system and appears as a small icon located in the system tray. When the PDO tray icon is clicked by the user it opens a PDO window interface as shown in FIG. 40. FIG. 40 also illustrates an example of a PDO window that contains a combination of fixed buttons which open select web pages of the user's portal, a search box allowing users to type a search term and then view search results from their portal, and a variable content pane where alert messages appear. When the PDO has found relevant new people or content, it alerts the user by flashing the tray icon and displaying a speech bubble containing a summary of its findings as illustrated in FIG. 41. FIG. 42 illustrates exemplary PDO alerts that may take the form of either PDO campaigns in which all PDO users receive a personalized alert at the same date and time, or as live updates scheduled at the individual user's discretion. FIG. 43, for example, illustrates an embodiment of a PDO system as a combination of a desktop executable file (.exe); a web service which makes connections between the PDO and the back-end database and services in the portal application; and the portal application including its web server and databases. The PDO's .exe file employs a mechanism in which the functionality and behavior of the PDO can change based on the content delivered to it from the server via the web service. For example, the fixed buttons on the PDO window may change in number, their labels may change, and the URLs embedded behind them may change depending on content sent from the server. This is desirable in order that the PDO can flexibly offer users valuable new functionality without requiring a new download of the .exe file. The PDO is downloadable via an install program located at a URL which can be accessed from a wide variety of locations including the event portal, email, and other websites.

The PDO system as shown in FIG. 43 may include a database to store content information related to users of an event within a database, and an all year operational industry website that may be configured to hold a subscriber account in order to permit access to a portal application by a user. The portal application may include a web-connected business tool designed to finding and gathering a plurality of entities based on a user profile, a matching profile, and/or a search behavior associated with the user. Such entities may include companies, products, knowledge, people and content information. The PDO system may also include a processor associated with the web server that may be configured to determine a set of needs and interests associated with the user. Such a web server can also monitor the database for new content information, detect when the new content information matches a set of needs and interest of the user, access the database to retrieve a matched information based on the detection, and alert the user with the matched information. The PDO system may be capable of soliciting inputs from the user in order to improve relevant matching results, and designating a subset of the needs and interests associated with the user as high general interest. The PDO may then alert the user when the designated subset is detected as new content. The web server can permit a portal search engine to return results, build a search profile on the user, and/or gather search behaviors in order to facilitate business relationships.

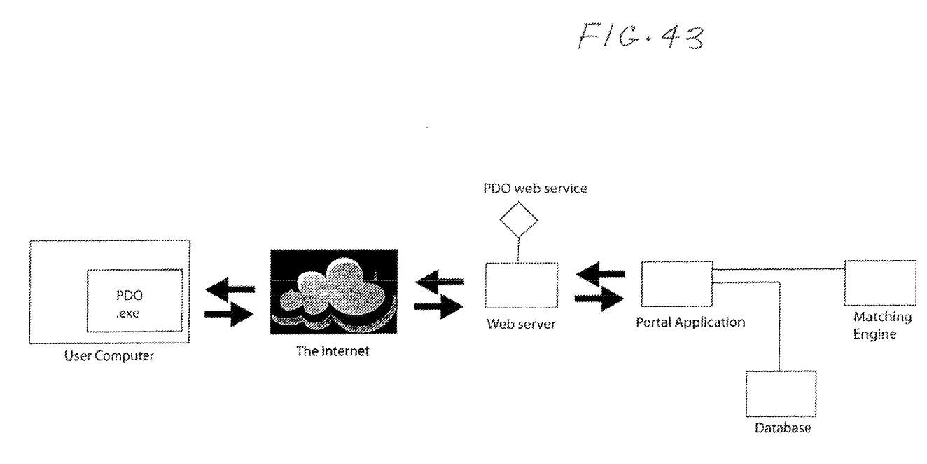

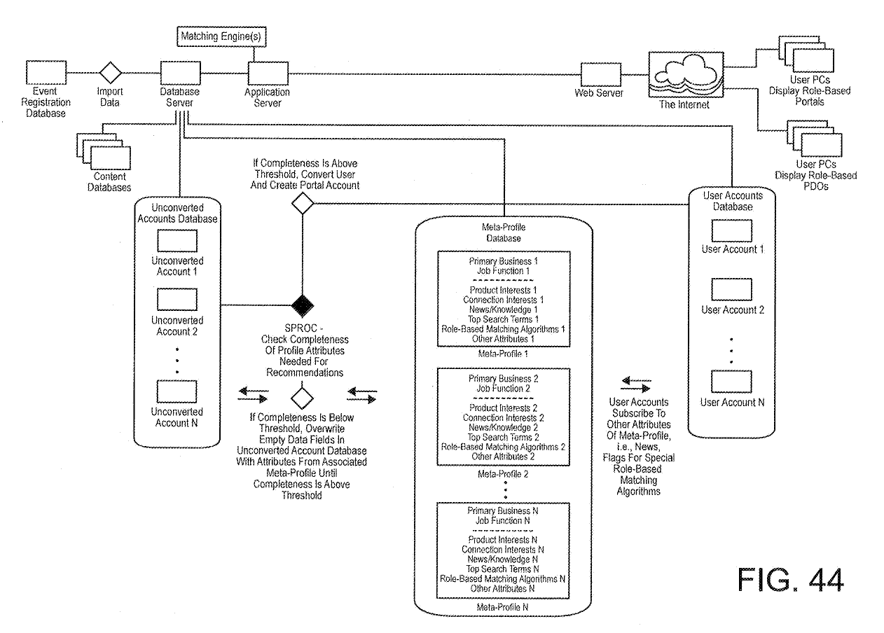

FIG. 44 is a conceptual block diagram for implementing some or all registrants of an event to receive “Role-Based Portals” which inherit some or all of the attributes of a Meta-Profile of other individuals with their same primary business and/or job function (i.e., “role”) and which have other role-based properties. Role-Based Portals solve the problem of the incompleteness of attendee profile data imported from the event registration process. The completeness—or “data health”—of this registration profile data is often poor, due both to registrants rushing inattentively to complete their registration forms and event owners not forcing completion of profile data fields needed by the automated business development system in order to generate relevant recommendations. One function of the Role-Based Portal is thus to ensure that this missing information is supplanted by attributes taken from a Meta-Profile associated with the user's primary business and/or job function (i.e., “role”). Role-Based Portals enable the generation of relevant recommendations for the often large percentage of users of this type whose profile data is incomplete. For example, a senior buyer in a consumer electronics retail superstore business may not have selected product interests during registration for the event. By supplanting this missing critical profile dataset with the most popular product interests taken from the Meta-Profile of individuals with this same primary business and job function, the most significant product interests of this registrant's peers may be inserted into his user profile in the system. Product recommendations of statistically high relevance can then be generated for this user, giving a much more positive out-of-the-box experience with the system. The process for supplanting user profile data fields with Meta-Profile data fields in the Role-Based Portal works based on the following algorithm: (i.) Each user portal account is checked for the completeness, or “data health”, of key profile attribute data fields needed to issue relevant recommendations for that user, (ii.) Accounts identified as having poor data health—i.e., missing any or ail of the key profile attribute data required to generate relevant recommendations—are flagged for Meta-Profile supplementation by this algorithm, (iii.) The system then supplants the empty data fields in these accounts by overwriting them with attributes taken from the Meta-Profile associated with that user role. (iv.) The matching engines within the system can then utilize a complete set of attributes for these users when generating recommendations.

Role-Based Portals can also selectively activate certain role-based recommendations algorithms known to be of high value to distinct demographics of users. The flag to activate one or another of these recommendation algorithm is stored in the Meta-Profile. For example, an engineer in the embedded systems business may have it stored in his associated Meta-Profile to activate a people recommendations algorithm that finds other engineers like himself for the purpose of peer discussion. Yet a business development executive in the embedded systems business may have it stored in his associated Meta-Profile to activate a people recommendations algorithm that finds all registrants who are seeking OEM agreements for the purpose of distribution and growing market share.

Role-Based Portals can also add to personalization by branding the portal according to the formula “[PortalName1] For [Role1]”. For example, a 3-D Artist logging into his MyNAB portal at the National Association Of Broadcasters show would see the portal branded “MyNAB For 3-D Artist”. In FIG. 45, a link such as “Not a 3-D artist? Click here.” may be provided to permit a user to modify his/her profile and role.

Searching and Lead Generation

Whether the user is an exhibitor or attendee at a tradeshow, or any other potential business partner in any forum, the user of the method and system herein will desire to identify and follow up with potential business partners in the relevant population. For those entities which might have a significant audience in the relevant population for their products or services, such as a trade show exhibitor, the method and system set forth herein provide a mechanism allowing the user to generate lists of potential business partner leads among the relevant population, and to track their interactions with one another.

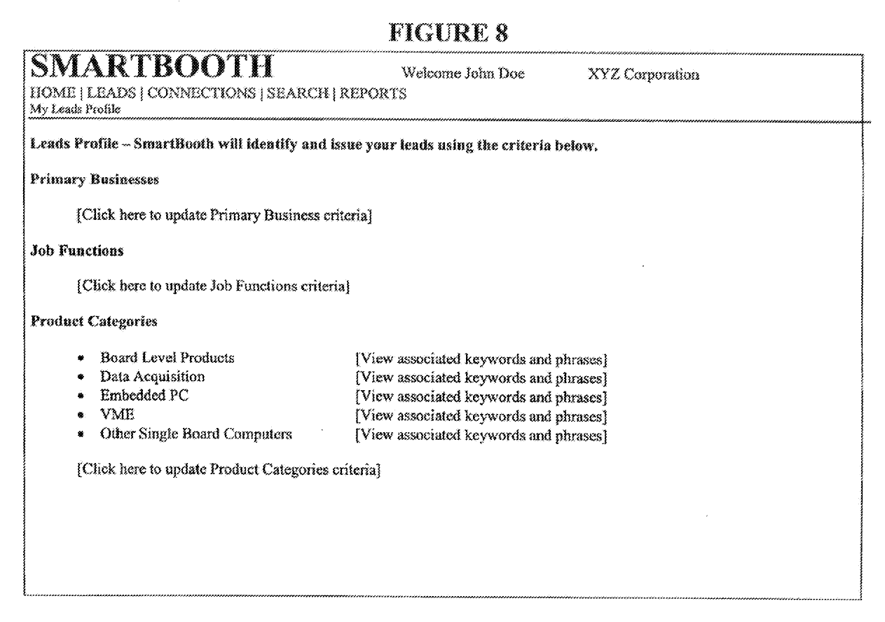

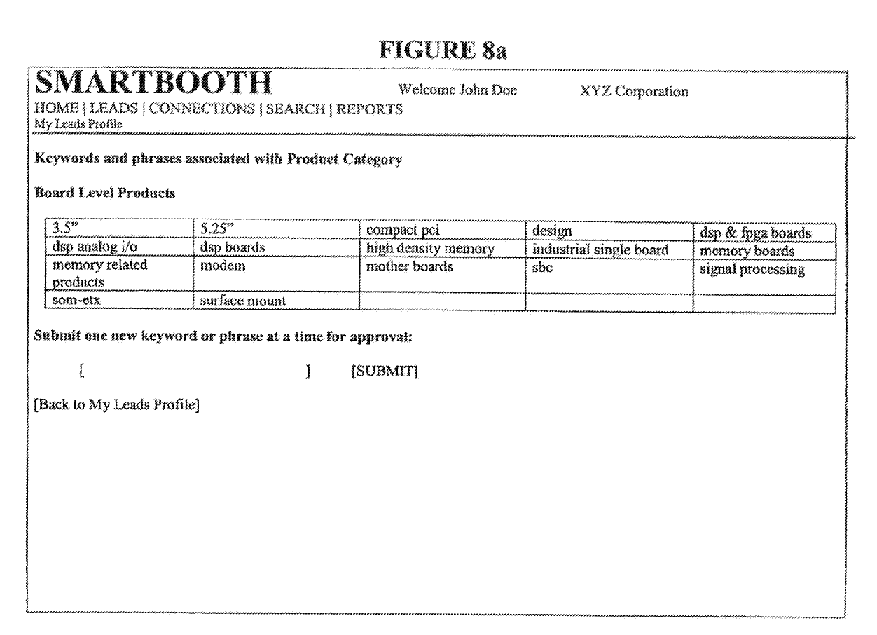

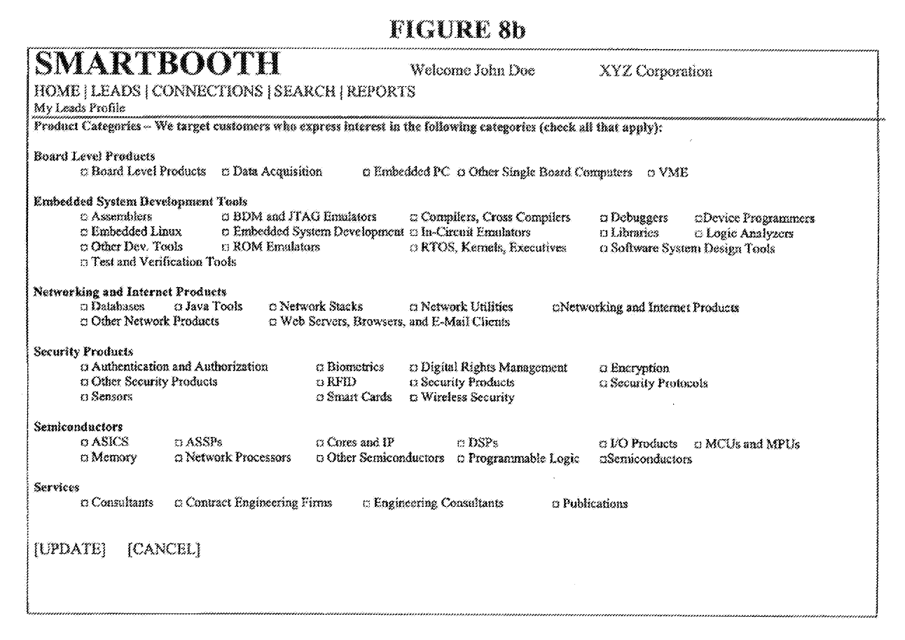

In order to select potential leads from among the relevant population, the user first preferably establishes their own Lead Profile. As shown in FIG. 8, the user is preferably presented a Leads Profile screen which allows the user to establish the criteria which the system will use to determine the set of leads from among the relevant population. The user's Lead Profile is preferably comprised of Primary Businesses which the user or the user's company targets for seeking business transactions, Job Functions which the user or the user's company targets for seeking business transactions, and Product Categories in which the user's or their company's targeted customers express interest. On the Leads Profile screen, the user may access an “update” function on each of those categories in order to select, deselect, or otherwise modify their selections. The specific categories of Primary Businesses, Job Functions, and Product Categories may be modified as appropriate for the specific forum in which the method and system are intended to be used, so long as they correspond to categories of businesses, categories of specific job functions, and categories of products and/or services, respectively.

Each of the Primary Business, Job Functions, and Product Categories may also have associated with their individual entries one or more keywords and/or phrases. As is discussed in greater detail below, such keywords and/or phrases may in turn be used during another user's search to identify the first user as a potential business partner.

In order to effect the lead generation and tracking functionalities, data from the user profiles of other members of the relevant population, and behaviors of such other members, are tracked, recorded, and associated with the entity to whom they relate according to a set of criteria accessible by the system. The system evaluates information in the user profile of each member of the relevant population, for instance, each attendee in a trade show environment, along with certain behaviors of each such member, against that set of criteria which in turn is used to determine a qualitative score for such member as a lead for the user. In a particularly preferred embodiment, the user may be an exhibitor at a trade show, and the members of the relevant population may be attendees, in which case the system evaluates such information from each attendee in order to determine a score for each such attendee as a lead for each exhibitor. The criteria used in order to evaluate the attendee data and behaviors is preferably maintained by an expert knowledge provider having administrative access to database 14 or other file containing the criteria so that such information may be updated, corrected, and otherwise maintained throughout the life of the system. The method and system will periodically automatically evaluate the relevant attendee user profile data and behaviors in order to establish matches and rankings for the attendees as leads for the various exhibitors. All attendees matching each exhibitor's lead criteria (as established by the system) are collected into a list (it being understood that such list may comprise one or more entries in a database file, or other electronic file compiling attendee identifications in suitable form so that they may be electronically linked with specific exhibitors). Preferably, summary information about each exhibitor's list of leads is accessible to that list's respective exhibitor enabling the exhibitor to contact such leads as described in greater detail below.

Optionally, issuance of leads may be governed by subscription rules allowing differing numbers of leads to be accessible to the exhibitor dependent upon the class of lead subscription they ordered.

In order to generate the lead lists for each exhibitor, the data used to generate that list is sorted into conceptual bins of two types, namely, Product Category Bins and Exhibitor-Specific (or other User-Specific) Bins. Product Category Bins collect demographic and behavioral information from attendees (or other members of the relevant population), and for each attendee associated with a Product Category Bin, provide a qualitative lead score and a rank based on that score against other attendees associated with that bin. Additionally, each Product Category Bin may have keywords associated therewith. As discussed in greater detail below, a keyword associated with a Product Category Bin serves to identify attendees, and thus add attendees to the bin, when an attendee issues a search query for a potential business partner using one of the keywords associated with such bin.

Each Product Category Bin identifies a single product category, and associates with such bin Products of Interest that relate to the Product Category for that bin, and any keywords that have been associated with such Product Category. Preferably, an expert knowledge provider may have administrative access to the data in each bin in order to receive, approve, and attach to bins new search keywords submitted by exhibitors that are likewise associated with such Product Category.

In order to submit a new keyword, an exhibitor may, using their Lead Profile form, select a Product Category that they wish to use in order to locate (as leads) those attendees having a specific interest in a given Product Category. Preferably, as shown on the Leads Profile screen of FIG. 8, a user may view the associated keywords and phrases associated with any single Product Category by engaging a “View associated keywords and phrases” function, which function directs the user to a “Keywords and phrases associated with Product Category” screen as shown in FIG. 8a. Such Keywords screen preferably displays all of the keywords associated with a specific Product Category. A user is optionally prompted to input a new keyword or phrase for inclusion in the list of keywords for the given Product Category, and may do so by simply typing the desired keyword in a keyword submission data field and engaging a “submit” function. Once the “submit” function is engaged by the user, it is directed to a keyword review cue where such new keyword may be reviewed by a system administrator for approval. Should the administrator approve the newly submitted keyword, it is added to the list of keywords associated with that Product Category for all users.

When an attendee performs a keyword search, the contents of their search is compared against the existing list of approved keywords. If their search query contains a keyword, that attendee's user identification is added to the bin for the Product Category associated with that keyword. Through the interactions of the attendees with the system, including the information they initially use to populate their User Profile and their behavior within the system to locate potential business partners, data elements are added to Product Category bins, which data elements preferably include the user ID for each user whose demographics and/or behavior matches the criteria set up for that bin, a date for the first behavior (which, in the context of a trade show, would typically comprise the date on which such attendee or other user registers with the system), an ever-changing date for the most recent behavior which placed the user in or updated the user's information in the bin, and a cumulative score (calculated as detailed below) for each attendee user ID in the bin relating to the degree of correlation between the bin criteria and the specific attendee's demographic information and behavioral traits.

It is noted that each of the Leads Profile categories shown on FIG. 8, namely, Primary Businesses, Job Functions, and Product Categories preferably provides a functionality to allow the exhibitor to update their choices under each such category by engaging an update function. For instance, upon engaging an “Update Product Categories criteria” function, the user is presented with a Product Categories selection screen as shown in FIG. 8b enabling the selection of different Product Categories to add to their Leads Profile criteria.

As mentioned above, the second type of conceptual bin is an Exhibitor-Specific (or other User-Specific) Bin. There is preferably one Exhibitor-Specific bin for each exhibitor, which collects attendees that exhibit behaviors that are specifically directed at the exhibitor's company, products or people. Preferably, the Exhibitor-Specific bins particularly collect the unique attendee user ID's for each attendee associated with the bin, their initial behavior date, the type of behavior directed against the company, the date of the most recent behavior, and an overall score (calculated as detailed below) for each attendee user ID in the bin. The attendee behaviors that are considered in determining how to score an attendee within an Exhibitor-Specific bin preferably include company-specific behavior, product-specific behavior, and people-specific behavior. Possible company-specific behavior may include conducting keyword or phrase searches conducted by the attendee, which searches include the company's name, viewing the company's profile, and clicking through a link provided on the company's profile to the company's website. Possible product-specific behavior may include keyword searching for one of the company's specific products, viewing a Product Profile for one of the company's products, or (in the context of a trade show environment) voting for a specific product as, for example, a “show favorite.” Further, people-specific behavior may include searching for a specific employee's name, viewing a particular employee's connection details (explained in detail below), sending or accepting a Connection Request to an employee (explained in detail below), and opening any system-generated communication to such attendee.

When an attendee (or other user of the relevant population) initially registers with the system, demographic information is collected from their User Profile and from any subsequent revisions that they make to their User Profile. Once registered with the system, the attendee's Products of Interest are mapped to Product Categories using an Exhibitor's Product Categories to Attendee's Products of Interest mapping file. The resulting list of Product Categories is evaluated against the criteria associated with each bin. If the attendee's Product of Interest matches one or more of a bin's Product Categories, then the user ID for that attendee is added to the bin with an initial score of 1. As more of the attendee's Products of Interest are evaluated, the user ID and score is added to other bins. If the user matches more than once on any bin, the score for that user ID is incremented by one in that bin. The same data is evaluated for each user in the system and scored into the bins. As a result, bins will contain various numbers of user ID's with different scores. Preferably, changes made to a user's User Profile will be propagated through and will appropriately modify the contents of the relevant bins. For instance, if an attendee adds a Product of Interest, then the data in the appropriate bins will be incremented. If the attendee removes a Product of Interest from his User Profile, then the data in the appropriate bins is decremented.

As mentioned above, searching activity by a user is likewise a behavior that will cause scoring and ranking in a bin, such as searching product categories, companies, people, educational sessions at a trade show, keywords, etc. Keyword searches by each attendee are evaluated against the current community-specific list of approved keywords. More particularly, each time an attendee searches using a query containing an approved keyword for a particular bin, their user ID is added to the bin with an initial score of 1. If that user ID is already in the bin, his score is incremented by 1.

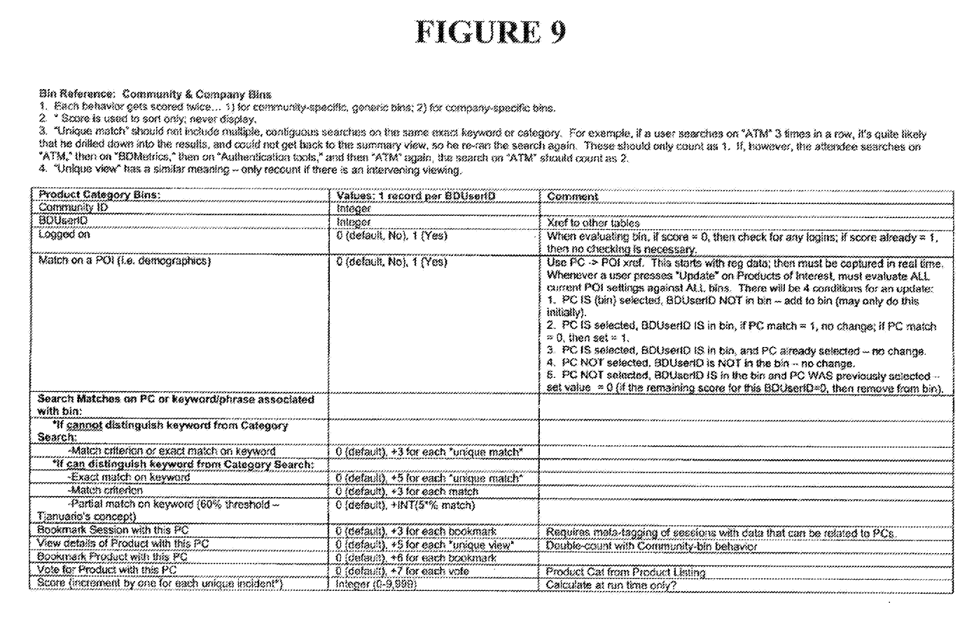

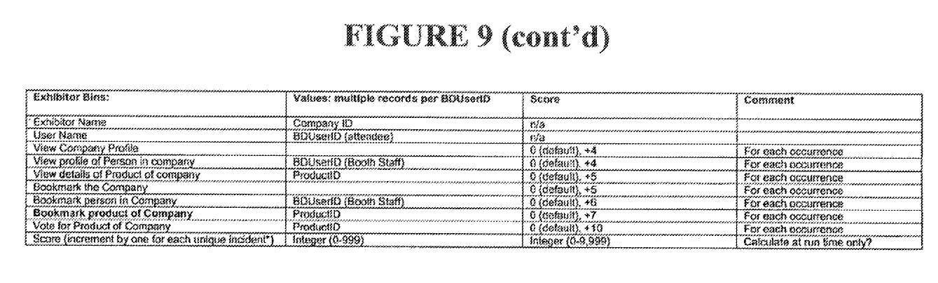

The scoring for various behaviors and demographics will now be explained. As shown in FIG. 9, exemplary data elements associated with both Product Category bins and Exhibitor-Specific bins are presented. A Product Category bin preferably carries the following data elements:

a. a code identifying the specific product category (Community ID)

b. a user ID for the attendee(s) in the bin;

c. an indication of whether the specific attendee is logged on to the system;

d. an indication of whether there was a match on a Product of Interest (from the attendee's User Profile, using a Product Category to Product of Interest mapping);

e. an indication (and score value) of whether the attendee has searched using a matching keyword or Product Category;

f. an indication (and score value) of whether the attendee has bookmarked a session (i.e., and educational session at a tradeshow) relating to the Product Category of the bin;

g. an indication (and score value) of whether the attendee has voted for a product as a “best of show” product in the Product Category of the bin; and

h. a final score for the attendee based on the above values.

Notably, the specific values presented for each score may be modified as experience dictates by those of ordinary skill in the art to customize the relative strength of each criteria without departing from the spirit and scope of the invention. Likewise, other values and metrics (i.e., behaviors) could be added to the above to provide a more refined scoring for each attendee and the degree of association they have with any given Product Category.

Similarly, an Exhibitor-Specific bin preferably carries the following data elements:

a. a code identifying the specific Exhibitor (Company ID)

b. a user ID for the attendee(s) in the bin;

c. an indication (and score value) of whether the specific attendee has viewed the exhibitor's User Profile;

d. an indication (and score value) of whether the specific attendee has viewed the User Profile of an individual person within the Exhibitor Company;

e. an indication (and score value) of whether the specific attendee has viewed the details of a Product of the Exhibitor Company;

f. an indication (and score value) of whether the attendee has bookmarked the Exhibitor Company;

g. an indication (and score value) of whether the attendee has bookmarked an individual person within the Exhibitor Company;

h. an indication (and score value) of whether the attendee has bookmarked a Product of the Exhibitor Company;

i. an indication (and score value) of whether the attendee has voted for a product of the Exhibitor Company as a “best of show” product; and

j. a final score for the attendee based on the above values.

Once again, the specific values presented for each score may be modified as experience dictates by those of ordinary skill in the art to customize the relative strength of each criteria without departing from the spirit and scope of the invention. Likewise, other values and metrics (i.e., behaviors) could be added to the above to provide a more refined scoring for each attendee and the degree of association they have with any given Exhibitor Company.

While exemplary only, FIG. 10 presents a summary chart of the various criteria and score values associated with such criteria in determining the scores that are to be associated with each User ID placed into a bin.

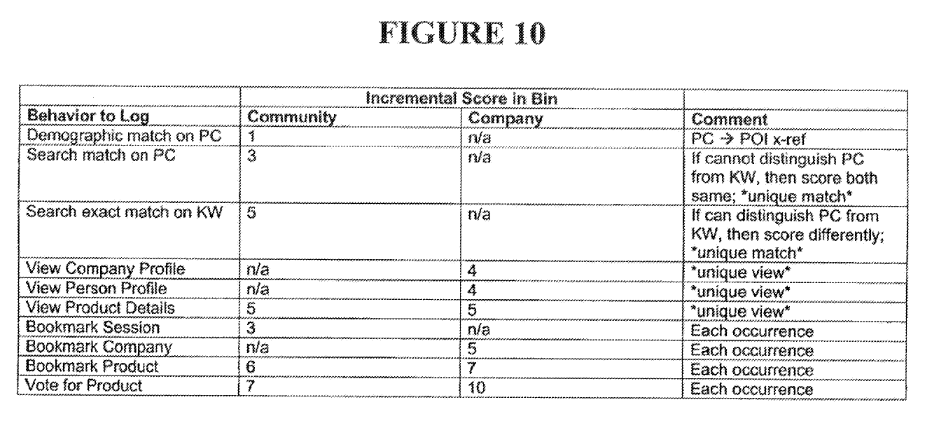

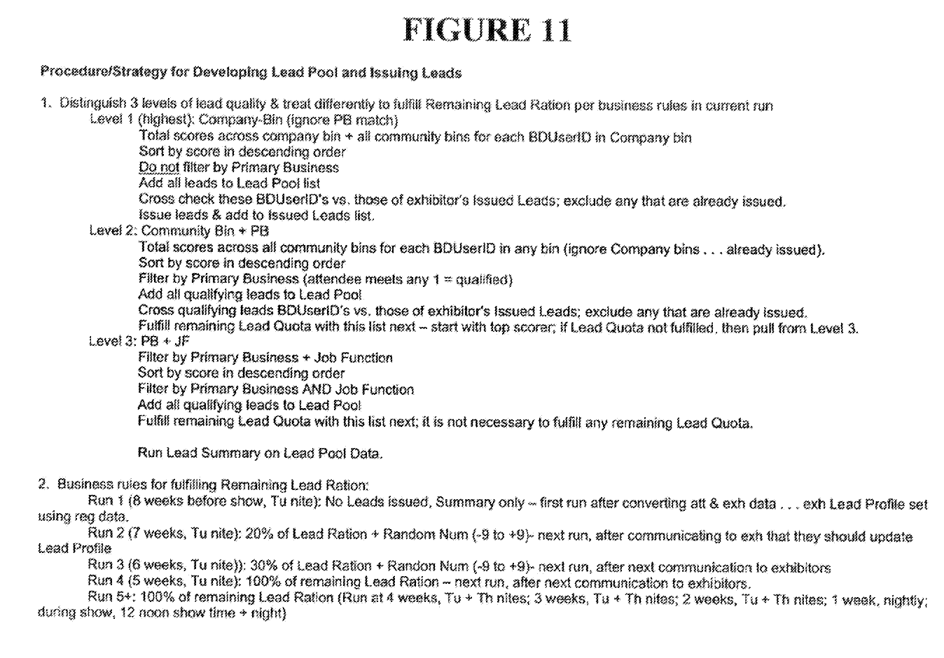

The foregoing discussion explains scoring of each user ID placed within either a Product Category bin or an Exhibitor Specific bin. However, in addition to providing a score for each such user ID, in order to appropriately distribute the contacts represented by the user ID's as leads, it is also desirable to rank the entries in each bin. As shown in FIG. 11, that ranking is preferably accomplished using a three stage screening process. More particularly, at level 1, all of the entries in each Exhibitor-Specific bin are analyzed in order to establish a ranking and disperse leads to such Exhibitor's Lead List. The exhibitor's Lead List is a listing of all potential leads for that exhibitor, and may optionally be provided to the exhibitor (as detailed below) in accordance with a distribution scheme that disperses select numbers of leads over time, in numbers that are determined by a subscription level purchased by the individual exhibitor. In the Level 1 analysis, the scores for each user listed in the Exhibitor-Specific bin are totaled. Likewise, for each such user listed in the Exhibitor-Specific bin, their scores in ail related Product Category bins are likewise totaled, and this value is added to their prior score. Once these values are calculated for each entry in the Exhibitor-Specific bin, all entries are then sorted in descending order. All leads are then added to the Exhibitor's Lead List. The user ID's for all leads so placed on the Exhibitor's Lead List are then cross checked against the list of leads that have already been issued to such Exhibitor, i.e., those leads whose contact information has actually been forwarded to the specific Exhibitor, and any leads that have already been issued are deleted. This first level of analysis represents the top leads available for each exhibitor.

In the Level 2 analysis, the scores for each user listed in the Product Category bin are totaled and then sorted by score in descending order. Once sorted, the users are filtered by Primary Business criteria. In the user's own User Profile, during registration with the system, the user is prompted to enter their own Primary Business, and such data is stored in the user's User Profile. Such Primary Business data element may be a separate data element from those discussed above comprising the User Profile, or may optionally comprise the attendee's “My Product Offerings” data in their User Profile. If a specific attendee/user matches their own Primary Business with the Primary Business of the specific bin, then they are designated as a qualified lead in that bin. Once all attendees/users are evaluated, all resulting qualifying leads are added to the appropriate Lead Pool, i.e., they are added to the Lead Pool of each exhibitor that has a matching Primary Business with such bin. Preferably, such resulting qualifying leads are compared against the leads already in each Lead Pool before placement in such Lead Pool in order to exclude any leads that have already been placed in such Lead Pool.

In the Level 3 analysis, the remaining leads (those not already distributed to the exhibitor's lead list in Levels 1 and 2) are filtered by Primary Business and Job Function, classifying the remaining leads based on their individual Primary Business and Job Function criteria. As with the Level 2 analysis, if a specific attendee/user matches their own Primary Business or Job Function with the Primary Business or Job Function criteria of an Exhibitor-specific bin, then they are designated as a qualified lead in that bin, and added to such Exhibitor's Lead Pool.

Once the leads are distributed to the specific exhibitor's lead list as indicated above, they may optionally be transmitted to the actual exhibitor in accordance with a distribution scheme that portions leads based on a subscription level purchased by the individual exhibitor. For example, the system may automatically distribute a certain percentage of leads from the exhibitor's lead lists at evenly spaced time intervals until all leads in the exhibitor's lead list are so distributed.

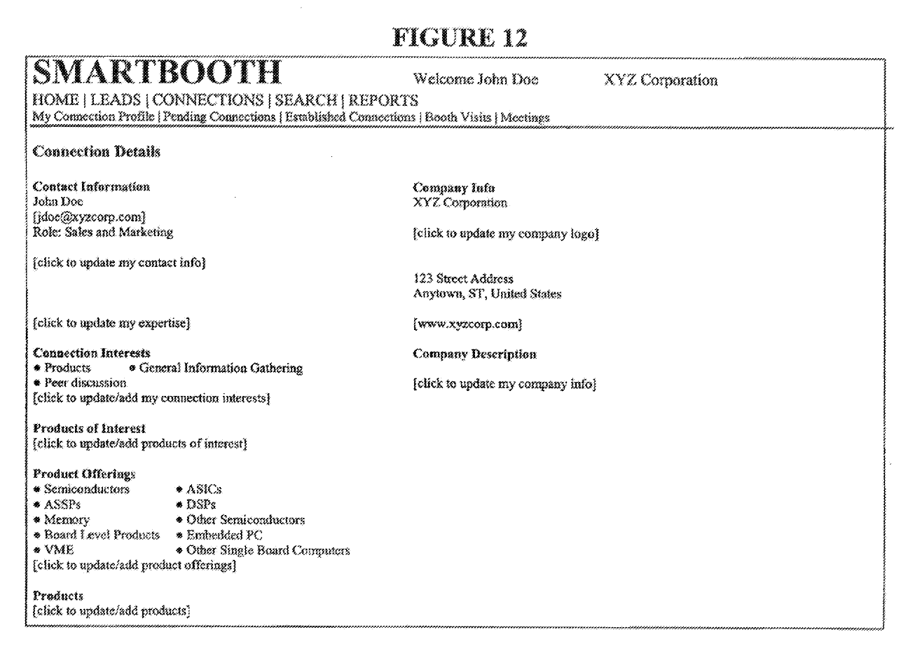

Distributed leads are made available to an exhibitor through a “Connections” function. While leads are determined for and distributed to exhibitors only, both exhibitors and attendees are provided such a Connections function. As shown in FIG. 12, an exhibitor (or attendee) may access a Connections Detail screen which summarizes the information that would be made available to those potential business partners with whom contact is made. Preferably, such information includes the individual's contact information including their role, the individual's area of expertise, their Connection Interests, their Products of Interest, their Product Offerings, and optionally specific products that they wish to promote to the population. Also included on Connection Details screen is preferably the individual's company information, including any description of the company that had been provided by that user.

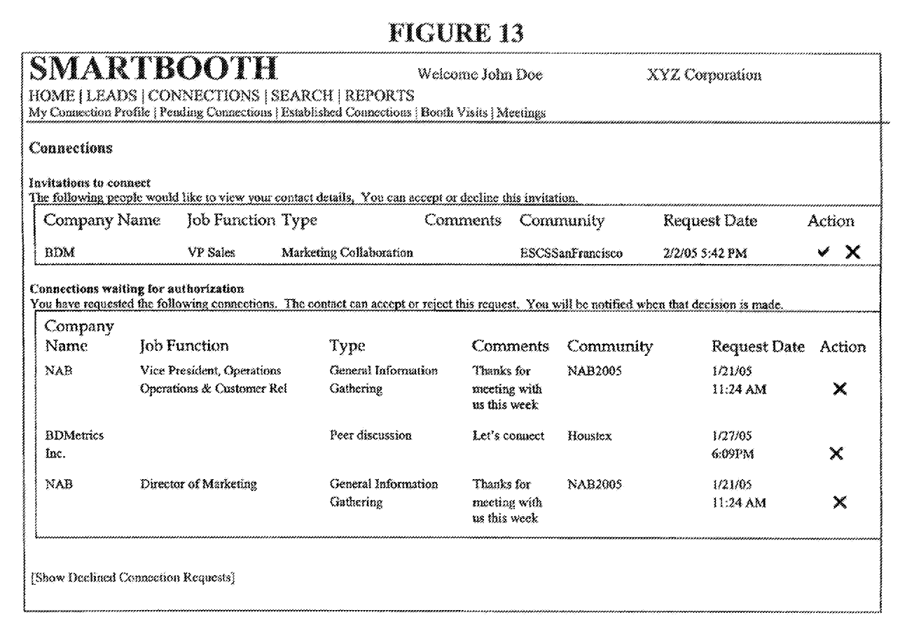

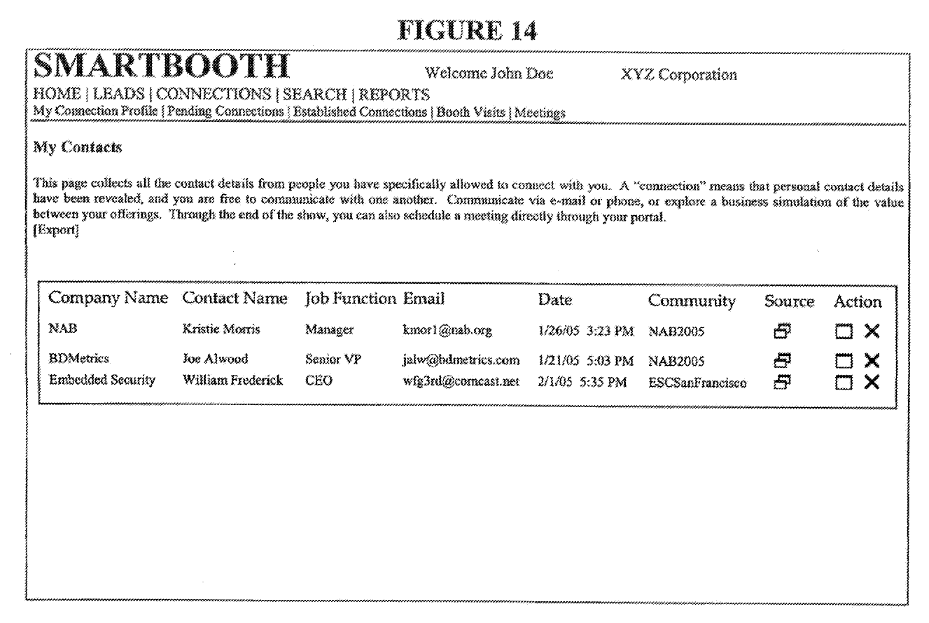

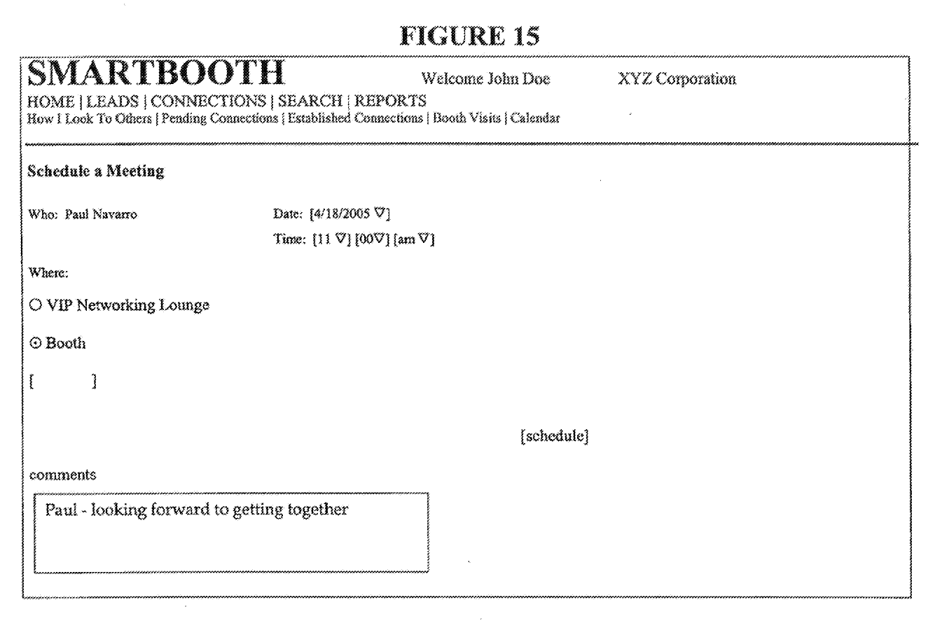

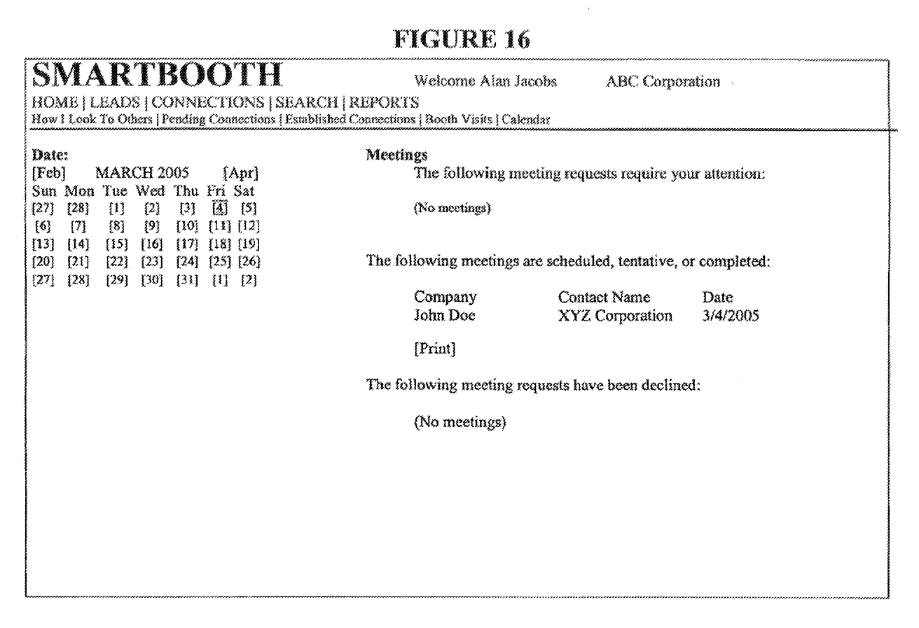

As a result of searching for potential business partners and locating those of interest, a user may send a connection request to such potential partner in an attempt to establish contact and pursue a potential business transaction. The process by which a user conducts such search and initiates a connection request is discussed in greater detail below. After such a connection request is either sent by the user or received from another user, it is reflected on a Pending Connections screen as shown in FIG. 13. More particularly, the Pending Connections screen provides “Invitations to connect” listing incomplete contact information for other users who have requested contact with the user. Such information preferably includes the company name, job function, and type of connection sought by the other users. Also provided on the Pending Connections screen is a “Connections waiting for authorization” listing incomplete contact information for other users with whom the individual user has requested contact. Again, such information preferably includes the other user's company name and job function, along with the type of connection sought by the individual user. After the individual users referenced on the Pending Connections screen accept an invitation to connect, they are then listed on an Established Connections screen as shown generally in FIG. 14. For each entry listed on the Established Connection screen, the user is preferably provided complete contact information, namely, a display of such other user's company name, contact name, job function, and email address so that direct communication may proceed with such other users. Optionally, a meeting scheduling function may be employed for each such contact to enable scheduling of a meeting with such contact. As shown in FIG. 15, employing the meeting scheduling function from the Established Connection screen will bring up a “Schedule a Meeting” screen providing opportunity to input a specific date and time for a meeting, along with comments the user wishes to send to the potential meeting partner. By engaging a schedule function, the user is then presented a Meeting Calendar screen as shown in FIG. 16 which displays any meeting requests made by the user, meetings scheduled, tentative, or completed, and meetings that have been declined by their invited partner. For outstanding meeting requests, a user may elect to accept the meeting, in which case the entry is moved from “meeting requests requiring attention” to scheduled meetings, and is noted on the user's calendar.

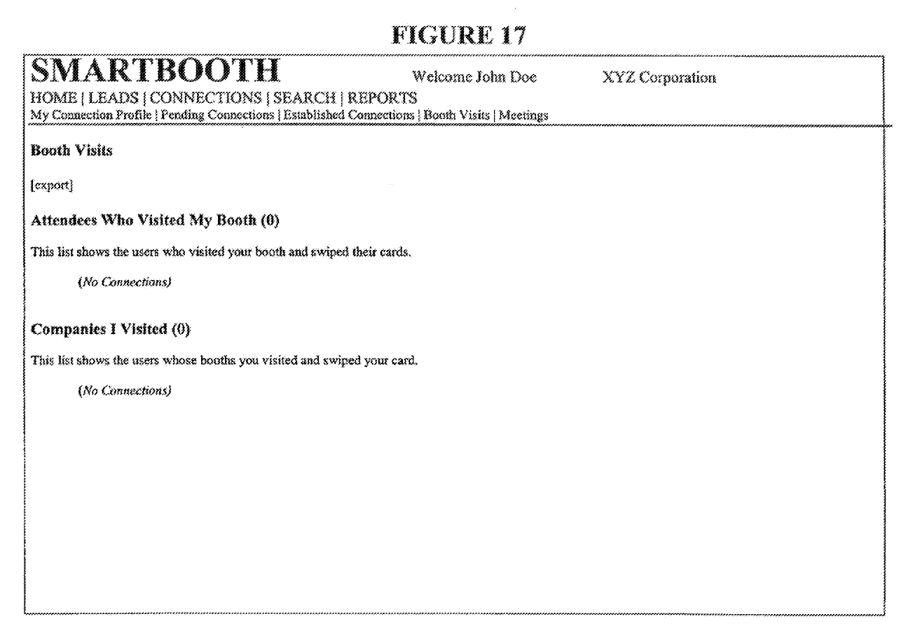

In a trade show environment, it is also desirable to maintain record of companies that the user has visited, and if the user is an exhibitor, record of individuals that have visited the user's own booth. Preferably, such connections are listed as a separate connection on a Booth Visits page (as shown in FIG. 17), which page preferably displays to the user the complete contact information for attendees/other users who visited the user's booth, along with the booths that such individual themselves visited. As explained, in greater detail below, such data is used in order to create and display to the user metrics indicating the extent of contacts made among the relevant population.

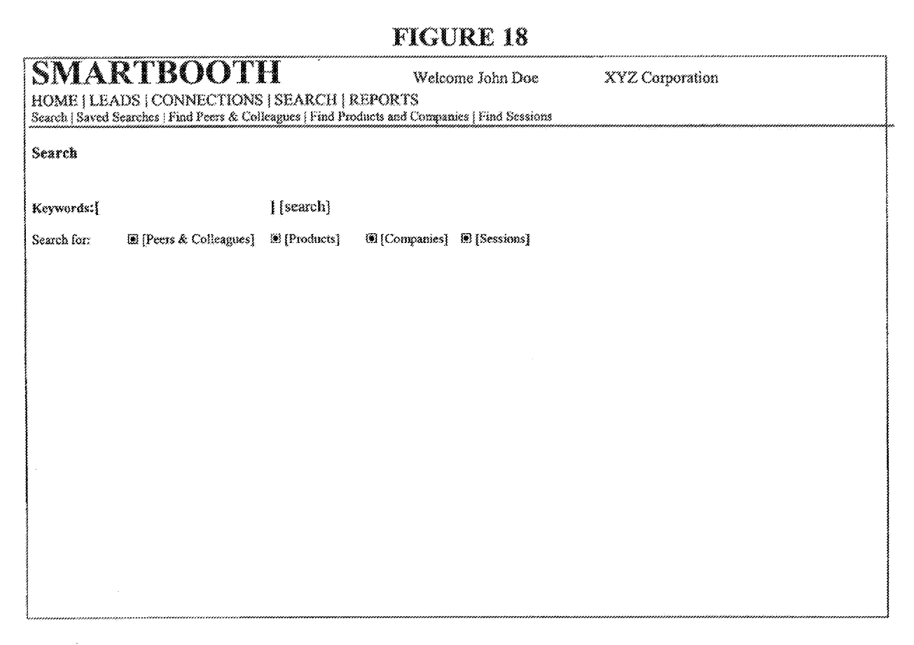

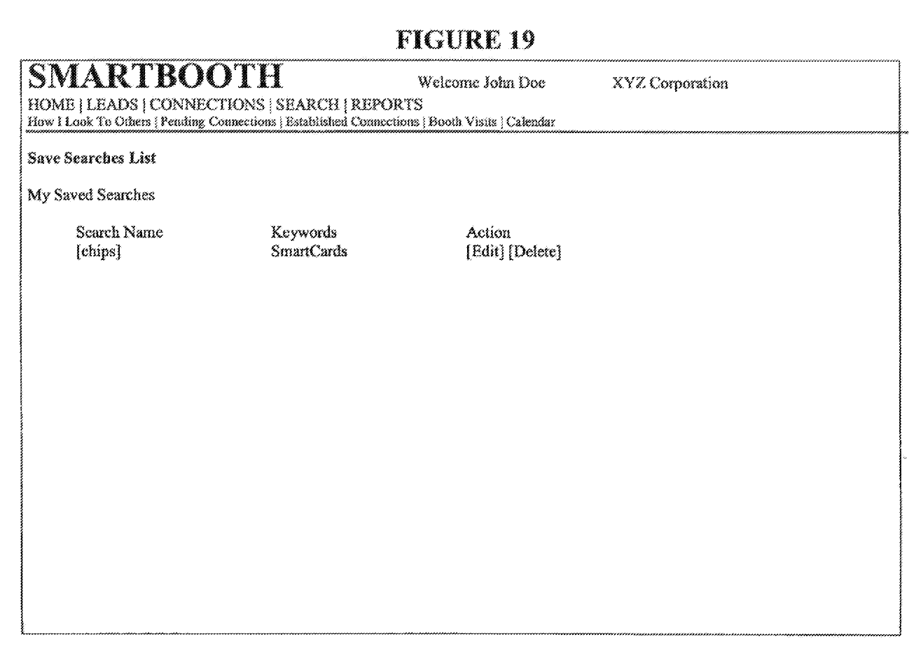

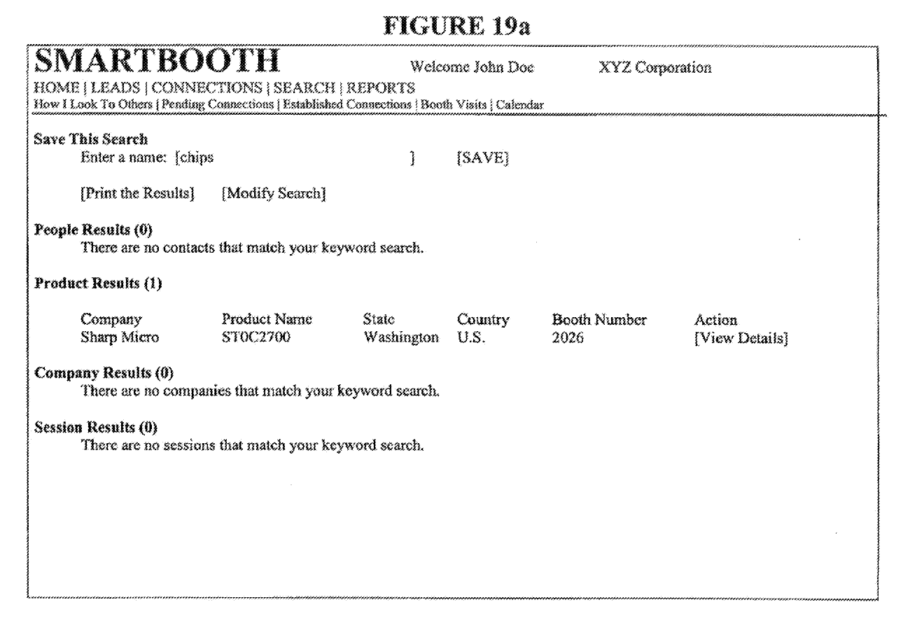

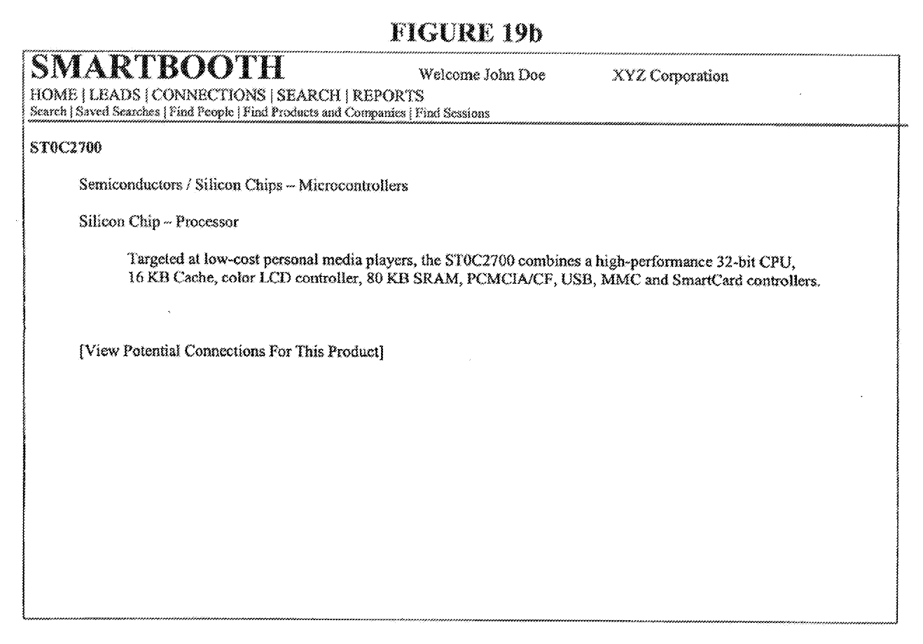

As mentioned above, it is also desirable for users to be able to search the relevant, population in order to locate those entities with whom such user might wish to seek contact in order to, for example, pursue a potential business transaction. The system thus provides users a search functionality for this purpose. As shown in the exemplary Search function screen of FIG. 18, a user may enter a search query in a data entry field, and preferably is prompted to select categories in which such search is to be conducted. Preferably, such categories include people (“Peers and Colleagues”), products, specific companies, and optionally sessions to be held at a tradeshow. As shown in FIG. 19, prior searches conducted by the user are preferably saved on a Saved Searches List for recall by the user. Preferably, the name of the search provides an active link which, when activated by the user, presents the current results of such search on a Search Results screen as shown in FIG. 19a. The Search Results screen preferably provides results for each search category, namely, People Results, Product Results, Company Results, and Session Results matching the user's keyword search. Preferably, for any such results presented, a View Details function is enabled which, when activated by the user, presents a Results Detail screen as shown in FIG. 19b providing the relevant details for such results category.

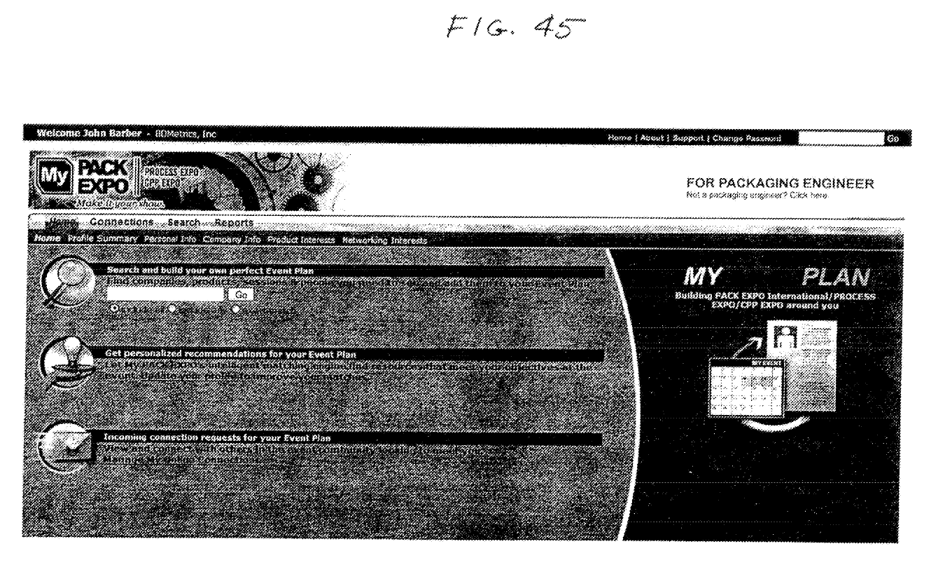

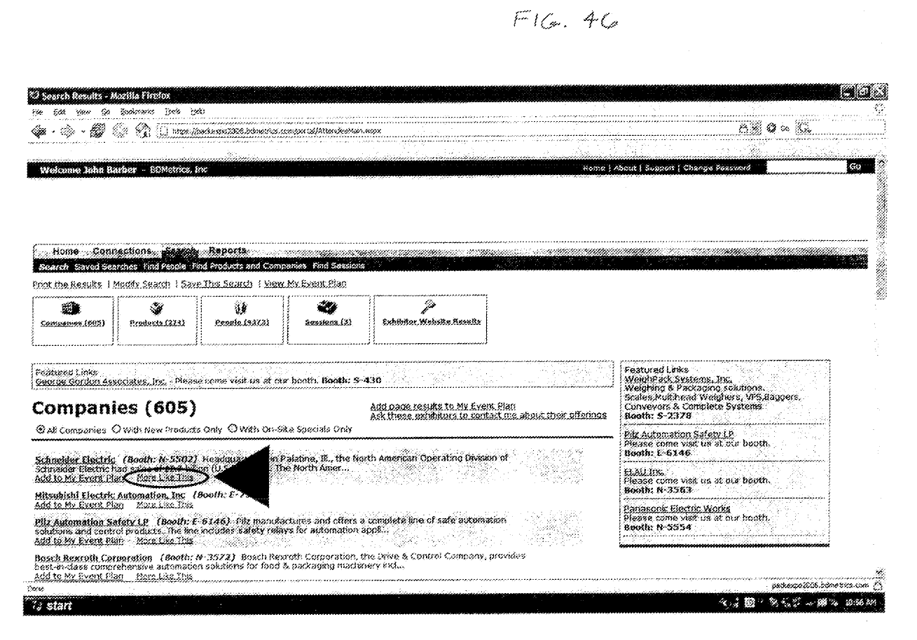

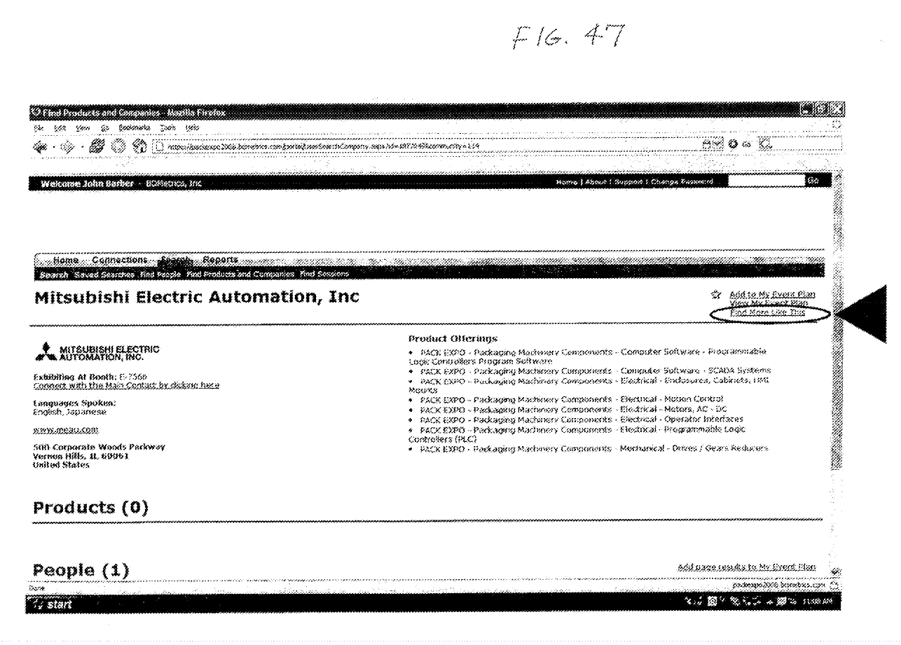

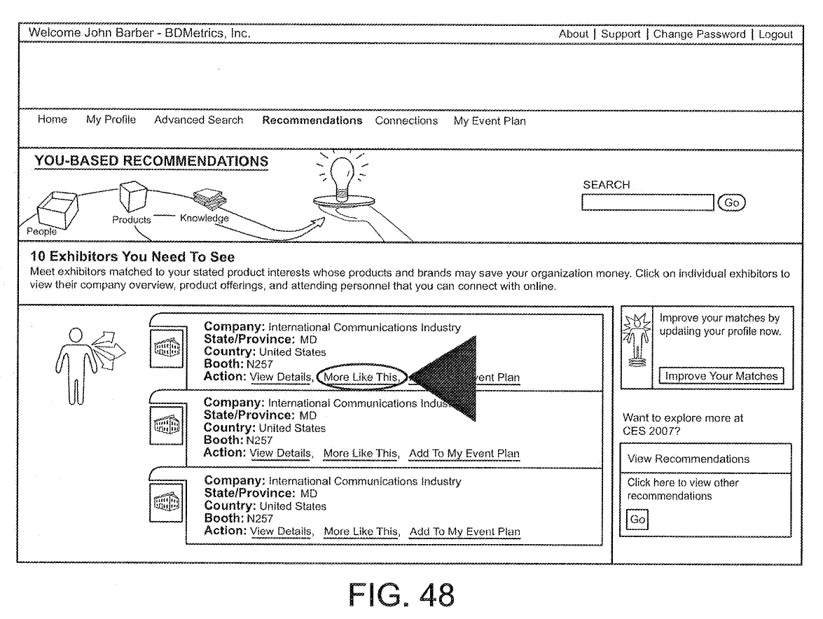

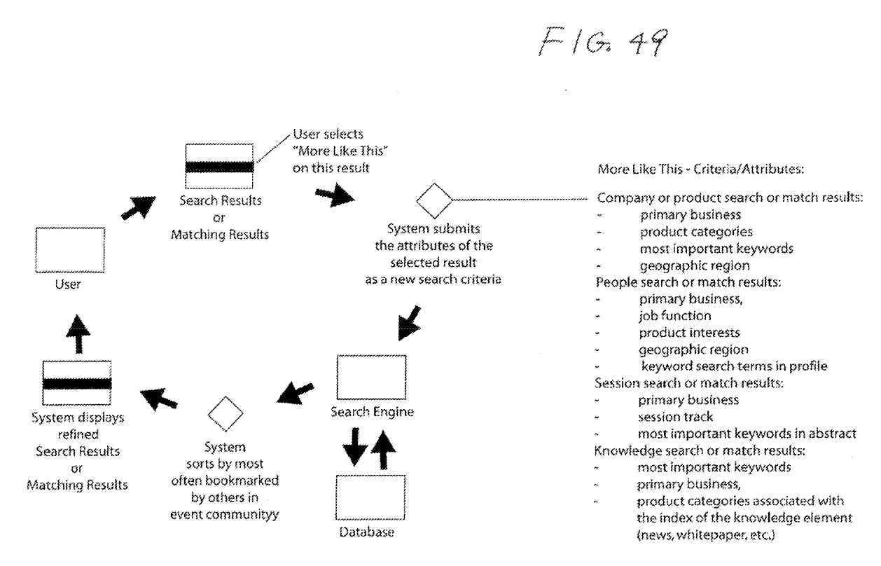

FIGS. 46-49 illustrate interfaces and a conceptual system diagram that enables users in an event community to be able to increase the relevance of their search results or recommendations by running a secondary search or match based on the result they like best. The system and method thus can provide a “More Like This” option as illustrated in FIGS. 46-49. For example, FIGS. 46-48 illustrates exemplary interfaces of the “More Like This” option given on the search results, matching results, and search detail pages of the system. Selecting the “More Like This” option can cause the system to submit a more refined set of criteria to the search engine, run this as a search, and return a new result set for the user. FIG. 49 provides a conceptual system diagram for implementing the “More Like This” system and method. In Company or Product Search Results, selecting “More Like This” can cause the primary business, product categories, most important keywords, and geographic region in the company or product listing to be submitted as search criteria. In People Search results, it can cause the primary business, job function, product interests, geographic region, and keyword search terms stored within the person's profile to be submitted as search criteria. In Session Search Results, it may initiate a new search using the primary business, session track, and most important keywords in the session abstract as criteria. In Knowledge Search Results, it can submit a new search using the most important keywords, primary business, and product categories associated with the index of that knowledge element (news article, white paper, Podcast, etc.) as the criteria. “More Like This” orders its search results in descending order of relevance and popularity, placing those most-often-bookmarked by other users in the event community at the top of results.

In FIG. 49, a database may be used to store data associated with a plurality of users of an event. The “more like this” system may permit a user of a user portal application and/or 365-day industry web portal to submit a search associated with a communication network in order to produce a set of primary search results. As used herein, the 365-day industry web portal is a portal that can be operational ail year round. The “more like this” system is capable of selecting a single primary search result from the set of primary search results based on attributes of high interest to the user, and then submit the selected single primary result as a new, secondary, more refined search in order to find additional results having attributes similar to the selected single primary search result. Processor 12 within the system can then analyze attributes of the stored data in the database of the user portal application and/or 365 day industry web portal for closeness of fit to attributes associated with the submitted search. Further, a display device may be used to output a secondary search result in accordance with items that match a closeness of fit to the analyzed attributes.

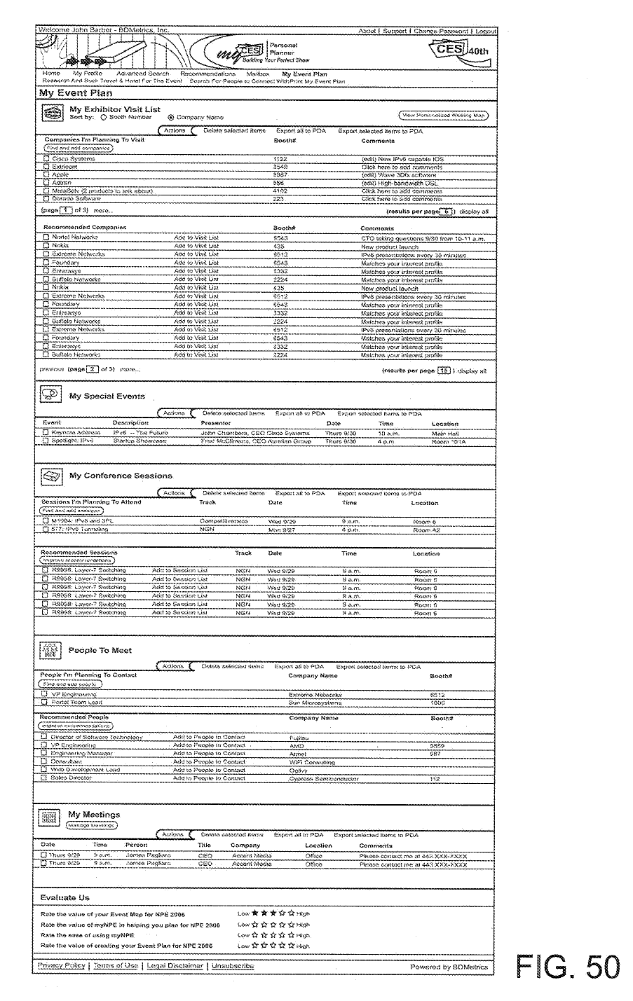

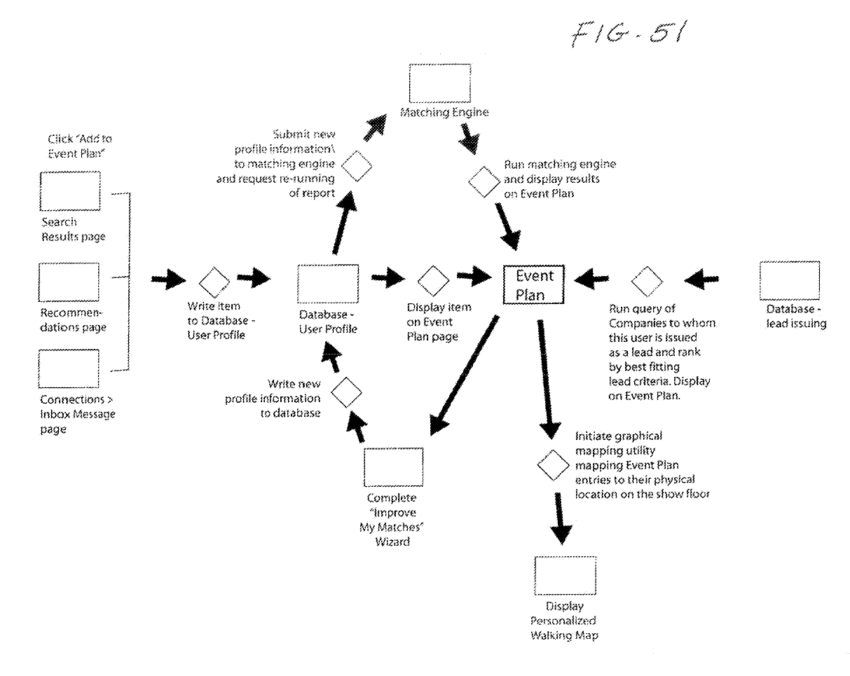

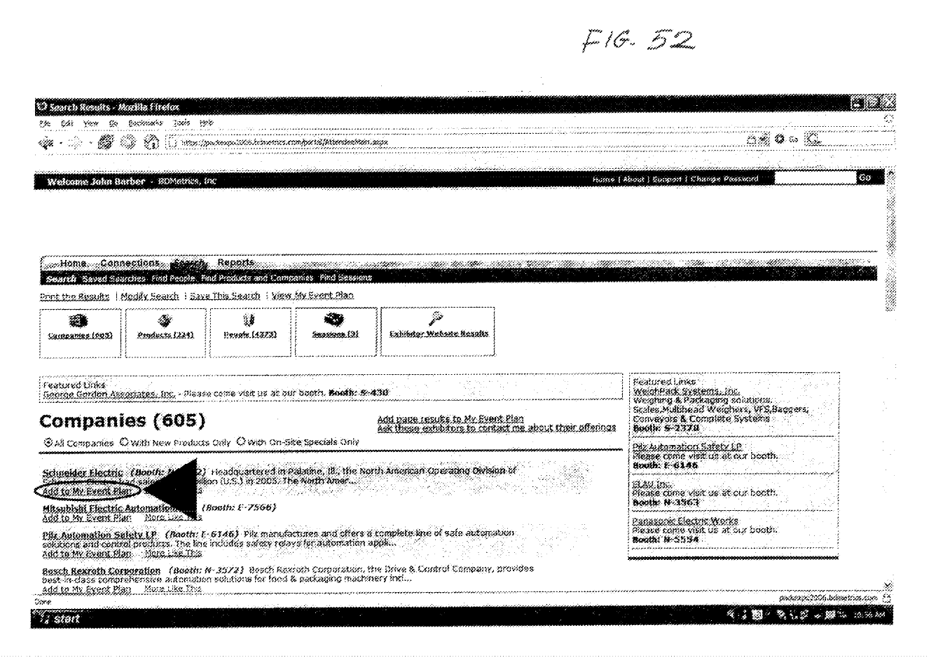

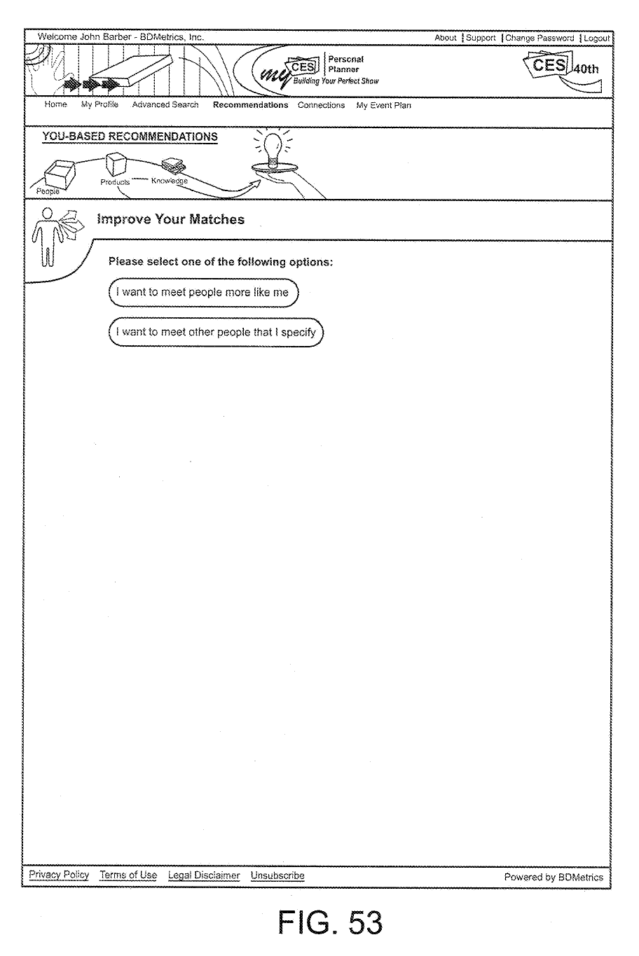

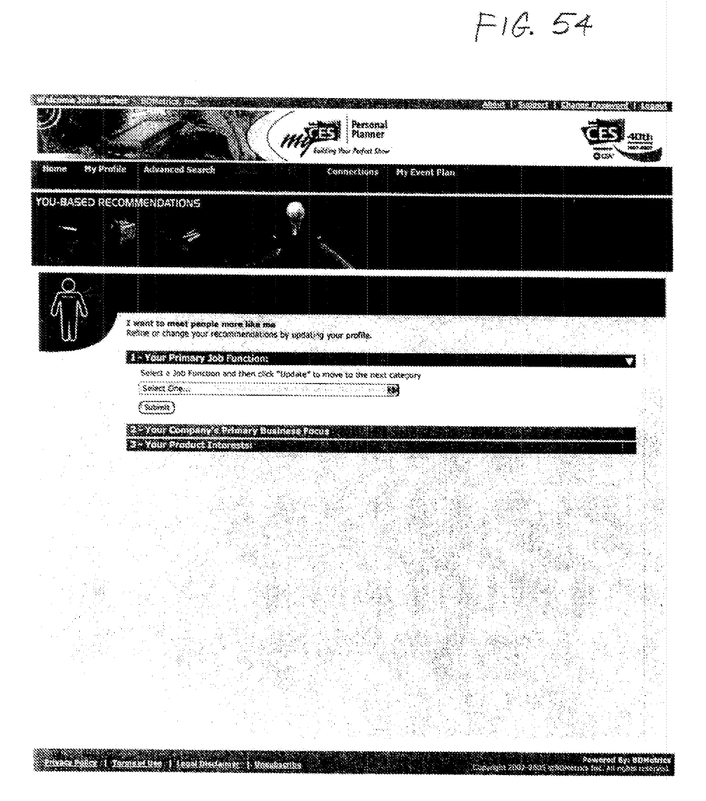

FIG. 50 is an exemplary interface that provides users with the ability to add search results and incoming connections of high personal interest to an “Event Plan” within their personal portals which also displays recommended content from the event that is personalized for them. FIG. 51 is a conceptual system diagram for implementing the Event Plan Utility, which is a combination of a web page, associated code, database tables, and the matching engine. Working together, these elements display a structured list of companies, products, sessions, people, and knowledge content (e.g., news, whitepapers, Podcasts, etc.) that the user has placed there by clicking the “Add To My Event Plan” link within the system as illustrated in FIGS. 50-52. FIGS. 50 and 51 illustrate how integration of the Event Plan and the matching engine enables the display of recommended companies, sessions, people, and knowledge in clearly demarcated “recommendations” areas. For example, FIG. 50 illustrates an interface that may permit the user to move items from the “recommended” area of the Event Plan to the “planning to visit” area. As illustrated in FIG. 51, items are placed on the Event Plan by saving them to the user's profile in the database as “bookmarks” which are then read by the system and displayed on the user's Event Plan page. The Event Plan Utility automatically populates itself with recommendations that originate from sources within the system best suited to optimize value for the user and stimulate commerce at the event. The source of recommended Companies is a lead-issuing system. An Event Plan query of recommended companies finds every company to whom the user has been issued as a lead, ranks them in descending order of most lead criteria met, and displays them in the recommended companies area. FIG. 51 also illustrates that the sources of recommended Sessions, People, and Knowledge for the Event Plan are the corresponding You-Based reports generated by the matching engine. FIGS. 50 and 53-55 illustrate the user being able to interactively improve the recommendations displayed in the Event Plan, and so the system includes an “improve recommendations” button and associated task path. This “improve your matches” path displays web pages of a matching wizard which collects attributes of the user's profile or attributes of the item he or she would like to be matched to. This “improve your matches” wizard then submits these inputs to the matching engine and automatically displays the improved match results both in the associated area of the Event Plan and in the user's You-Based personalized matching report pages of the portal. It is also desirable that the Event Plan be integrated with a graphical mapping utility that maps items onto their physical locations on the show floor. FIG. 50 further illustrates an interface that facilitates the initiating process by clicking the “View Personalized Walking Map” button. FIG. 52 is an exemplary interface having an “Add to My Event Plan” button that may be used for implementing an Event Plan being polled by the database to keep a behavioral bin of the user's bookmarks for behavioral scoring purposes. It is also desirable that the Event Plan be presented via an interface that is easily scannabie and displays only the first few results in each section, provides users with pagination controls allowing easy viewing of the next sets of items and expanding and collapsing of the number of items displayed. It is also desirable that the Event Plan be printable in a simple printer friendly version.

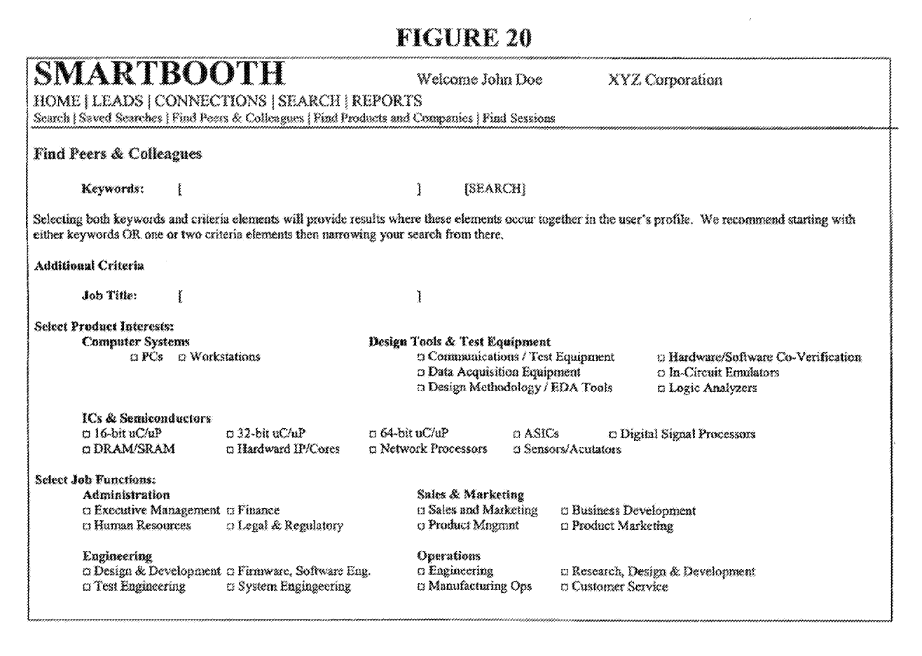

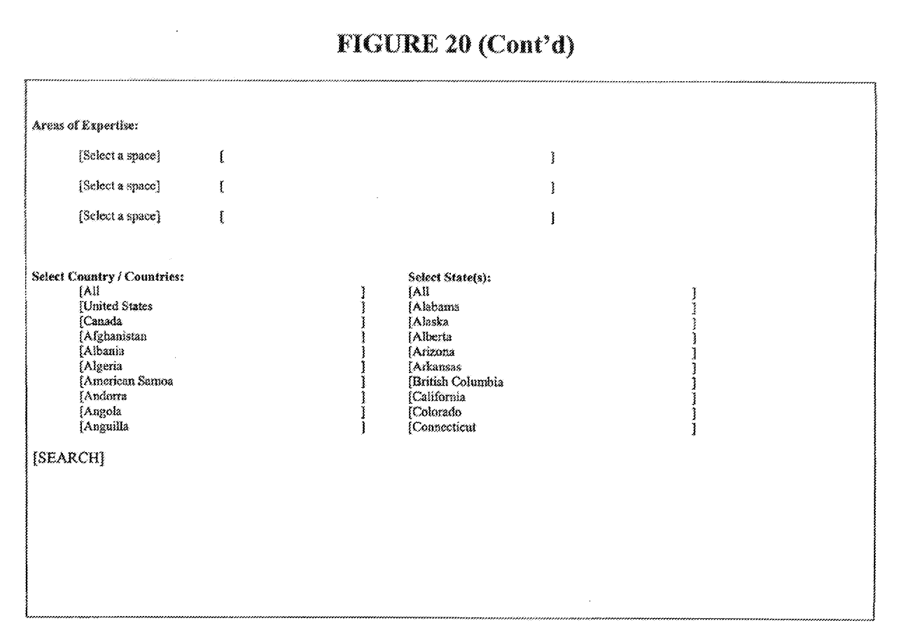

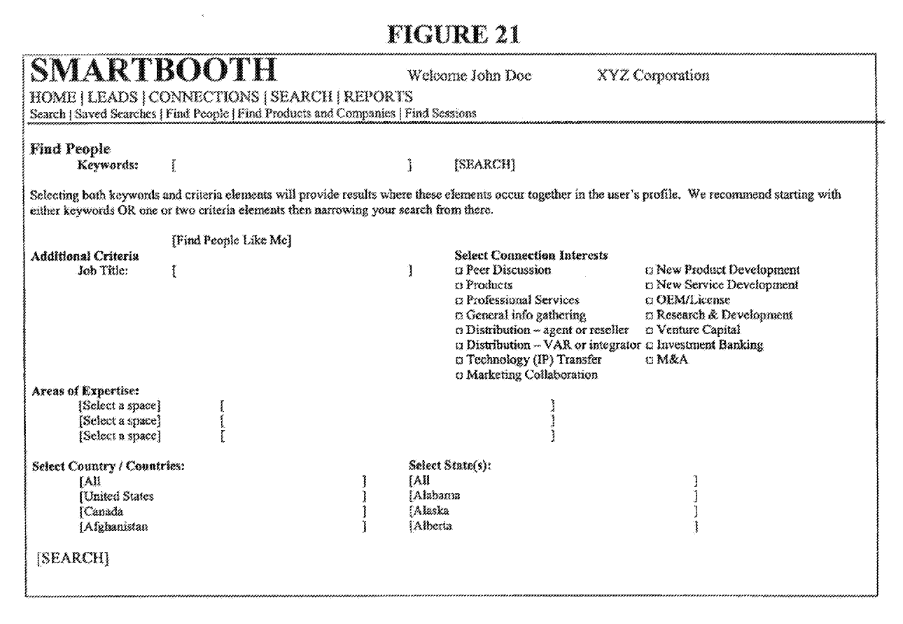

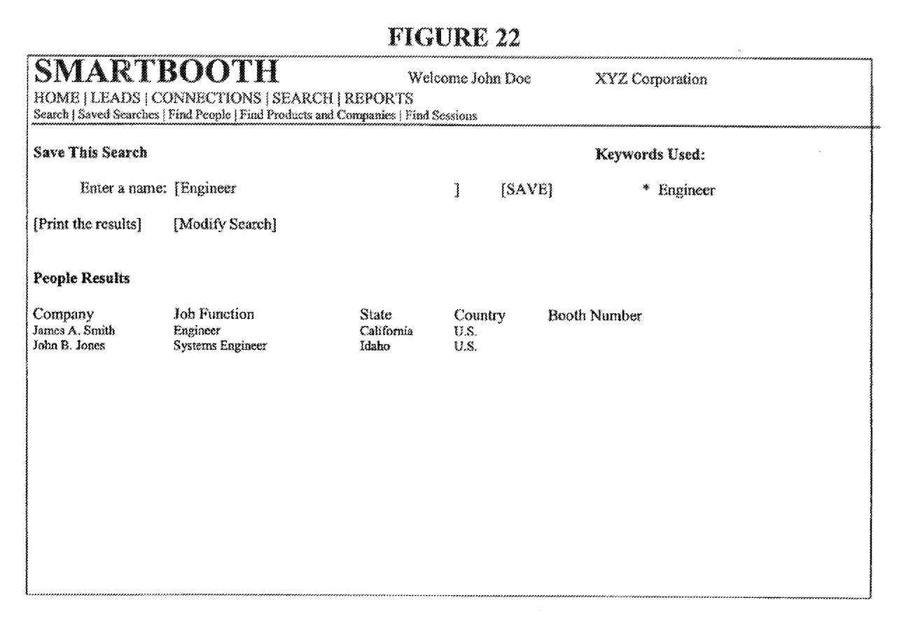

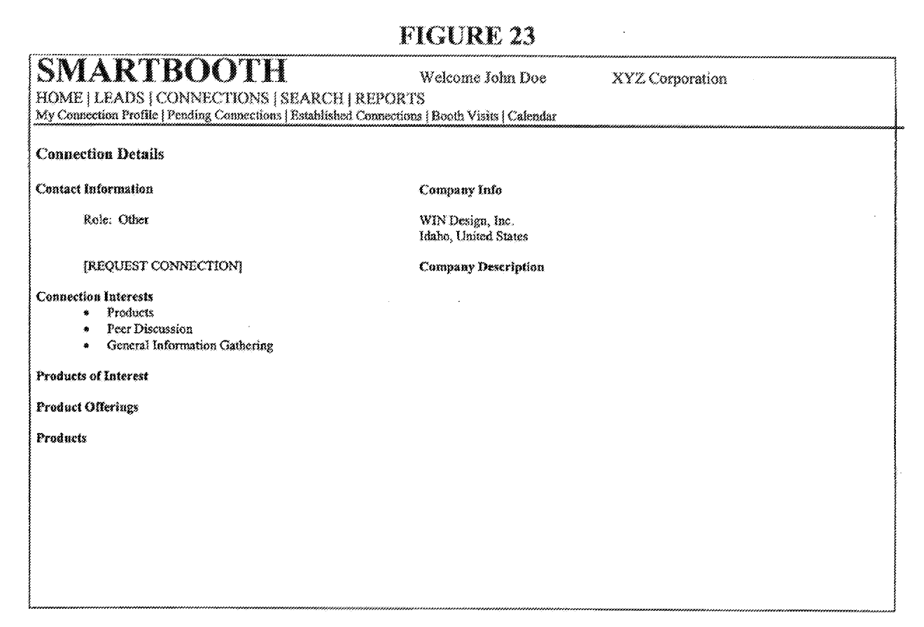

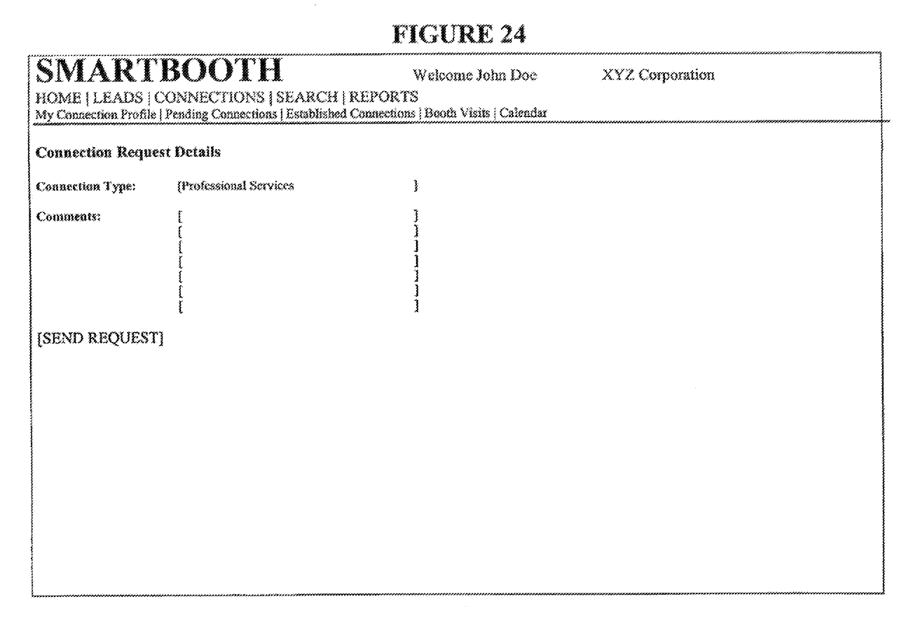

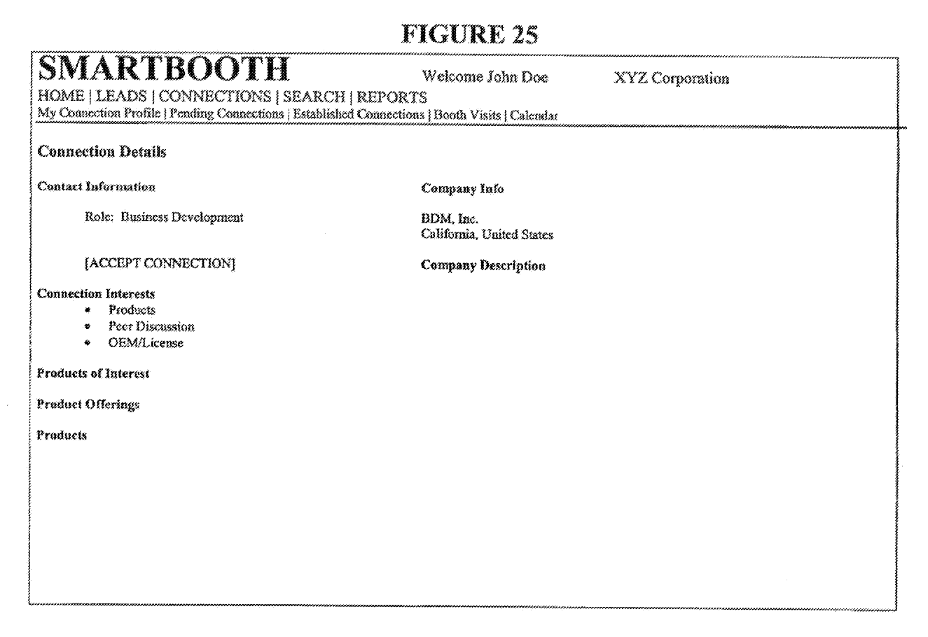

The data entered by the user on the Search function screen (FIG. 18) serves as a keyword for searching the various User Profiles of other users among the relevant population. In order to conduct a search for specific persons, as shown in FIGS. 20 and 21, respectively, the user is presented either a “Find Peers & Colleagues” screen (in the case of exhibitors) or a Find People screen (in the case of attendees) for conducting a search for specific persons having criteria in their User Profile matching the user's keyword search. As shown on the Find Peers & Colleagues screen of FIG. 20, the exhibitor is preferably prompted to enter one or more keywords in a data entry field, and to select additional criteria to refine their search, including the job title of the person they are seeking, specific product interests of the person they are seeking, specific job functions of the person they are seeking, areas of expertise of the person they are seeking, and the geographic location of the person they are seeking. Likewise, as shown on the Find People screen of FIG. 21, the attendee is preferably prompted to enter one or more keywords in a data entry field, and to select additional criteria to refine their search, including the job title of the person they are seeking, specific areas of expertise of the person they are seeking, specific market space with which the person they are seeking has associated their products or services, the desired connection type of the person they are seeking, and the geographic location of the person they are seeking. Each category selected, along with the keywords input by the user in each, search screen, build a search query which is used to search the User Profiles of the relevant population and return results matching the criteria selected by the user on their respective search screen. For the people search, when one or more contacts are returned as a result of the search, they are preferably presented to the user in the form of a People Search Results screen as shown in FIG. 22. Each returned entry preferably provides an active link which, when activated by the user, presents a Connection Details screen as shown in FIG. 23 which displays relevant, incomplete connection information for the particular contact, along with a Request Connection function. When activated by the user, the Request Connection function presents the user with a Connection Request Details screen as shown in FIG. 24, prompting the user to input a desired Connection Type and any comments they wish to present the prospective contact when such contact is notified of the user's connection request. When the user completes such information, they may activate a Send Request function that in turn adds the contact entry to that user's Connections waiting for authorization, and likewise adds the first user's incomplete contact information to the prospective contact's Invitations to Connect, with an active link to the details for such user. Such prospective contact may activate such link to display the Connection Details for the user, as shown in FIG. 25, along with an Accept Connection junction. When activated by the prospective contact, the Accept Connection function adds the user to the prospective contact's Established Connections screen with complete contact information for such user, and likewise adds the prospective contact to the user's Established Connections screen with complete contact information for such prospective contact.

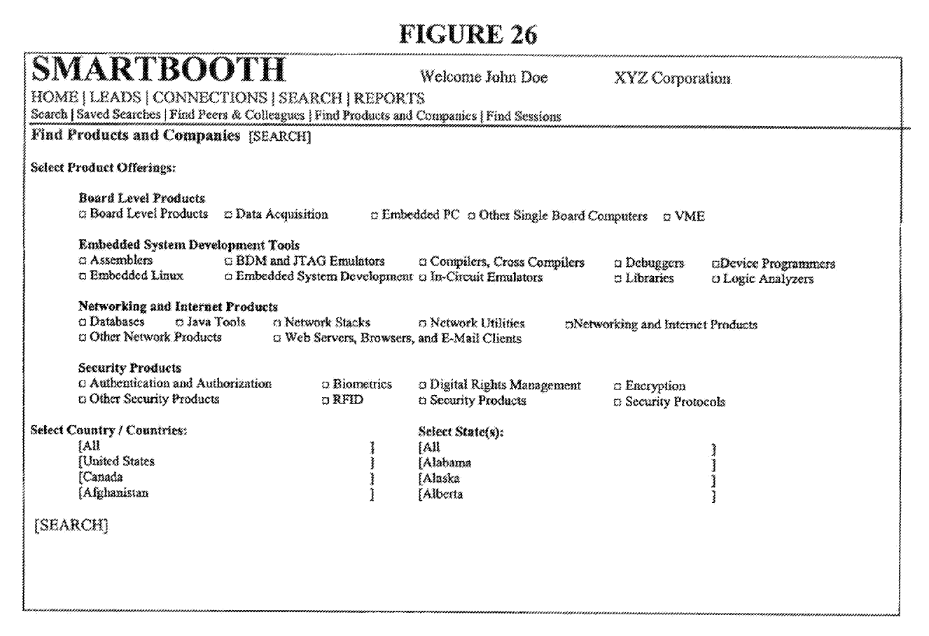

In order to conduct a search for specific products or companies, as shown in FIG. 26, the user is presented a Find Products and Companies screen enabling the user to select specific Product Offerings offered by other members of the relevant population, and optionally the geographic region in which such products are offered. As with a person search screen, upon the system identifying a match between the user's search and the Product Offerings data in another user's User Profile, such other user's incomplete contact information may be added to the user's Pending Connections screen so that a contact with such other user may be pursued.

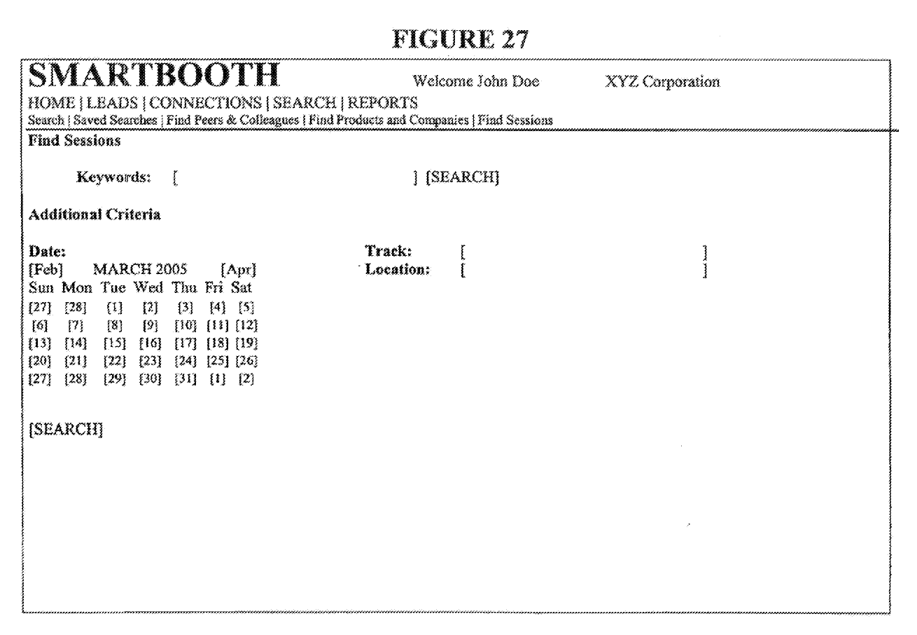

Lastly, in order to conduct a search for specific sessions (e.g., educational programs, promotional presentations, round-table discussions, etc.) offered in a trade show or other environment, a user may access a Find Sessions search screen as shown in FIG. 27. The Find Sessions search screen preferably prompts a user to input one or more keywords to search the names of available sessions, and likewise preferably allows the user to select additional search criteria including Track and Location. Track criteria preferably allows the user to select a specific track for a desired session in tradeshow environments in which multiple talent or expertise tracks are provided. Likewise, Location criteria preferably allows the user to select a specific geographic area in which such session would be offered. Based on the user's keywords and selected search criteria, in response to the user initiating a Search function, the user is presented a Sessions results screen (not shown) which preferably provides a listing of all sessions matching such keywords and selected search criteria, and optionally allowing the user to view details concerning each such, revealed session.

Lead Conversion Process

The above described process of identifying and tracking leads is useful to allow users of the system to establish contact with prospective business partners. However, the method and system also provides opportunity for users to establish early connection with prospective leads, and to track interaction with such prospective leads over a period of time. Such tracking process over time provides a user, and particularly a user in the position of an exhibitor, to track success in converting leads generated into actual business partners.

More particularly, the entire relevant population (e.g., the entire attendance of a tradeshow) represents a target lead population. From that target lead population, a subset are identified, as qualified leads, i.e., those members of the relevant population that exhibit qualification behaviors as the user has defined in their Leads Profile. As discussed at length above, such behaviors may include keyword searching by other users using terms associated with the exhibitor's own User Profile (such as the exhibitor's product offerings), searching on product categories that match the exhibitor's product offerings, viewing the exhibitor's products or company profile, and a user having the other above-described product-of-interest categories in their User Profiles that, correspond to the exhibitor's profile. From such collection of qualified leads, an additional subset may be identified of users who have received the exhibitor's invitation to connect. Lastly, of those individuals, a final subset maybe identified of users with whom a connection has been accepted. Thus, those individual users in the final connect population represent users who have been processed through the lead conversion process of target lead to qualified lead to contacted lead to connection. Having identified the connections established, the contact data (and any other data of interest from such connection contacts' User Profiles) may be exported to, for example, a Customer Relationship Management (“CRM”) program for further analysis and follow up.

Once again, this process is preferably carried out over time so that each user's interaction with the program with which the method and system herein are to be used, such as a tradeshow, may likewise be extended. Through such expanded interaction of users with such program environment, the administrators of the program may obtain greater value by driving additional interest in the program than would be possible by limiting the users' involvement to simply the multi-day window of the program/tradeshow itself. By expanding the opportunity for users to establish business connections over a greater period of time, the users extract greater value from the program experience, and thus are more apt to participate in the program in the first place, thus increasing sales of program registrations for the administrators.

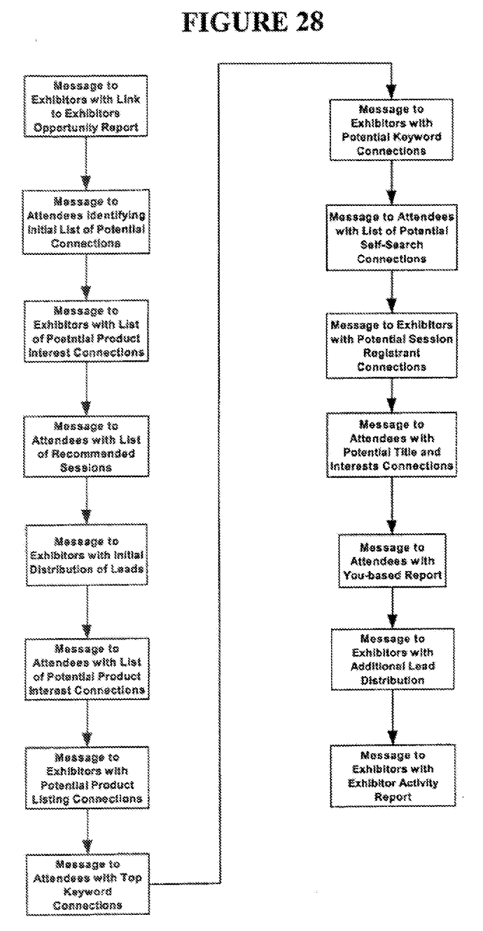

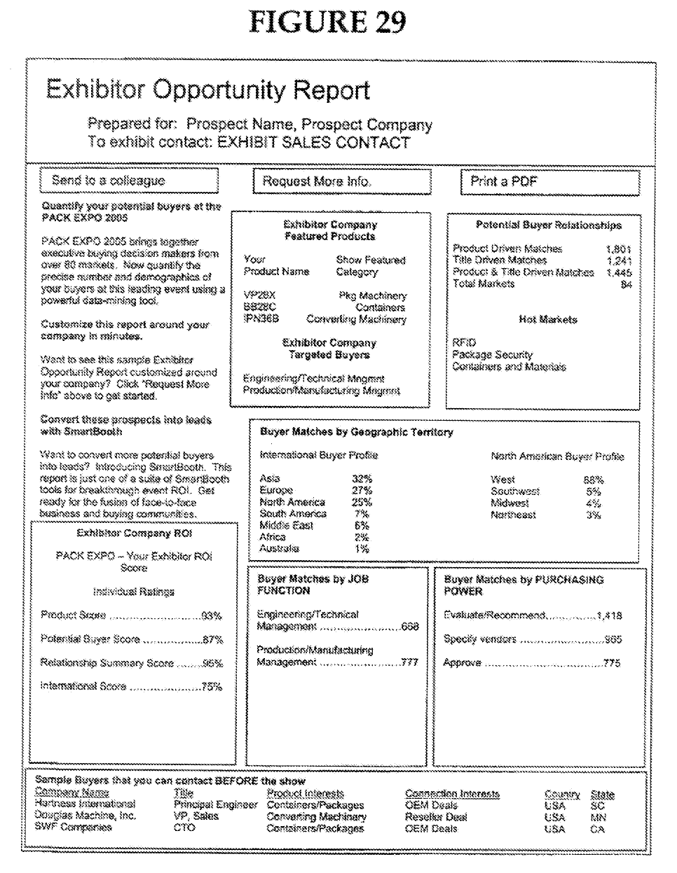

An example of how such lead conversion process may be spread over time will now be discussed. As shown in FIG. 28, the process may begin with distribution of a message, such as an electronic mail message, to exhibitors inviting them to engage the system to view members of the relevant population (e.g., attendees) that will be interested in that exhibitor's products, and providing a link to an Exhibitor Opportunity Report that summarizes information indicating the prospective business partners in the relevant population. An exemplary Exhibitor Opportunity Report is shown in FIG. 29, and may include such data elements as summaries of the exhibitor's own products and targeted buyers: an indication of the number of prospective buyers that are present in the relevant population corresponding to the exhibitor's various product, purchaser, and market criteria in the exhibitor's User Profile; the return on investment (“ROI”) the exhibitor may expect based upon the products they plan to exhibit at the program (including a metric indicating a degree of relevance of the exhibitor's products or services to the attendee population based upon the data in the attendee population's User Profiles); geographic locations of purchasers for the exhibitor's products or services (based on the data in the attendee population's User Profiles); the number of prospective purchasers for the exhibitor's products in particular job functions; the number of prospective purchasers for the exhibitor's products with particular purchasing authority; and a sample list of actual contacts that the exhibitor may pursue based upon the lead distribution process described above. Other categories of data and metrics may likewise be provided from the data in each of the exhibitor's and attendee's User Profiles in order to display to the exhibitor, at an early stage, the benefit that may be gained through their participation in the event.

At a point after issuance of the Exhibitor Opportunity Report, the system preferably forwards a message to attendees indicating a number of contacts of potential value for the specific attendee. Such list is preferably compiled by automatically engaging the above-described search functions to locate other system users whose User Profile data, and preferably whose job functions and areas of expertise data elements, match the user's own such data. Such list also enables the attendee receiving the message to engage the connections function described above with each user on such list, the contacts being initially treated as pending connections.

Next, the system preferably forwards a message to exhibitors indicating a number of attendee contacts of potential value for the specific exhibitor. Such list is preferably compiled by automatically engaging the above-described search functions to locate attendees who have listed in their Product Interests products of a type offered by the particular exhibitor.

Optionally, the system then forwards a message to attendees indicating a number of sessions of potential value for the specific attendee. Such list of sessions is preferably compiled by automatically engaging the session search function described above on behalf of each attendee to identify sessions of potential interest to such attendee. The automatic search may be conducted by automatically pulling data from a number of data elements in the attendee's User Profile, such as the particular attendee's Products, Expertise, Product Interests, or Product Offerings.

The system then preferably forwards a message to exhibitors indicating a number of attendee contacts of potential value for the specific exhibitor. Such list is preferably compiled by distributing a select number of leads in that exhibitor's lead list to the specific exhibitor. Such list again enables the exhibitor receiving the message to engage the connections function described above with each attendee on such list, the contacts being initially treated as pending connections.

Thereafter, the system preferably forwards a message to attendees indicating a number of products available from other users that may be of interest to such attendee receiving the message. Such list is preferably compiled by automatically engaging the above-described search functions to locate Product Offerings of other users that match the specific attendees keyword search criteria. Such list also preferably enables the attendee receiving the message to engage the connections function described above with each user on such list, the contacts being initially treated as pending connections.

Next, the system preferably forwards a message to exhibitors indicating a number of attendees who have searched on such exhibitor's Product Listings.

Next, the system preferably forwards a message to attendees informing such attendees of a number of top keywords used by other users having similar User Profiles (e.g., similar or related job functions, market spaces, product interests, etc.) in conducting searches.

Next, the system preferably forwards a message to exhibitors indicating a number of attendees that have searched on keywords that relate to such exhibitor's products.

The system then preferably sends a message to attendees providing a list of other users that have searched on such attendee, and optionally enables the attendee receiving the message to engage the connections function described above with each user on such list, the contacts being initially treated as pending connections.

Next, the system preferably sends a message to exhibitors indicating a number of attendees that have registered for sessions relating to such exhibitor's products.

Thereafter, the system preferably forwards a message to attendees indicating a number of other users that are most similar in User Profiles to the particular attendee, and optionally enables the attendee receiving the message to engage the connections function described above with each user on such list, the contacts being initially treated as pending connections.

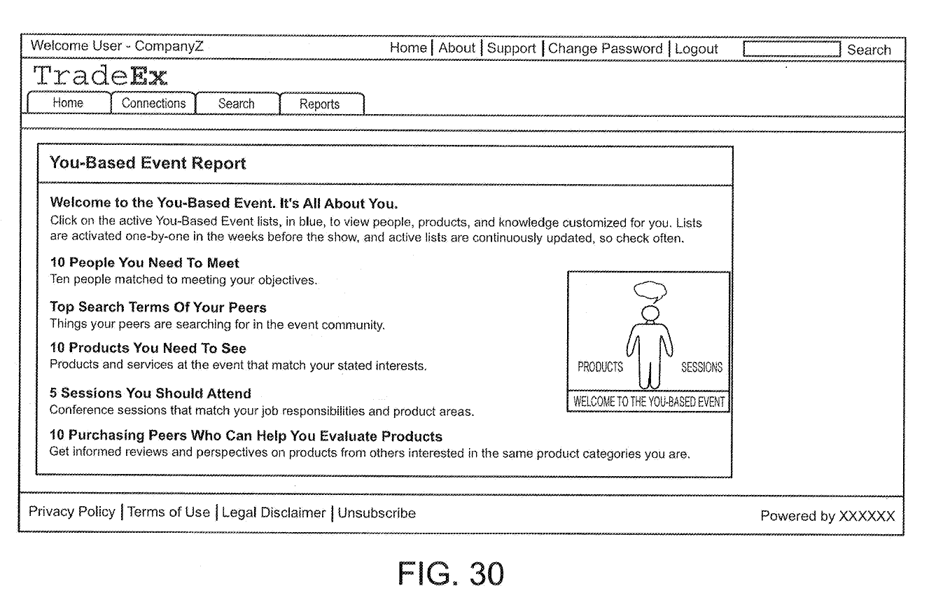

Next, the system preferably forwards a message to attendees indicating that a customized report has been prepared for each such attendee, and provides an active link which, when activated by the attendee, displays the attendee's customized “You-Based Event Report.” as shown in FIG. 30. Each attendee's Event Report preferably provides a customized interface allowing each attendee a customized program experience to maximize their own return on investment and realization of opportunities in establishing connections with potential partners. As shown in FIG. 30, the Event Report preferably particularly provides the user a number of active links to display people, product, and information that has been customized for the particular attendee. Such lists preferably include: (i) a listing of contacts that share the attendee's job function and areas of expertise; (ii) a listing of keywords used in high frequency by persons having similar User Profiles to the particular attendee's; (iii) a listing of product and services available from other users that match the attendee's Product Interest data element in their User Profile; (iv) a listing of sessions available whose subject matter relates to the attendee's job responsibilities, products, and product offerings data elements in their User Profile; and (v) a listing of other users who have indicated Product Interests in their User Profiles that relate to the attendee's own Product Interests.

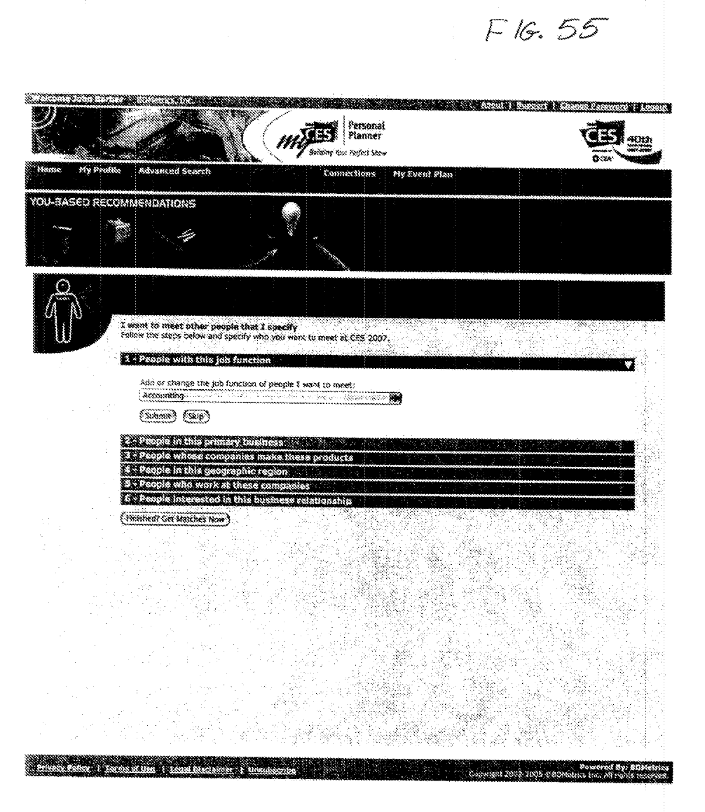

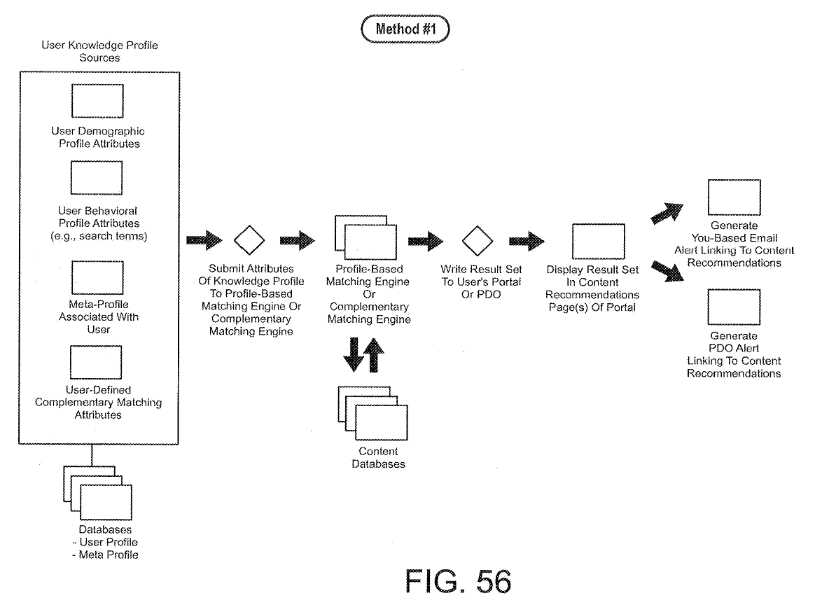

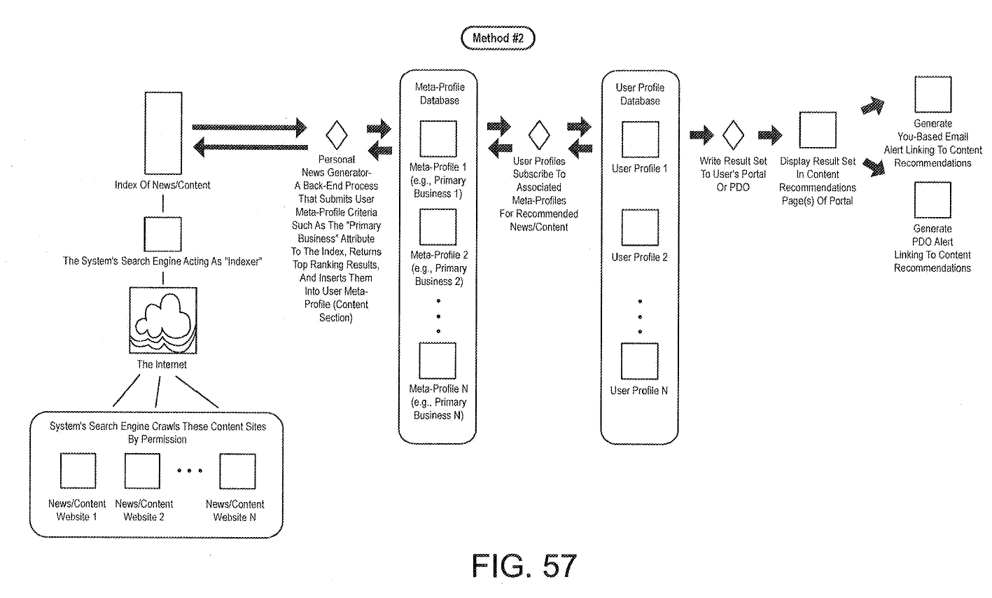

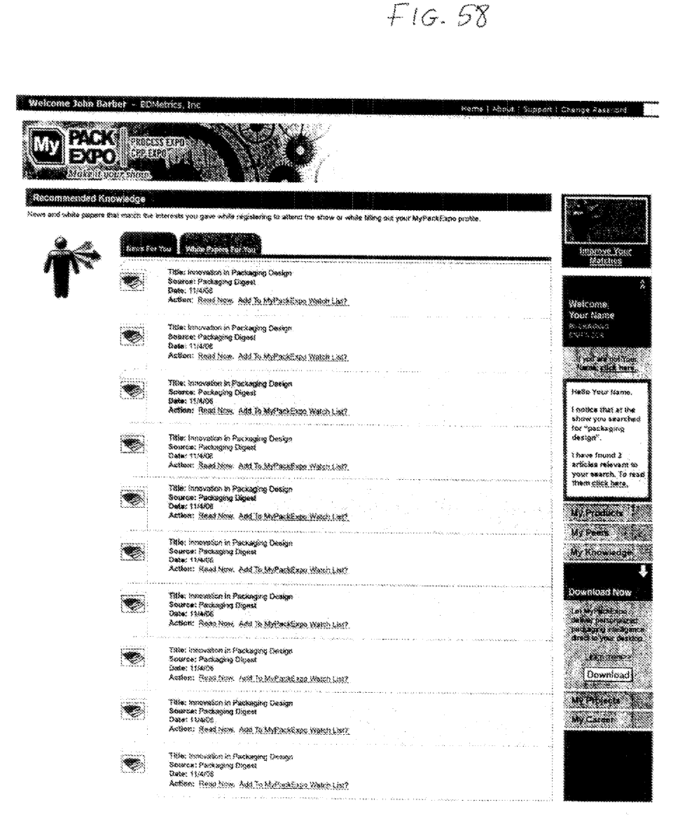

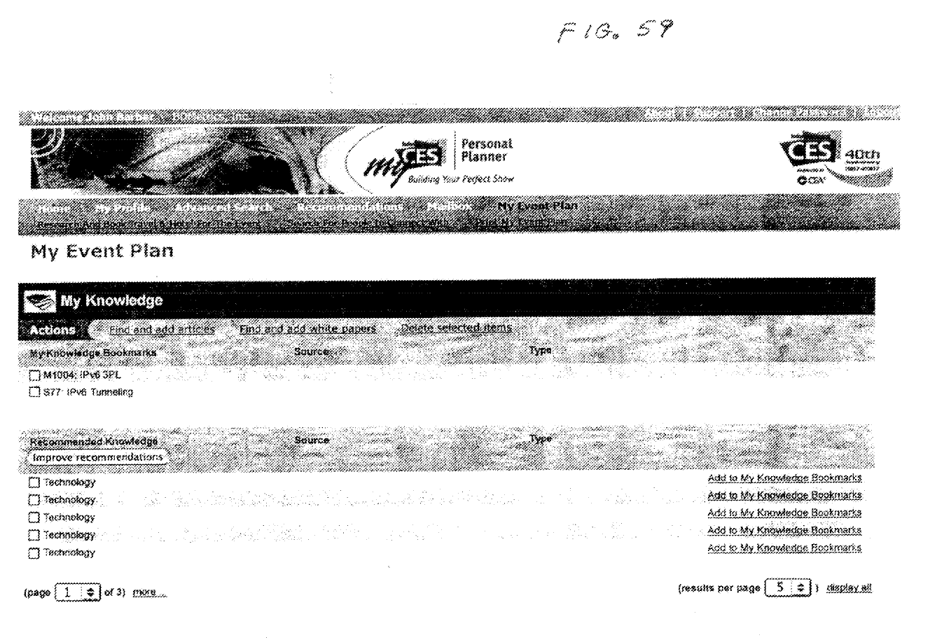

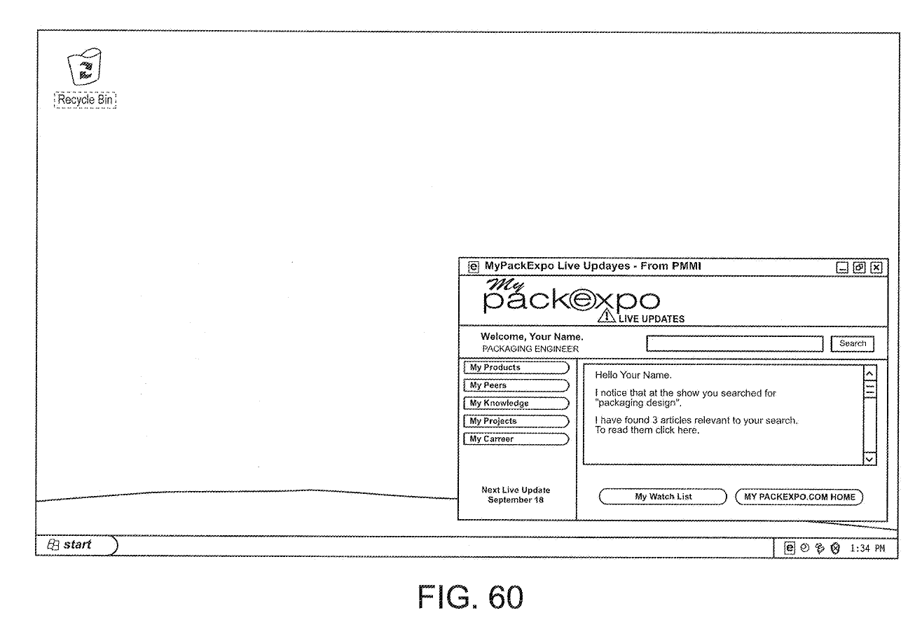

FIGS. 56-60 illustrate interfaces and a conceptual system diagram that enables registrants of an event to receive via their portal personalized content updates that increase their professional knowledge—e.g. news articles, white papers, press releases, conference session presentations, exhibitor literature, Podcasts, Flash movies, etc. Such knowledge alerts are also integral to developing and retaining audience on the automated business development system. To achieve this, the system provides “You-Based Content Hosting And Delivery”. This technology combines web search, meta-tagging, a content management system, matching engines, attendee demographic and behavioral profiles, the Meta-Profile, the event portal, the Event Plan Utility, You-Based Marketing, and the PDO to deliver personalized content to users. You-Based Content Hosting And Delivery relies upon the following components working together as illustrated in FIGS. 56 and 57: (A.) A knowledge profile on the user. This knowledge profile may be created by the system from a variety of sources appropriate to various types of content being served. Sources for the knowledge profile include: (i.) the user's demographic profile, (ii.) the Meta-Profile associated with the user, (iii.) complementary attributes on the topics and types of knowledge desired by the user, collected in a complementary matching wizard, (iv.) the behaviors of tire user including search behavior and bookmarking. (B.) Knowledge content databases. These databases are of two broad types: (i.) A database of content files or links meta-tagged and indexed by content type, primary business, keyword, and other indexes, and hosted in the system via a content management system, (ii.) A content section of the Meta-Profile database. This section of the Meta-Profile database is populated via indexing of targeted content websites by permission, such as news websites, by the system's integrated search engine. (C.) A web crawling and indexing system to populate the Meta-Profile database content section. This consists of an indexer (search engine), an index, and a personalized content generator which sorts content into Meta-Profile bins for distribution to users. The web crawling and indexing system can also populate the Meta-Profile database with content from the Internet. One classification of bin is a primary business bin. User profiles then subscribe to associated Meta-Profiles to populate themselves with personalized content. (D.) Matching Engines and their algorithms to sort the Knowledge content databases and retrieve personalized content according to a knowledge profile. A knowledge profile may be gathered in several ways including the complementary matching wizard. (E.) Personalized Recommendations pages in the event portal and recommendations sections of the Event Plan Utility. See FIGS. 58 and 59. These are some of the primary in-portal user interface elements for presenting You-Based Content Hosting And Delivery. (F.) You-Based Marketing. This is the system's “push” e-mail marketing system used to proactively issue recommendation alerts to users via email. Each e-mail contains a link to the relevant recommendations page within the user's portal. (G.) The PDO as illustrated in, for example, FIG. 60. For users who download the PDO, a database-driven PDO alert containing personalized knowledge content may be sent directly to the desktop of the user's personal computer. Time-Slicing of a registration database can be used to achieve optimal You-Based alerting to a user/registrant. At some conferences and events, registration may ramp steadily over the course of a period of time. Thus, starting 8-12 weeks in advance of an event date, for example, You-Based Marketing can “time-slice” the database in order to: (1.) ensure that the same You-Based e-mail alert is prevented from being sent to the same individual more than once; and (2.) ensure that all registrants receive the optimal sequence of You-Based alerts regardless of the number of weeks before the show they register. Time slicing can enable the database to be broken into distinct groups based on registration date. As one example, “Group 1” can be all those who registered before June 4; “Group 2” can be ail those who registered from June 4-June 10: “Group 3” can be ail those who registered from June 11-June 17; and so on. This enables a You-Based E-mail schedule to be constructed for a given event. The following example illustrates:

TABLE 1

| | | | |
|---|---|---|---|
| Tues 5/3 | | | |
| 10 People You Need To Meet | Group 1 | all that registered before 4/26 | |
| Tues 5/10 | | | |
| 10 People You Need To Meet | Group 2 | all that registered from 4/26 to 5/3 | |
| 10 Exhibitors You Need To See | Group 1 | | got 10 People on 4/26 |
| Tues 5/17 | | | |
| 10 People You Need To Meet | Group 3 | all that registered from 5/3 to 5/10 | |
| 10 Exhibitors You Need To See | Group 2 | | got 10 People on 5/3 |
| 5 Sessions You Should Attend | Group 1 | | got 10 Exhibitors on 5/3 |
| Tuesday 5/24 | | | |
| 10 People You Need To Meet | Group 4 | all that registered from 5/10 to 5/17 | |
| 10 Exhibitors You Need To See | Group 3 | | got 10 People on 5/10 |
| 5 Sessions You Should Attend | Group 2 | | got 10 Exhibitors on 5/10 |
| Top Search Terms Of Your Peers | Group 1 | | got 5 Sessions on 5/10 |
| Tuesday 5/31 | | | |
| 10 People You Need To Meet | Group 5 | all that registered from 5/17 to 5/24 | |
| 10 Exhibitors You Need To See | Group 4 | | got 10 People on 5/17 |
| 5 Sessions You Should Attend | Group 3 | | got 10 Exhibitors on 5/17 |
| Top Search Terms Of Your Peers | Group 2 | | got 5 Sessions on 5/17 |
| 10 Purchasing Peers To Help You | Group 1 | | got Top Search Terms |
| Evaluate Products | | | on 5/17 |
| Thursday 6/2 | | | |
| 10 People You Need To Meet | Group 6 | all that registered from 5/24 to 5/31 | |
| Show Plan Is Ready | All but Group 6 | | |
| Monday 6/6 | | | |
| Your Show Plan Is Ready | Group 6 | | |
| 1 Day Left | All but Group 6 | | |

### Example: SUPERCOMM 2005 You-Based Email Sequence

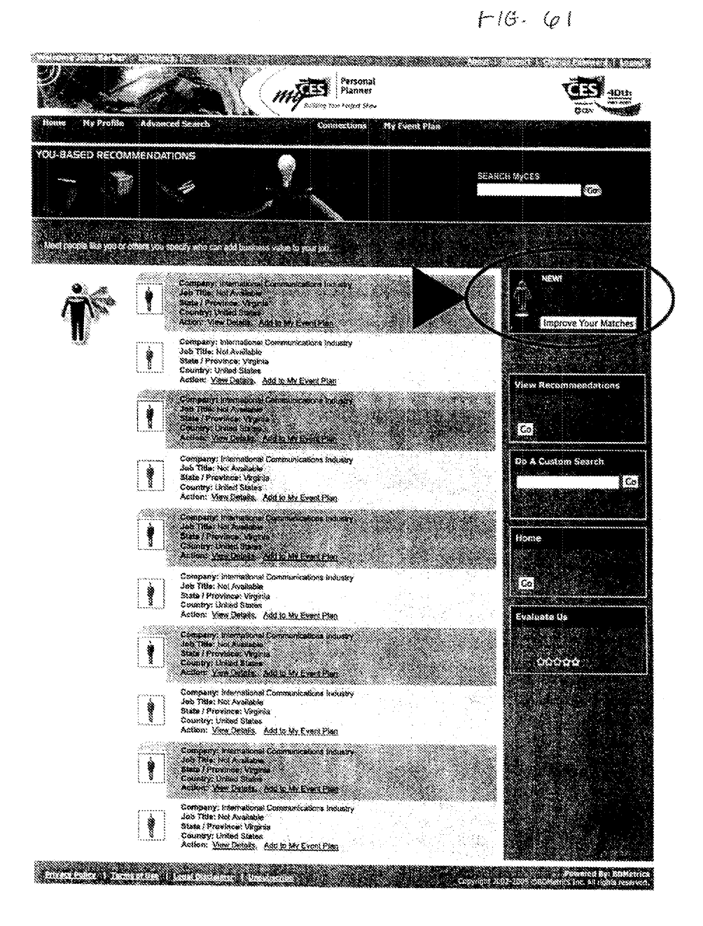

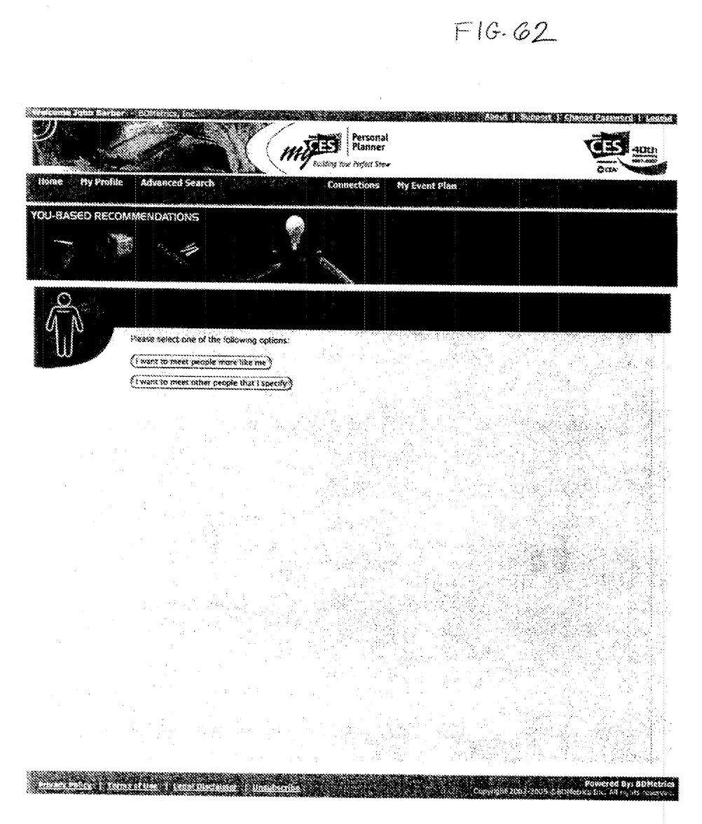

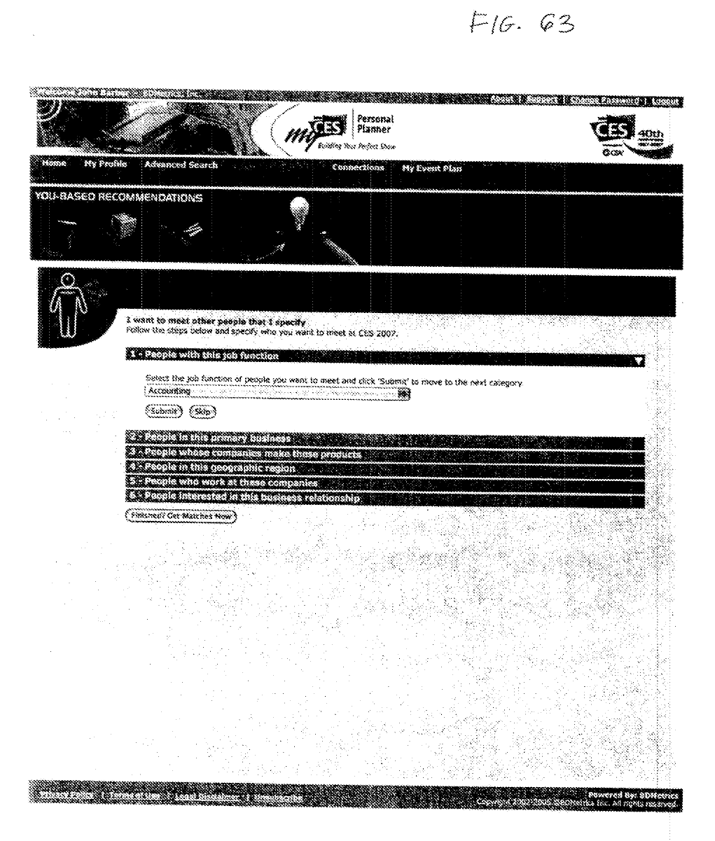

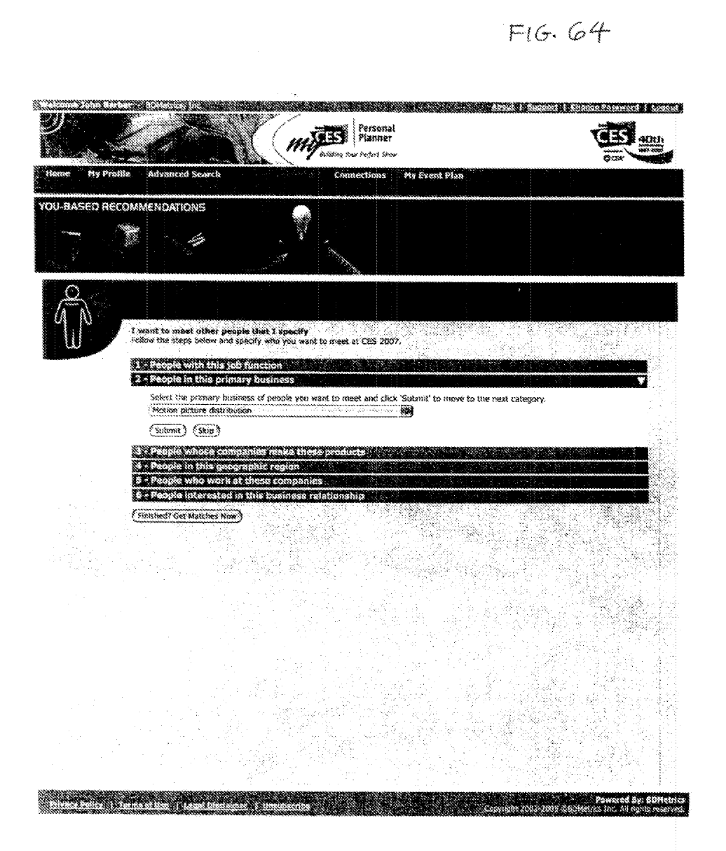

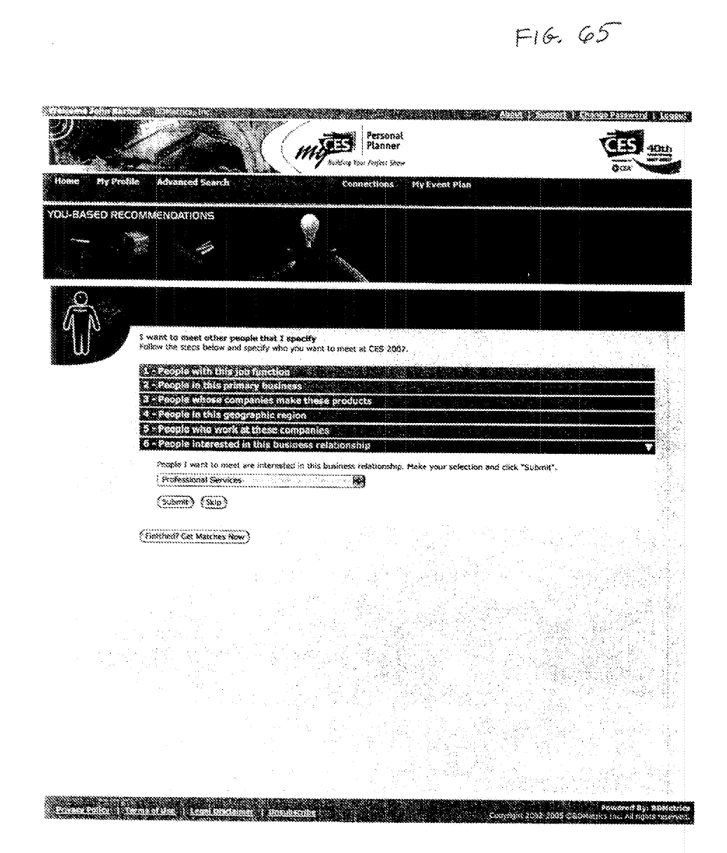

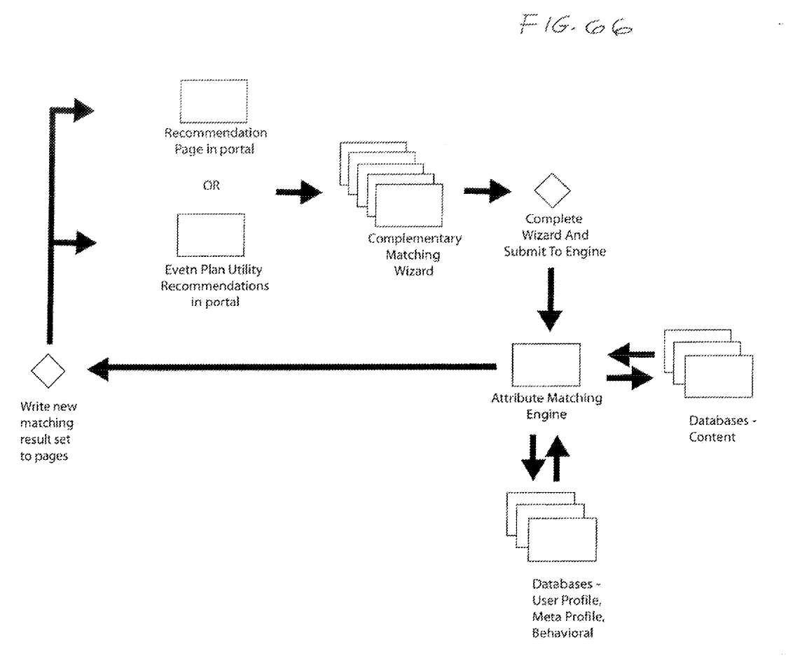

FIGS. 61-66 illustrate interfaces and a conceptual system diagram that enables registrants of an event to have the ability to greatly improve the relevance of the recommendations generated for them in their portal by providing structured inputs on the attributes of the thing they are looking for and submitting these inputs to an attribute matching engine. The system provides Complementary Matching Technology for this purpose. Unlike the portal's user-profile-driven matching technology which uses the individual's own user-profile attributes gathered from event registration, from the attendee portal profile, or from a Meta-Profile associated with the user's role, to recommend items based upon their relevance to the user's profile, Complementary Matching Technology instead recommends items based upon their nearness of fit to the attributes of the thing sought—i.e., that which is complementary to the user. Complementary Matching Technology is exposed in the portal as a task path for refining and improving the profile-based recommendations which the portal generates for users “out-of-the-box”. Complementary Matching Technology is launched via an “Improve Your Matches” button integrated into the portal's recommendations pages and the recommendations sections of its Event Plan. This task path is illustrated in FIGS. 61-66. Complementary Matching Technology submits attributes to the portal's attribute matching engine as illustrated in FIG. 66. It can then display the resulting refined matches to the user on a newly refreshed screen like that shown in FIG. 61, only with more refined results. Complementary Matching Technology can gather and submit to the Attribute Matching Engine distinct sets of complementary attributes depending on the type of recommendations page to which it is linked. For example, when linked to the people recommendations page, the Wizard can gather the Job Function, Primary Business, Expertise, Company Name, Business Relationship Interests, Geographic Region, and Type Of Products Made By The Companies Of the people being sought. The user may input information into any or ail of these fields. On the other hand, when linked to another recommendation page, such as a company recommendations page, the Wizard can gather different attributes which may include the Product Category, New Product Announcements, Awards, Company Size, International Distribution, and other attributes of the company being sought. When linked to the product recommendation page, the wizard can gather attributes that may include the primary business, product category, date range of product launch, and/or company associated with manufacturing a corresponding product. When linked to the solution recommendation page, the wizard may include a customized solution criteria specific to an organization deploying the solution attribute matching device, wherein the organization deploying the solution attribute matching device can include a packaging organization, a market segment within an organization, a product category within an organization, a machine line speed within an organization, a control platform used within an organization, a line integration experience within an organization, and/or an organization within a country where work will be done. When linked to the knowledge recommendation page, the wizard may gather attributes that may include the primary business area of the knowledge sought, product category of the knowledge sought, keywords associated with the knowledge sought, date range when the knowledge was published, knowledge sources to be searched, and/or sources of the knowledge.

The system may permit users of an event to specify a weight and/or degree of importance associated with each attribute based on an importance co-efficient that rates each attributes on a scale of value from lesser to greater. The system can then submit the user-specified weighting and/or degree of importance associated with each attribute to a matching processor in order to determine whether a match occurred, wherein the match may be based on the described preference.

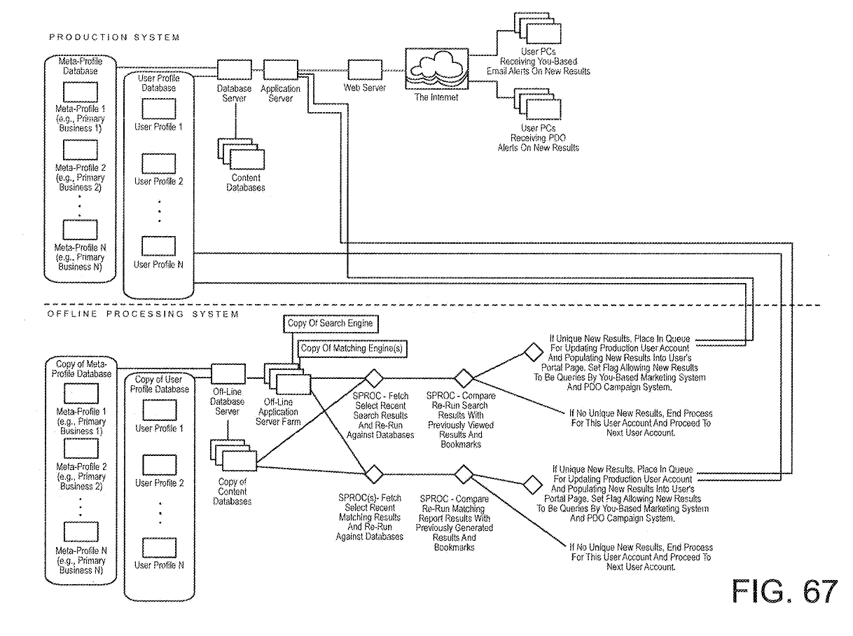

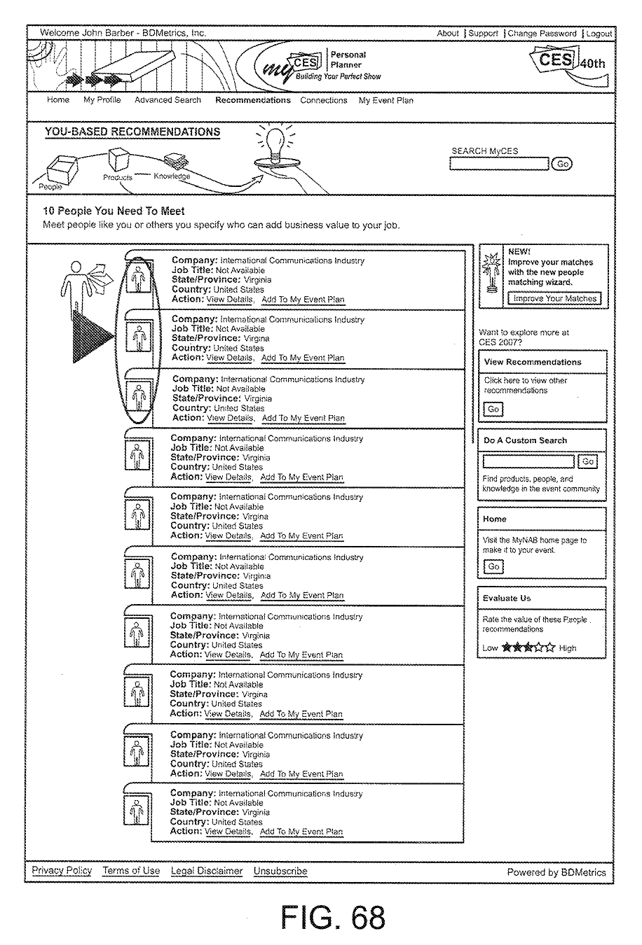

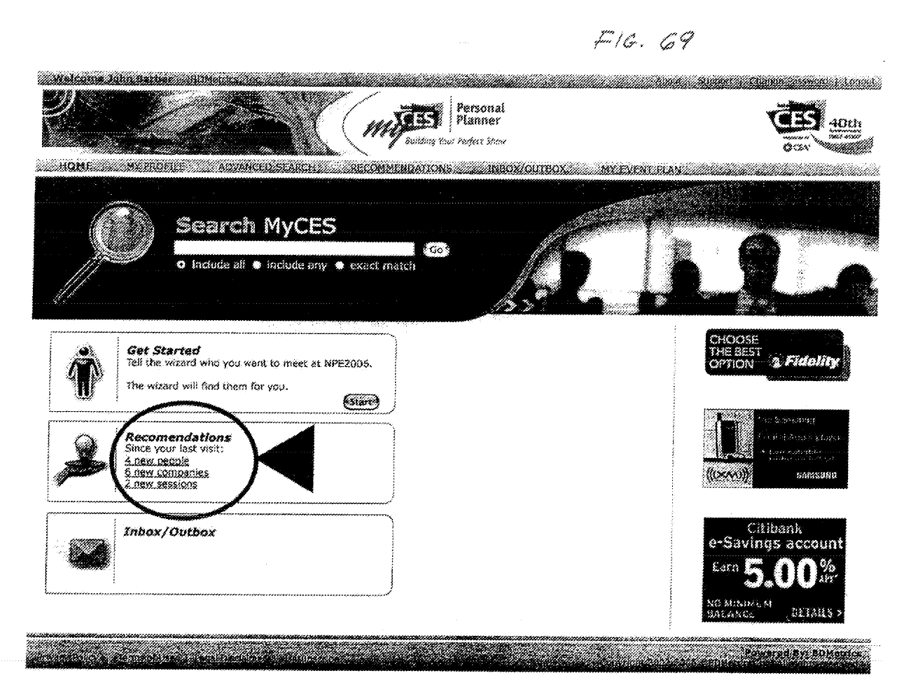

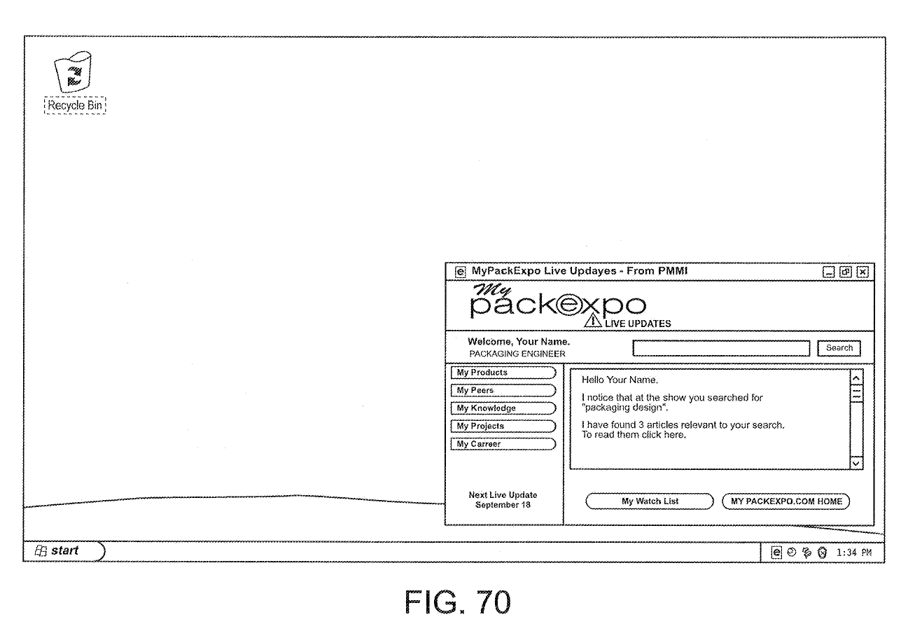

FIGS. 67-70 illustrate interfaces and a conceptual system diagram that enables registrants of an event to have their portal or PDO periodically update them with any unique new people, companies, products, knowledge, or other content items that match their previous searches or matching profiles. These updates enable the automated business development system to function as a personal assistant for each user, continuously re-running the user's previous searches and matching reports against the databases, determining whether any of the results are new (that is, not previously viewed by the user), and reporting to the user with new items it has found. To achieve this, the system provides New Search And Matching Updates. The feature delivers a “living search” and “living matching” capability to users, essentially causing the user's search or matching report to “live on” over time and bring the continuing value of additional items to the user's attention. As illustrated in FIG. 67, New Search And Matching Updates technology is a combination of the event portal, the portal's search engine, the matching engines (both profile-based matching engine and complimentary attribute matching engine), the portal's databases, an offline-processing system for re-running searches and matching reports in batch mode during off-peak hours and comparing the results with a record of previously viewed results in each user's account, the PDO, and/or a marketing system. FIGS. 68 and 69 illustrates exemplary interlaces of an offline processing system that includes database queries to deliver any new results with a “New” designation to the corresponding pages of each user's portal, and to enable outbound alerts to each user via either an email marketing system or via each user's PDO as illustrated in FIG. 70. The offline processing system functions in the following way. In FIG. 67, an offline processing server farm and database are dedicated to the New Search And Matching Updates process. By offline it is meant that these servers are not used as resources by the production system responding to the requests of online users. The offline databases are a copy—a daily snapshot—of the production databases and not accessed by online users of the system. Each day a batch operation is scheduled in which select previous searches of each user are re-run on a copy of the portal's search engine running on an off-line server farm searching against off-line copies of the user database and the content databases. A stored procedure (SPROC) is run which fetches the first 25 results previously viewed by the user for this search. Another SPROC compares the first 25 results of the new offline search to the first 25 results of the previously viewed search results and determines whether there are new items previously unviewed by the user. The SPROC then compares these new items against a copy of the user's bookmarks in the system to make sure that the user did not bookmark any of the items previously. As used herein, a bookmark refers to a method of storing items in memory such that it is then easier for the user to access these items in the future. Any items previously bookmarked are eliminated by the SPROC. The SPROC then places any items that pass through these comparison filters into a queue for insertion as “New” items to be displayed at the top of a page in the user's portal to be used for displaying new items. Finally the SPROC places flags into the database that may be queried by the You-Based email marketing system or the PDO campaign system so that users may be proactively alerted to their new results. For New Matching Results, a nearly identical offline process is scheduled in which select matching reports active in the user's portal account are re-run against copies of the user database and the content databases. The criteria for these matches may vary from batch run to batch run requiring different SPROCs. In the case where the user's own profile attributes are used as matching criteria, then the SPROC fetches these from the database. In the case where attributes from the Meta-Profile associated with the user's account are used, then the SPROC fetches these from the database. In the case where complementary attributes from a complementary matching wizard are used as attributes, then the SPROC fetches these from the database. The attributes selected for the New Matching Results operation are then re-submitted to the appropriate matching engine running on the off-line server farm. A SPROC then fetches the matching results for this match previous generated for the user, compares it with the new matching results generated by the offline matching process, and determines whether there are any unique new items. The SPROC then compares these new items against a copy of the user's bookmarks in the system to make sure that the user did not bookmark any of the items previously. Any items previously bookmarked are eliminated by the SPROC. The SPROC then places any items that pass through these comparison filters into a queue for insertion as “New” items to be displayed at the top of a page in the user's portal to be used for displaying new items. Finally the SPROC places flags into the database that may be queried by the You-Based email marketing system or the PDO campaign system so that users may be proactively alerted to their new results. In the separate case of matching updates based upon personalized news/knowledge content obtained via “Method 2” in the “You-Based Content Hosting And Delivery” feature of the system, a different offline operation is performed. In this case, a SPROC queries the content section of the Meta-Profile database for any news/knowledge content added since the last date when the user profiles “subscribed” to news/knowledge content from the Meta-Profile. These items are flagged for labeling with a “New” designation and promotion to the top of the results in the appropriate page of the user's portal, and a subscription to the Meta-Profile for new content by the user profiles is scheduled.

The next message sent by the system is preferably a message directed to exhibitors indicating a number of additional attendee contacts of potential value for the specific exhibitor. Such list is preferably compiled by distributing additional leads in that exhibitor's lead list to the specific exhibitor. Such list again enables the exhibitor receiving the message to engage the connections function described above with each attendee on such list, the contacts being initially treated as pending connections.

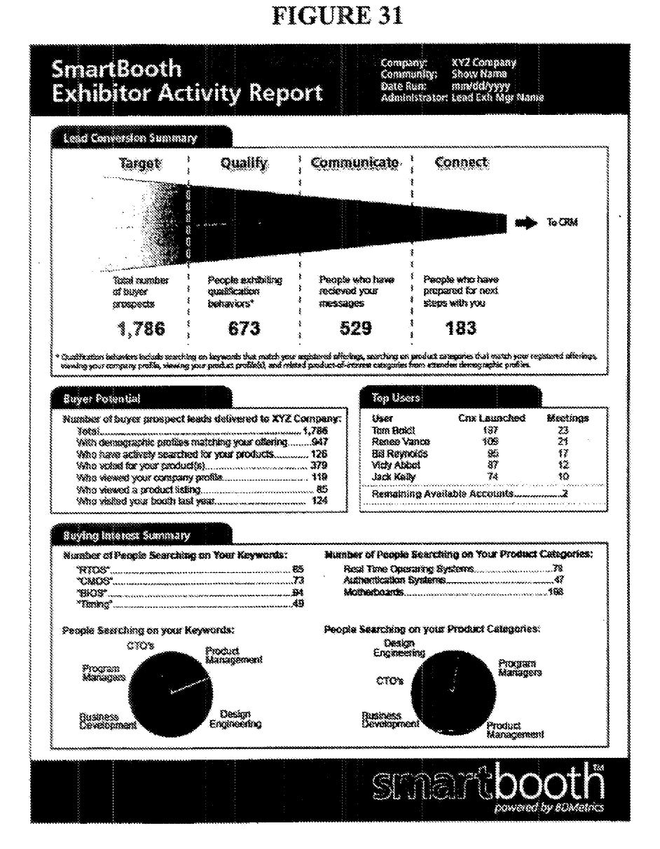

Next, the system preferably directs a message to exhibitors with a link which, when activated, presents the exhibitor with an Exhibitor Activity Report as shown in FIG. 31. The Exhibitor Activity Report preferably provides a summary of the lead conversion process for the specific exhibitor, providing (as detailed above) the numbers of target leads, qualified leads, leads with whom a connection has been sought, and leads with whom a connection has been established. Additional the Exhibitor Activity Report preferably provides the exhibitor a listing of the total numbers of prospective business partners having matching criteria in their User Profiles or who have practiced behaviors which have relation to the criteria in the exhibitor's own User Profile. For example, such categories of prospective business partners may include users having demographic profiles matching the exhibitor's product offerings, users who have searched for the exhibitor's products, users who have voted for the exhibitor's product(s) (e.g., in a “best of show” vote for best product), users who have viewed the exhibitor's company profile, users who have viewed a product listing of the exhibitor, and users who visited the exhibitor's booth in prior programs, e.g., prior tradeshows. Additionally, the Exhibitor Activity Report preferably provides a summary of interests of prospective business partners in the exhibitor's products or services. More particularly, the Exhibitor Activity Report preferably reflects numbers of other users who have conducted searches on keywords associated with the exhibitor's products or services in the exhibitor's User Profile, the job functions of such persons, the number of other users who have conducted searches on product categories associated with the exhibitor's products or services in the exhibitor's User Profile, and the job functions of such persons.

Lastly, following the program, a message is preferably directed to both attendees and exhibitors as a follow up. For attendees, such message preferably provides a listing of exhibitors on whose lead list such attendee is listed, but with whom such attendee did not establish contact or a connection through the program. For exhibitors, such message preferably provides an indication of the number of additional leads on the exhibitor's lead list with whom the exhibitor did not establish contact or a connection through the program. Such message preferably provides the exhibitor opportunity to further engage the system to identify at least a portion of those leads and engage the above-described connection function to further pursue a potential connection with such users.

Again, the above series of messages are preferably temporally dispersed. For instance, the first message might be forwarded to the exhibitor 60 days before the program which will draw together the relevant population, and the messages that follow may be separated by, for example, 1-5 days between each such message, in order to provide continual interaction with exhibitors and attendees far beyond the program experience itself. Also, it should be noted that the particularly ordering of the messages noted above is not critical and may be modified without departing from the spirit and scope of the invention. Likewise, while the steps above for transmitting messages to both attendees and exhibitors are presented as being interspersed for convenience, it is noted that each should be viewed separately as a series of temporally disparate messages directed to exhibitors and temporally disparate messages directed to attendees.

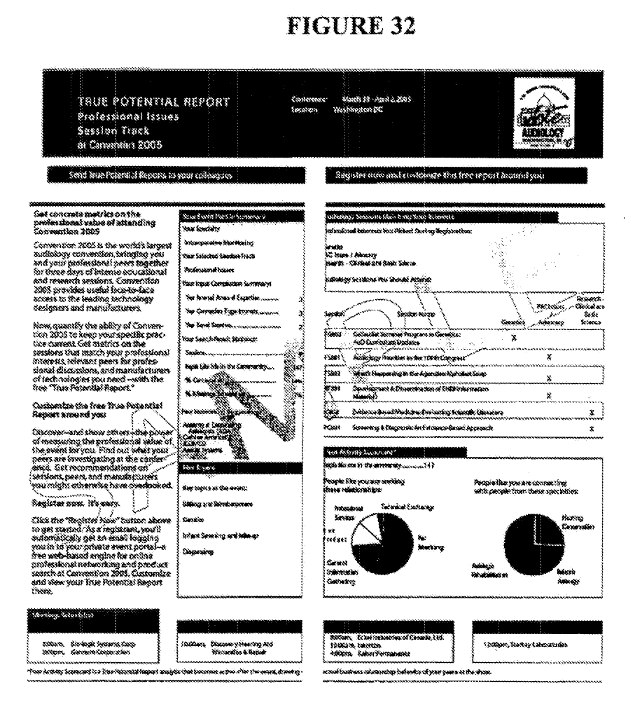

In addition to the reports referenced above, the system also preferably provides, at some point in advance of the program that will bring together the relevant population, Justification Reports (an example of which is shown in FIG. 32) directed to attendees and exhibitors that provide metrics highlighting the value of exhibiting and/or attending the program. Such reports are preferably focused on revealing the specific opportunity available at the program for individual attendee's and exhibitor's goals, in order to provide specific, objective justification for program participation. The metrics provided on such report are preferably customized for the job function of the intended recipient (e.g., Executive Management, Product Management, Business Development, etc.), providing information such as numbers, types, and characteristics of potential contacts, select markets in which opportunities are available for the specific user, sessions which relate to the user's User Profile and thus that may be of interest to the user, and other date that provides a measure of the opportunities represented by participation by that user in the program. Preferably, such Justification Report is forwarded by the system to each user registered with the system, along with an active link prompting the user to forward the report to a colleague. When activated by the user, the user is presented an email contact screen on which they are prompted to input at least an email address and job function of the colleague to whom they wish to send a Justification Report, along with a Send Report function which, when activated by the user, causes a message to be sent to the system containing the sending user's email address and User ID, and at least the recipient's email address and job function. The system then generates and transmits a new report customized for the recipient's role to the recipient. Likewise, the roles of both the sender and recipient are recorded in a data record to establish that a personality link exists between such roles. This new relationship is then manually added to the relationships database with a score determined by a human analyst to estimate the overall strength of the relationship. Once added, the newly discovered relationship is used in the above-described calculations to determine overall score of a lead.

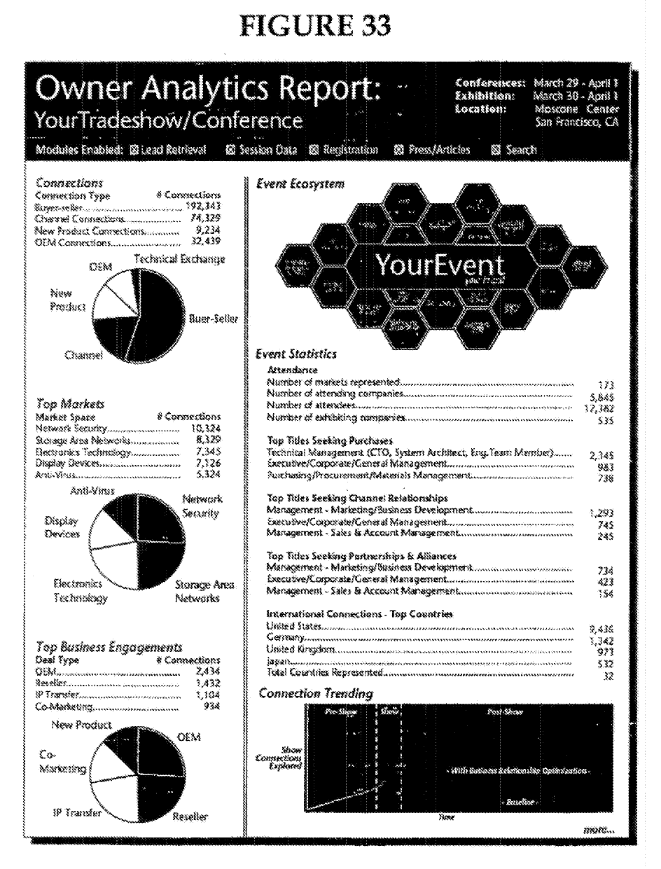

Additionally, as shown in FIG. 33, an Owner Analytics Report may likewise be generated for the program administrator providing metrics of the interactions that occurred between and among registered exhibitors and attendees. More particularly, such report preferably provides description of the connections that took place among exhibitors and registrants, the top markets in which connections took place, the types of transactions most frequently sought in the connections which took place, the market spaces represented by the registered exhibitors and attendees, and a number of additional statistics allowing the program administrator to gauge the types of persons who registered for the program, and thus the types of persons that should be targeted for registration for future programs.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of tire embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. A method for determining common interests, relevant content and/or business opportunities within a communication network, comprising:
determining demographics, interests, and/or behaviors of a plurality of users in a community;
filtering content associated with the community based on the determining for a first user of the plurality of users;
delivering the filtered content to the first user; and
identifying to other users in the community the demographics, interests and/or behaviors of the first user.

2. The method of claim 1, further comprising:
placing a framed web page within an event website;
configuring the framed web page to be hosted on a server relating to a user portal application;
initiating a creation of a user portal account when the framed web page is accessed;
determining whether an existing portal account associated with the first user within the user portal application is detected; and
accepting personal information to associate the first user with a created portal account after a determination of an absence of an existing portal account associated with the first user; and
creating a user portal associated with the user portal account, wherein the delivering occurs through the created user portal.

3. The method of claim 2, further comprising:
offering the first user, from the user portal, an opportunity to register for the event.

4. The method of claim 2, further comprising:
providing personalized content on the user portal based on the user portal account.

5. The method of claim 2, further comprising:
blocking use of predetermined functionality from the user portal for users who have not registered for the event;
notifying users that such predetermined functionality activates after such users register for the event; and
tracking from the portal application when a user having a user portal account accesses an event registration interface or registers for the event.

6. The method of claim 5, further comprising:
monitoring activity within the user portal, the monitoring within the user portal configured to be executed autonomously from trackings associated with portals of users whose access to functionality has not been blocked.

7. The method of claim 3, further comprising:
tracking accesses to the event website from the user portal; and
determining whether the first user registers for the event after accessing the event website.

8. The method of claim 2, further comprising:
permitting user portal accounts to be issued as leads based on preferences set by an exhibitor.

9. The method of claim 4, wherein the personalized content serves as a basis to register with the event website and/or attend the event.

10. The method of claim 3, wherein an event plan utility, an online networking system, and/or a personalized walking map provided on the user portal serves as a basis to register with the event website.

11. The method of claim 2, wherein the personal information comprises at least one of name, company name, job function, and/or email address.

12. The method of claim 2, further comprising:
sending a message to the first user when an existing account is detected prior to channeling the first user to the existing account associated with the first user.

13. The method of claim 12, wherein the message comprises confirmation email containing login credentials associated with the first user.

14. The method of claim 2, further comprising:
placing an identity cookie on a computer used by the first user to access the user portal, the identity cookie being placed during the creation of the user personal account; and
reading the identity cookie when the first user visits the website to provide personal information to the first user during subsequent access to the event website.

15. A system for determining common interests, relevant content and/or business opportunities within a communication network, comprising:
at least one storage device to store content associated with a community; and
at least one processor to:
determine demographics, interests, and/or behaviors of a plurality of users in a community,
filter the content associated with the community based on the determination for a first user of the plurality of users,
deliver the filtered content to the first user, and
identify to other users in the community the demographics, interests and/or behaviors of the first user.

16. The system of claim 15, wherein:
the at least one processor to:
host a user portal application,
host a framed web page within an event website,
initiate creation of a user portal account by accessing the framed web page, and
determine whether an existing portal account associated with the first user within the user portal application is detected; and
the system further comprising a storage device to store personal information that associates the first user with a created portal account when it is determined that an existing portal account associated with the first user is absent,
wherein the at least one processor also creates a user portal associated with the user portal account, wherein the at least one processor delivers the filtered content through the user portal.

17. The system of claim 16, wherein the at least one processor to also offer the first user, from the user portal, an opportunity to register for the event.

18. The system of claim 16, wherein the at least one processor to also provide personalized content on the user portal based on the user portal account.

19. The system of claim 16, wherein the at least one processor to also:
block use of predetermined functionality from the user portal for users who have not registered for the event;
notify users that such predetermined functionality activates after such users register for the event; and
track from the portal application when a user having a user portal account accesses an event registration interface or registers for the event.

20. The system of claim 19, wherein the at least one processor to also:
monitor activity within the user portal, the monitoring within the user portal configured to be executed autonomously from trackings associated with portals of users whose access to functionality has not been blocked.

21. The system of claim 17, wherein the at least one processor to also:
track accesses to the event website from the user portal; and
determine whether the first user registers for the event after accessing the event website.

22. The system of claim 16, wherein the at least one processor to also permit user portal accounts to be issued as leads based on preferences set by an exhibitor.

23. The system of claim 18, wherein the personalized content serves as a basis to register with the event website and/or attend the event.

24. The system of claim 17, wherein an event plan utility, an online networking system, and/or a personalized walking map provided on the user portal serves as a basis to register with the event website.

25. The system of claim 16, wherein the personal information comprises at least one of name, company name, job function, and/or email address.

26. The system of claim 16, wherein the at least one processor to also send a message to the first user when an existing account is detected prior to channeling the first user to the existing account associated with the first user.

27. The system of claim 26, wherein the message comprises confirmation email containing login credentials associated with the first user.

28. The system of claim 16, wherein the at least one processor to also:
place an identity cookie on a computer used by the first user to access the user portal, the identity cookie being placed during the creation of the user personal account; and
read the identity cookie when the first user visits the website to provide personal information to the first user during subsequent access to the event website.

29. The method of claim 1, further comprising:
storing content information related to a community within a database;
holding a subscriber account on a website for the community in order to permit access to a portal application by a user;
monitoring the database for new content information;
detecting when the new content information matches the first user based on the demographics, interest and/or behaviors of the first user;
accessing the database to retrieve a matched information based on the detection; and
alerting the first user with the matched information.

30. The method of claim 29, further comprising:
designating a subset of the needs and interests associated with the first user as high general interest; and
alerting the first user when the designated subset is detected as new content.

31. The method of claim 29, further comprising:
soliciting inputs from the first user in order to improve relevant matching results.

32. The method of claim 29, further comprising:
permitting a portal search engine to return results, build a search profile on the first user, and/or gather search behaviors in order to facilitate business relationships.

33. The method of claim 29, wherein the portal application comprises a web-connected business tool configured to finding and gathering a plurality of entities based on a user profile, a matching profile, and/or a search behavior associated with the first user.

34. The method of claim 33, wherein the plurality of entities comprises at least one of companies, products, knowledge, people and content information.

35. The method of claim 29, wherein the portal application comprises a desktop executable file, and/or a web service capability.

36. The method of claim 35, wherein the desktop executable file includes a persistent desktop object.

37. The system of claim 15, wherein;
the at least one processor also to:
hold a subscriber account in order to permit access to a portal application by the first user,
monitor the database for new content information,
detect when the new content information matches the first user based on the demographics, interests and/or behaviors of the first user,
access the database to retrieve a matched information based on the detection, and
alert the first user with the matched information.

38. The system of claim 37, wherein the at least one processor to also:
designate a subset of the needs and interests associated with the first user as high general interest; and
alert the first user when the designated subset is detected as new content.

39. The system of claim 37, wherein the at least one processor to also:
solicit inputs from the first user in order to improve relevant matching results.

40. The system of claim 37, wherein the at least one processor to also permit a portal search engine to return results, build a search profile on the first user, and/or gather search behaviors in order to facilitate business relationships.

41. The system of claim 37, wherein the portal application comprises a web-connected business tool configured to finding and gathering a plurality of entities based on a user profile, a matching profile, and/or a search behavior associated with the first user.

42. The system of claim 41, wherein the plurality of entities comprises at least one of companies, products, knowledge, people and content information.

43. The system of claim 37, wherein the portal application comprises a desktop executable file, and/or a web service capability.

44. The system of claim 43, wherein the desktop executable file includes a persistent desktop object.

45. The method of claim 1, further comprising:
storing profile data for the first user associated with the determining;
determining whether the profile data associated with the first user is complete; and
supplanting any missing information associated with the first user using attributes extracted from a meta-profile for the role of the first user, wherein the filtering occurs based on the profile data as enhanced by the supplanting.

46. The method of claim 45, wherein the role of the first user comprises a primary business and/or primary job function of the first user.

47. The system of claim 15, wherein:
the at least one storage device stores profile data for the first user associated with the determining; and
the at least one processor to:
determine whether the profile data associated with the first user is complete,
supplant any missing information associated with the first user using attributes extracted from a meta-profile for the role of the first user, wherein the filtering occurs based on the profile data as enhanced by the supplanting.

48. The system of claim 47, wherein the role of the first user comprises a primary business and/or primary job function of the first user.

49. The method of claim 1, further comprising:
storing a meta-profile of attributes, behaviors, recommendations, and/or content associated with a role of each user in the community;
determining a first recommendation and/or first content for the first user based on the filtering;
determining a second role-based recommendation and/or second role-based content for the first user based on the meta-profile associated with the role of the first user; and
issuing the second role-based recommendation and/or the second role-based content to the first user via a web-portal of the first user associated with the community, wherein the second role-based recommendation and/or second role-based content is configured to add value to the first user that is beyond value received by the first user through the first recommendation and/or the first content.

50. The method of claim 49, wherein the role comprises primary business and/or job function associated of the first user.

51. The system of claim 15, further comprising:
a database to store a meta-profile of attributes, behaviors, recommendations, and/or content associated with a role of each user in the community; and
the at least one processor to also:
determine a first recommendation and/or a first content for the first user based on the filtering,
determine a second role-based recommendation and/or second role-based content for the first user based on the meta-profile associated with the role of the first user, and
issue the second role-based recommendation and/or the second role-based content to the first user via a web-portal associated with the community, wherein the second role-based recommendation and/or second role-based content is configured to add value to the first user that is beyond value received by the first user through the first recommendation and/or the first content.

52. The system of claim 51, wherein the role comprises primary business and/or job function of the first user.

53. The method of claim 1, further comprising:
analyzing the delivered content in accordance with relevance feedback from the at least one user; and
running a refined set of search criteria in order to produce search results, the refined set of search criteria being based on the relevance feedback.

54. The system of claim 15, wherein:
the at least one processor to:
analyze the delivered content in accordance with relevance feedback from the at least one user, and
run a refined set of searching criteria in order to produce search results, the refined set of searching criteria being based on the relevance feedback.

55. The method of claim 1, further comprising:
selecting a primary search result from the delivered content based on attributes of interest to the first user;
submitting characteristics of the selected primary result for a search in order to find additional results having attributes similar to the selected primary search result;
analyzing attributes of the content associated with the community for closeness of fit to attributes associated with the submitted search; and
outputting a secondary search result in accordance with items that match a closeness of fit to the analyzed attributes.

56. The system of claim 15, wherein:
the at least one processor to also:
select a primary search result from the delivered content based on attributes of interest to the first user,
submit characteristics of the selected primary result for a search in order to find additional results having attributes similar to the selected primary search result,
analyze attributes of the content associated with the community for closeness of fit to attributes associated with the submitted search, and
output a secondary search result in accordance with items that match a closeness of fit to the analyzed attributes.

57. The method of claim 55, wherein, when the first user is conducting a people search, the submitted characteristics of the primary search result comprises job function, primary business, product interests, geographic region, and/or keyword search terms stored with a profile associated with the first user.

58. The method of claim 55, wherein when the first user is conducting a company or product search, the submitted characteristics of the primary search result comprises primary business, product categories, most important keywords, and/or geographic region stored in the company and/or product profile stored with a profile associated with the first user.

59. The method of claim 55, wherein when the first user is conducting a knowledge search, the submitted characteristics of the primary search result comprise keywords, primary business, product categories associated with an index of a knowledge element, and/or sources of the submitted attributes.

60. The system of claim 56, wherein when the first user is conducting a people search, the submitted characteristics of the primary search result comprises job function, primary business, product interests, geographic region, and/or keyword search terms stored with a profile associated with the first user.

61. The system of claim 56, wherein when the first user is conducting a company or product search, the submitted characteristics of the primary search result comprises primary business, product categories, most important keywords, and/or geographic region stored in the company and/or product profile stored with a profile associated with the first user.

62. The system of claim 56, wherein when the first user is conducting a knowledge search, the submitted characteristics of the primary search result comprises keywords, primary business, product categories associated with an index of a knowledge element, and/or sources of the submitted attributes.

63. The method of claim 1, further comprising:
creating an event plan associated with a desired event of the first user; and
populating the event plan with references to the filtered content, recommendations and/or connection requests.

64. The method of claim 63, wherein the event plan comprises exhibiting companies, conference sessions, special events, companies, products, sessions, knowledge content and/or people.

65. The method of claim 1, further comprising:
causing a structured list of information useful to the first user to be displayed, the structured list configured to be based on the filtered content;
integrating an event plan in order to display the structured lists in demarcated recommendation areas;
storing items within the structured list in order to enable the communication network to process the structured list on an event plan webpage associated with the first user;
causing the event plan to be displayed; and
populating the displayed event plan with recommended content.

66. The method of claim 65, wherein the structured list comprises companies, products, sessions, people, and/or knowledge content.

67. The method of claim 65, further comprising:
moving around items contained in the structured list from the recommendation areas to areas demarcated to cater to future plans of the first user.

68. The method of claim 65, further comprising:
querying recommended companies when the first user is issued as a lead;
ranking the queried companies in descending order based on the number of lead criteria met by the first user; and
causing the ranked companies to be displayed in the event plan webpage associated with the first user.

69. The method of claim 1, further comprising:
receiving input from an interactive button configured to provide recommendations displayed in an event plan;
collecting attributes associated with a profile of the first user when the interactive button is activated;
submitting the collected attributes to a matching engine to configure a set of matched results; and
causing the matched results to be displayed in designated areas of the event plan.

70. The method of claim 69, further comprising:
causing a fraction of a total of the matched results to be displayed in the designated areas;
providing the first user with pagination controls to allow for easy viewing of the matched results;
expanding and/or collapsing the viewed matched results; and
outputting the expanded and/or collapsed viewed matched results.

71. The system of claim 15, further comprising:
the at least one processor to:
create an event plan associated with a desired event of the first user; and
populate the event plan with references to the filtered content, recommendations and/or connection requests.

72. The system of claim 71, wherein the event plan comprises at least one of exhibiting companies, conference sessions, special events, companies, products, sessions, knowledge content and/or people.

73. The system of claim 15, further comprising:
a storage unit to store items within a structured list of information useful to the first user in order to enable the communication network to process the structured list on an event plan webpage associated with the first user, the structured list configured to be based on the filtered content; and
the at least one processor to also:
integrate an event plan in order to display the structured lists in demarcated recommendation areas, and
populate the displayed event plan with recommended content.

74. The system of claim 73, wherein the structured list comprises at least one of companies, products, sessions, people, and/or knowledge content.

75. The system of claim 73, wherein:
the at least one processor to also move around items contained in the structured list from the recommendation areas to areas demarcated to cater to future plans of the first user.

76. The system of claim 73, wherein:
the at least one processor to also:
query recommended companies when the first user is issued as a lead, and
rank the queried companies in descending order based on the number of lead criteria met by the first user; and
cause the ranked companies to be displayed in the event plan page associated with the first user.

77. The system of claim 15, wherein:
the at least one processor to:
receive input from an interactive button configured to provide recommendations displayed in an event plan;
collect attributes associated with a profile of the first user when the interactive button is activated,
submit the collected attributes to a matching engine to configure a set of matched results,
cause the matched results to be displayed in designated areas of the event plan.

78. The system of claim 77, wherein:
the at least one processor to also:
cause a fraction of a total of the matched results to be displayed in the designated areas;
provide the first user with pagination controls to allow for easy viewing of the matched results, and
expand and/or collapse the viewed matched results, and
output the expanded and/or collapsed viewed matched results.

79. The system of claim 15, further comprising a portal associated with the first user, wherein:
the content stored in the at least one storage device includes content related to professional knowledge,
the at least one processor to filter the content, sorts the professional knowledge content of at least one storage device to determine a match based on the determination to obtain personalized professional knowledge content for the first user in accordance with the sorting, and
to deliver the filtered content writes the personalized professional knowledge content to the associated user portal, and the associated user portal to display the written personalized professional knowledge content in a personalized recommendation page.

80. The system of claim 79, wherein the determination comprises user demographic profile attributes, user meta-profile attributes, user-defined complementary attributes and/or user behavioral profile attributes associated with the first user.

81. The system of claim 80, wherein the user-defined complementary attributes are based on topics desired by the first user and collected in a wizard.

82. The system of claim 79, wherein the at least one storage device comprises a knowledge content database that includes content files and/or meta-tagged links that are indexed based on content, primary business and/or keyword.

83. The system of claim 79, wherein the at least one processor alerts the first user of the personalized professional knowledge content via an email that includes a link to the personalized recommendation page.

84. The system of claim 79, further comprising a persistent desktop object on a computer used by the first user, wherein the at least one processor sends an alert informing the first user of the personalized professional knowledge content to the persistent desktop object.

85. The system of claim 79, further comprising:
a web crawling and indexing device to populate the at least one storage device with content from the Internet.

86. The system of claim 85, wherein:
the indexing device comprises an Internet search engine, an index, and/or a personalized content generator so that the content can be sorted into bins for distribution to the first user.

87. The system of claim 86, wherein the bins correspond to meta-profiles associated with primary businesses and/or job functions of community members.

88. The method of claim 1, wherein:
the content includes content related to professional knowledge;
the filtering includes sorting the professional knowledge content to determine a match based on the determining to obtain personalized professional knowledge content for the first user in accordance with the sorting; and
the delivering includes writing the personalized professional knowledge content to a portal associated with the first user, the associated user portal displaying the written content in a personalized recommendation page.

89. The method of claim 88, wherein the determining comprises determining user demographic profile attributes, user meta-profile attributes, user-defined complementary attributes and/or user behavioral profile attributes associated with the first user.

90. The method of claim 89, wherein the user-defined complementary attributes are based on topics desired by the first user and collected in a wizard.

91. The method of claim 88, wherein the content includes content files and/or meta-tagged links that are indexed based on content, primary business and/or keyword.

92. The method of claim 88, further comprising sending an email to the first user including a link to the personalized recommendation page.

93. The method of claim 88, further comprising sending an alert informing the first user of the personalized professional knowledge content to a persistent desktop object on a computer used by the first user.

94. The method of claim 88, further comprising:
collecting from the Internet and indexing the content.

95. The method of claim 94, wherein the indexing comprises sorting the content into bins for distribution to the first user.

96. The method of claim 95, wherein:
wherein the bins correspond to meta-profiles associated with primary business and/or job functions of community members.

97. The method of claim 1, further comprising:
hosting a plurality of content which is accessible to the plurality of users, wherein:
the filtering includes matching each of the plurality of users with the hosted plurality of content based on the determining and populating a database with the matched content; and
the delivering includes alerting each of the plurality of users periodically with the matched content located in the populated database so that refreshed information is delivered to each user.

98. The method of claim 97, wherein the determining comprises determining preferences, needs, demographics and/or behaviors associated with each user.

99. The method of claim 97, wherein the plurality of content comprises news articles, white papers, press releases, conference session presentations, literature, podcasts, and/or videos.

100. The system of claim 15, further comprising:
a database to host a plurality of content which is accessible to the plurality of users, wherein:
the at least one processor to:
filter the content matches to each of the plurality of users with the hosted plurality of content based on the determination and populates the database with the matched content, and
deliver content alerts to each of the plurality of users periodically with the matched content located in the populated database so that refreshed information is delivered to each user.

101. The system of claim 100, wherein the determination by the at least one processor determines preferences, needs, demographics and/or behaviors associated with each user.

102. The method of claim 100, wherein the plurality of content comprises news articles, white papers, press releases, conference session presentations, literature, podcasts, and videos.

103. The method of claim 1, further comprising:
permitting each of a plurality of users of an event to specify a plurality of attributes that describe at least one preference that each of the plurality of users desires to locate;
matching the specified attributes with the content in order to determine whether the content relates to the described preference; and
displaying a result associated with the match.

104. The method of claim 103, further comprising:
permitting each of the plurality of users of an event to specify a weight and/or degree of importance associated with each attribute based on an importance co-efficient that rates each attributes on a scale of value from lesser to greater.

105. The method of claim 104, further comprising:
matching the user-specified weighting and/or degree of importance associated with each attribute with the content in order to determine whether the content relates to the described preference.

106. The method of claim 103, wherein the preferences comprises content, people and/or solution.

107. The method of claim 103, wherein the plurality of attributes comprises primary business, job functions, product category types, geographic region, companies, expertise and/or business relationship type associated with a person that at least one of the plurality of users desires to meet.

108. The method of claim 103, wherein the matching comprises people matching, wherein the plurality of attributes includes primary business, job function, company, company products, geographic region, expertise, and/or business relationship interests, specified by one of the plurality user.

109. The method of claim 103, wherein the matching comprises company/supplier matching, wherein the plurality of attributes includes primary business, product category, geographic region, end markets served, company size, import/export countries, and/or keyword.

110. The method of claim 103, wherein the matching comprises product matching, wherein the plurality of attributes includes primary business, product category, date range of product launch, and/or company associated with manufacturing a corresponding product.

111. The method of claim 103, wherein the matching comprises solution matching that comprises at least one of a plurality of customized solution criteria specific to an organization deploying solution attribute matching.

112. The method of claim 103, wherein the matching comprises knowledge matching, wherein the plurality of attributes includes primary business area of the knowledge sought, product category of the knowledge sought, keywords associated with the knowledge sought, date range when the knowledge was published, knowledge sources to be searched, and/or sources of the knowledge.

113. The system of claim 15, wherein the at least one processor also to:
permit each of a plurality of users of an event to specify a plurality of attributes that describe at least one preference that each of the plurality of users desires to locate,
match the specified attributes with the content in order to determine whether the content relates to the described preference; and
cause a result associated with the match to be available to at least one of the users.

114. The system of claim 113, wherein:
the at least one processor to also permit each of a plurality of users of an event to specify a weight and/or degree of importance associated with each attribute based on an importance co-efficient that rates each attributes on a scale of value from lesser to greater.

115. The system of claim 114, wherein:
the at least one processor also to match the user-specified weighting and/or degree of importance associated with each attribute with the content in order to determine whether the content relates to the described preference.

116. The system of claim 113, wherein the preferences comprise content, people and/or solution.

117. The system of claim 113, wherein the plurality of attributes comprises primary business, job functions, product category types, geographic region, companies, expertise and/or business relationship type associated with a person that at least one of the plurality of users desires to meet.

118. The system of claim 113, wherein the matching comprises people matching, wherein the plurality of attributes includes primary business, job function, company, company products, geographic region, expertise, and/or business relationship interests, specified by the at least one user.

119. The system of claim 113, wherein the matching comprises company/supplier matching, wherein the plurality of attributes includes primary business, product category, geographic region, end markets served, company size, import/export countries, and/or keyword.

120. The system of claim 113, wherein the matching comprises product matching, wherein the plurality of attributes includes primary business, product category, date range of product launch, and/or company associated with manufacturing a corresponding product.

121. The system of claim 113, wherein the matching comprises solution matching, wherein the plurality of attributes includes at least one of a plurality of customized solution criteria specific to an organization deploying solution attribute matching.

122. The system of claim 113, wherein the matching comprises knowledge matching, wherein the plurality of attributes includes primary business area of the knowledge sought, product category of the knowledge sought, keywords associated with the knowledge sought, date range when the knowledge was published, knowledge sources to be searched, and/or sources of the knowledge.

123. The system of claim 15, wherein:
the at least one processor also to:
repeat the filtering;
compare the result of the previous filtering with the subsequent filtering in order to determine different results; and
provide the different results to the first user.

124. The system of claim 123, wherein the at least one processor provides the different results on a portal associated with the first user.

125. The system of claim 123, wherein the different results are new items that are unviewed by the first user.

126. The system of claim 125, wherein the at least one processor alerts the first user to the different results.

127. The system of claim 15, further comprising:
at least one offline storage device to store a copy of content associated with at least one storage device;
at least one offline processor to:
fetch a predetermined number of results of previous filtering,
run offline filtering subsequent to the previous filtering,
compare the offline filtering result with the previous filtering result in order to determine different results,
compare the different results to prior bookmarks associated with the first user,
filter the different results using the prior bookmarks, and
provide the filtered different results to the first user.

128. The system of claim 127, wherein the at least one processor provides the filtered different results to a portal associated with the first user.

129. The system of claim 127, wherein the filtered different results are new items that are unviewed by the first user.

130. The system of claim 129, wherein the at least one processor alerts the first user to the filtered different results.

131. The method of claim 1, further comprising:
repeating the filtering;
comparing the result of the previous filtering with the subsequent filtering in order to determine different results; and
providing the different results to the first user.

132. The method of claim 131, wherein the providing includes providing the different results to a portal associated with the first user.

133. The method of claim 131, wherein the different results are new items that are unviewed by the first user.

134. The method of claim 133, further comprising:
alerting the first user of the different results.

135. The method of claim 1, further comprising:
storing a copy of the content offline;
fetching a predetermined number of results of previous filtering;
running offline filtering subsequent to the previous filtering;
comparing the offline filtering result with the previous filtering results in order to determine different results;
comparing the different results to prior bookmarks associated with the first user;
filtering the different results using the prior bookmarks; and
providing the filtered different results to the first user.

136. The method of claim 135, wherein the providing provides the filtered different results to a portal associated with the first user.

137. The method of claim 135, wherein the filtered different results are new items that are unviewed by the first user.

138. The method of claim 137, further comprising:
alerting the first user of the filtered different results.

139. The method of claim 1, further comprising:
storing matching criteria associated with a plurality of users of an event, the matching criteria configured to be based on the filtered content associated with at least one user;
transmitting the matching criteria to the at least one user;
alerting the at least one user when the new predetermined information is detected;
updating the at least one user with the alerting predetermined information;
matching the transmitted matching criteria with the content continuously and/or at regular intervals;
comparing new results obtained from the matching to a previous result obtained from a prior matching associated with the at least one user, wherein the previous result is stored in an offline database;
obtaining a new result based on the compared results; and
displaying the obtained new result to the at least one user.

140. The method of claim 139, wherein the new result comprises at least one of new people, sessions, products, companies and other content that are added to an event within the communication network, the new result configured to be based on the last visit of the at least one user and preferences not previously seen by the at least one user.

141. The system of claim 15, further comprising:
a storage device to store matching criteria associated with a plurality of users of an event, the matching criteria configured to be based on the filtered content associated with at least one user; and
at least one processor to:
transmit the matching criteria to the at least one user,
alert the least one user when new predetermined information is detected,
match the transmitted matching criteria with the content continuously and/or at regular intervals
compare new results obtained from the matching to a previous result obtained from a prior matching associated with the at least one user, wherein the previous result is stored in an offline database,
obtain a new result based on the compared results, and
update the at least one user with the alerting predetermined information, and display the obtained new result to the at least one user.

142. The system of claim 141, wherein the new result comprises at least one of new people, sessions, products, companies and other content that are added to an event within the communication network, the new result configured to be based on the last visit of the at least one user and preferences not previously seen by the at least one user.
